(19) United States
(12) Patent Application Publication
(10) Pub. No.: US 2014/0041321 A1
(43) Pub. Date: Feb. 13, 2014

(54) Building Systems

(71) Applicant: Alain Poivet, Palo Alto, CA (US)

(72) Inventor: Alain Poivet, Palo Alto, CA (US)

(21) Appl. No.: 13/831,496

(22) Filed: Mar. 14, 2013

Related U.S. Application Data
(63) Continuation-in-part of application No. 13/129,378, filed on May 13, 2011.

(30) Foreign Application Priority Data
Nov. 17, 2008 (FR) 0806419

(51) Int. Cl. F24J 2/52

(52) U.S. Cl. CPC F24J 2/5245; B25J 9/00
USPC 52/173.3; 52/173.1; 901/50

(57) ABSTRACT

A new system of building construction, technology and methods for making the skin complex of a building as elements on a roof or façade of which solar panels/systems are a part are disclosed.

### CROSS REFERENCE TO RELATED APPLICATIONS

This application claims the benefit of U.S. patent application Ser. No. 13/129,378, filed May 13, 2011, entitled, “DEVICE FOR SUPPORTING PHOTOVOLTAIC CELL PANELS, SUPPORT SYSTEM AND INSTALLED ASSEMBLY,” by Poivet et al., which in turn claims priority to PCTFR2009001322, filed on Nov. 17, 2009, which in turn claims priority to the prior French application 0806419, filed on Nov. 17, 2008, all of which are hereby incorporated by reference in their entirety.

### TECHNICAL FIELD

The disclosed embodiments relate building systems.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 illustrates a perspective view of an outer skin complex, according to certain embodiments of the invention.

FIG. 1b illustrates an outer skin complex with panels in landscape mode, according to certain embodiments of the invention

FIG. 2 illustrates a sectional view of an outer skin complex, according to certain embodiments of the invention.

FIG. 3 illustrates a mounting system of an outer skin complex, according to certain embodiments of the invention.

FIG. 3b illustrates “before” and “after” scenarios related to an outer skin complex, according to certain embodiments of the invention.

FIG. 4 illustrates aspect of creating a solar array on a roof, according to certain embodiments of the invention.

FIG. 4a illustrates an application for a carport, according to certain embodiments of the invention.

FIGS. 5-7, FIG. 8, FIG. 8a illustrate waterproofing, insulation aspects of an outer skin complex of according to certain embodiments of the invention.

FIG. 7b illustrates adjustable height of an outer skin complex, according to certain embodiments of the invention.

FIG. 8b illustrates structural settings, according to certain embodiments of the invention.

FIG. 9 illustrates installation examples of an outer skin complex, according to certain embodiments of the invention.

FIG. 10 illustrates structural capacity of an outer skin complex, according to certain embodiments of the invention.

FIG. 11 illustrates further aspects of adjustable height of an outer skin complex, according to certain embodiments of the invention.

FIGS. 12, 20 illustrate variations of outer skin complex, according to certain embodiments of the invention.

FIG. 13 illustrates facades configurations, according to certain embodiments of the invention.

FIGS. 14-18, 19, 19b, 19c illustrate various LSC structures, according to certain embodiments of the invention.

FIG. 18a illustrates a multi component LSC structure, according to certain embodiments of the invention.

FIGS. 21, 22, 22b, 23, 24 illustrate attachment aspects for LSC structure, according to certain embodiments of the invention.

FIG. 25 illustrates rigidity aspects for an outer skin complex, according to certain embodiments of the invention.

FIG. 25b illustrates accessories for an outer skin complex, according to certain embodiments of the invention.

FIGS. 26, 26b, 27 illustrate waterproofing for an outer skin complex, according to certain embodiments of the invention.

FIGS. 28, 29, 30, 31 illustrate airtightening, sealing aspects for an outer skin complex, according to certain embodiments of the invention.

FIGS. 32, 32b illustrate use of clamps for an outer skin complex, according to certain embodiments of the invention.

FIGS. 33, 34, 35, 36 illustrate air duct flow management, according to certain embodiments of the invention.

FIGS. 37, 37b, 38, 39, 40, 40b, 41 illustrate prefabrication methods, according to certain embodiments of the invention.

FIGS. 42, 42b, 43, 44, 44b, 45, 45b, 46, 47, 48 illustrate mobile walkways and associated tools, according to certain embodiments of the invention.

FIGS. 49, 50 illustrate robots for outer skin complex and duct complex, according to certain embodiments of the invention.

### DESCRIPTION OF EMBODIMENTS

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

There are different ways to integrate solar systems in buildings, such as replacing windows by solar glass, or by fixing solar panels on roofs or facades. Some of these solutions are sometimes described as “Building Integrated Photovoltaics” or BIPV.

There are also many techniques for mounting solar panels, or on buildings or outside the building. These solutions, in some cases, use profiles or frames on which panels or cells are attached, and these profiles are usually supported either by independent structures similar to frameworks, or by the structure of the building on which they are attached.

When attached to buildings, additional rooftop racking systems are unsatisfactory as they do not come close to the level of performance/efficiency/simplicity of implementation/cost/reliability required for large-scale development of solar energy.

The embodiments disclosed herein present solutions that address the above problems.

Typically, a building is first built using traditional techniques, and then one seeks to add secondary structures that enable solar panels to be attached and the energy they produce to be exploited.

According to certain embodiments, a solution is not to add structures to existing buildings or buildings to be built, but to change the systems, methods and construction processes in order to directly build solar skins (photovoltaic and/or thermal) that fulfill the solar functions and the traditional functions of a building at the same time.

The embodiments of the building system are flexible to address various configurations. Each element can be achieved in several different ways and different embodiments can be combined to create a large number of solutions adapted for special cases.

Further, the embodiments described herein have non-solar applications. The embodiments disclose new construction processes and methods applicable to many building cases.

Replacing the Roof, Facade or Skin of a Building with a New Complex

According to certain embodiments, a new system of building construction, technology and methods replaces the skin of a building (generally elements on the roof or façade) with a new complex of which solar panels/systems are a part. In other words, the traditional methods of building construction are replaced by new building systems as disclosed by the embodiments.

According to certain embodiments, the building system can fulfill part or all of the functions expected of the skin of a building, including but not limited to: waterproofing, airtightness functions, air circulation, drainage of water, mechanical protection, fence, structural functions, rigidity functions, functions of thermal insulation, ventilation functions, fluid circulation, electrical functions (electricity production, electrical grounding, flow of current, information or fluids), and architectural functions.

### Ventilation Duct

The building system is designed to ensure a flow of air or gas or other fluids:
a) to remove the heat from the building
b) to heat or cool the building
c) to heat or cool the inhabitants of the building
d) to heat or cool the building skin itself (for example to cool or heat the solar panels or to eliminate snow),
e) any function related to fluids, or
f) to control issue of vibration, of magnetic or wavelengths emissions, or maintenance functions, etc.

The embodiments of the building system may take the form of a ventilation duct. The duct can be:
a) open to the outdoors on one or more sides,
b) closed like a pipe but ventilated naturally or artificially,
c) closed like a pipe and connected to external ventilation systems, such the ventilation of a building or other structures, or
d) connected to other systems, such as heat exchangers, or inlets or outlets of air or liquid, or recirculation systems.

The duct can be individual, limited by the side rails, or connected to other ducts or other systems. The duct can be opened or closed, openable, closable or flexible in different ways. The duct can include different manual devices or mechanized devices. The duct may be programmable, or controlled by a remote controller or a computer.

The longitudinal supporting components (LSC) and/or the duct can provide functions other than support. For example, the LSC and/or duct (or complex of ducts) can transport fluids or information, bear sensors or exchangers (for example heat exchangers), or play an active or intelligent role. The LSC and/or duct (or complex of ducts) can also be components of an intelligent system that may be internal or external, local or remote.

### Related Applications

Some of the solutions discussed herein can also generate non-solar systems where the solar panels are replaced by panels of a different nature or by non-rigid elements.

Some of the solutions discussed herein can be used on structures other than buildings, and for other purposes.

Some of the solutions discussed herein allow for applying elements to the building, but without forming the skin of the building.

The embodiments can improve the building's overall performance, its energetic performance, thermal performance and insulation.

Constructions with Inverted Structures

All or a subset of the solutions, methods, and technologies described herein can be applied partially or wholly or combined to generate various applications.

The embodiments include:
a) Building processes (equipment, systems, processes, etc.) that can also be applied to non solar buildings.
b) Techniques, processes or mounting strategies (prefabrication, robotics, computerized controls).
c) Types of supporting structures (inverted support).
d) Sealing and longevity of systems (waterproofing, warranties).
e) Overall thermal performance.
f) New systems for building solar systems outside the buildings.
g) Maintenance systems.

### Building System

According to certain embodiments, a network of parallel Longitudinal Supporting Components (herein referred to as “LSCs”) is installed, usually arranged so as to follow the slope of the intended roof or intended façade of the building but not necessarily. The surface of these LSCs forms a plane or a complex surface and allows the mounting of solar panels juxtaposed in a regular pattern, for example. The panels are attached to the LSCs. The LSCs are arranged in parallel. The spacing between the LSCs depend on the dimension of the rectangular panel. The length of the LSCs allows them to support several successive panels, for example. The width of the LSCs generally allows them to support two panels disposed laterally side-by-side as well as their mounting systems, or one panel to one side, for example.

According to certain embodiments, the LSCs can be made of several parts, in order to respond to different cases, in particular with thermal break or with multifunctional LSCs. The LSCs may have different heights and different structural or functional abilities. The solar panels can be replaced by any other material or product, flexible or rigid.

According to certain embodiments, the building system enables the creation of various types of structures, such as roofs, facades, solar skins or coverings (e.g., carports, outdoor structures, mobile systems, components of intelligent or active systems, etc.).

The building system also enables the integration of the elements and functions of a roof or façade, such as: 1) Closure and protection, 2) waterproofing, 3) thermal insulation, 4) ventilation, 5) load bearing, 6) support of external loads. 7) climactic loads, etc. The building system adaptable to various types of buildings or structures and different the types of mounting schemes.

According to certain embodiments, the building system may include its own support structure and, in some cases, it may contribute to the rigidity of the adjacent structures.

According to certain embodiments, the building system may also help: 1) to ventilate, 2) to evacuate and re-use the air or thermal energy, 3) to develop innovative techniques of construction, installation and maintenance, and 4) to develop specific designs.

The building system described herein operates in a variety of applications. For example, photovoltaic solar panels can be replaced by various kinds of solar panels, as well as various kinds of rigid or flexible plates, opaque or transparent, or by other elements such as fabrics or flexible sheets, or other alternative materials. Other examples include: pathways, ventilations, decorative panels, illuminated or informative panels, sensors, heat exchangers, glazing, moving parts etc.

According to certain embodiments, the LSCs can be used to circulate various types of elements, such as cables, fluids, mechanical systems, and information. The LSCs can circulate electric or computer cables or other types of cables (and if necessary, have connectors for these cables where needed), as well as various devices (connectors, sensors, interfaces, etc.). The LSCs can also circulate fluids (e.g., liquids or gases), either for internal use, or used by the building or structures related to the system, or used in connection with the duct complex, or for other purposes. Examples include, circulating heat transfer fluids or air, or having transfers between the fluid and the duct or the underlying structure. For example, a heat transfer fluid is coupled to a heat exchanger in order to transfer heat or cold between the fluid flowing in the LSC or those present in the duct (or associated structure). As another example, there can be air or gas exchanges, by blowing or sucking air between the LSC and the duct, or vice versa, in order to regulate the flow through fixed, adjustable or mobile air grilles. Certain embodiments include a control system to change the above parameters in real time or otherwise.

### Different Mounting Types

The system adapts to various types of buildings and fits many application types. Some examples are described below.

The building system can be enhanced with various options that may allow it to perform a number of functions in addition to the basic functions described below.

### Self-Stable Building or Structure

In this case, the building or structure is stable on its own and does not rely on its skin to keep the structure stable. The building or structure provides cross support to the LSCs. The building system is used in the roof, façade, or in design independent from the structure, and at whatever angle or slope.

For the skin complex, the parallel LSCs are be positioned perpendicular to the support (e.g., following the slope in the case of a sloping roof design, or any other geometry depending on the configuration of the design of the host building) since the LSCs can provide structural rigidity between supports. Another possible case is that in which the LSCs are laid on a supporting surface. For example, a surface made of wood or metal, such as a roof's wooden deck.

The panels will be fixed on these parallel LSCs (solar sensors, or other finish as stated above). Different types of panels can also be mixed, such as PV and hot water panels, or rigid panels of another nature, or illuminated signs or displays, or ventilation grids or circulation grids, or sensors, or wind sensors or communication equipment of any other nature, etc.).

According to certain embodiments, a waterproofing function can be added to the skin complex by placing a waterproofing sheet or layer from LSC to LSC (possibly not on all LSCs). In another scenario, the waterproofing layer may be placed on a plate itself placed under the LSC, or be placed somewhere else).

According to certain embodiments, the skin complex can include an airtightness function by using the system built for this purpose, and can include various circulation systems (fluid, heat, cold circulation).

Certain embodiments can include a thermal insulation function by placing the insulating layer in between the LSCs, or under the LSCs or somewhere else. Various insulating materials can be used, with various thicknesses and various types of implementation.

Certain embodiments can include auxiliary functions such as communications, fluids, information, etc. that can be activated.

Certain embodiments use the structural function of the LSCs to attach or suspend loads such as ceilings, equipment or any other items. The insulation layer can for example be integrated into a ceiling suspended to the structure, or independent of this structure.

We see that if the appropriate configuration and accessories are used, a complete façade or roof can be made, and which also has additional functions compared to a conventional roof. Such a configuration can, for example, be used to make solar roofs that replace conventional roofs. Further, the embodiments can fulfill the requisite functions and produce electricity and/or heat. Further, the embodiments can be used to make non-solar roofs or facades that carry panels of a different nature.

The embodiments can also produce structures that are not roofs or facades. The embodiments enable installing solar panels in a much more efficient, reliable, rational and economical way than current systems.

### Various Architectural Applications

The application cases may also include various façades or roofs, roof-façades, facades of high rise buildings, including for possible heat recovery. The application cases may also include combining different materials such as by replacing the solar panels with panels of another kind, or glass, or furthermore cases where the 4th side of the duct is made up of the inner skin of a building (e.g., an existing façade, an inner façade or an element of the roof).

### A Carport or Independent Structure

A support structure carries the system like a solar system, with or without additional features. This applies to any type of support structure, related to a building or not, fixed or mobile, permanent or temporary. According to certain embodiments, the supporting structure can be above, below or sideways of the solar system. According to certain embodiments, the support structure can be a roof, a facade, a mere shelter, or a mere floor plan with any type of function. Certain embodiments can include awnings, courtyards, walkways, covered streets, architectural promenades, crossings, bridges, carports, shadings, moving parts, etc.

The panels are attached to the LSCs. The LSCs can support the panels between two main supporting points (for example beams of the supporting structure of the building, or carport). The main supporting structure can be made of metal, wood, masonry, or any other building process. It can be fixed or mobile, according to certain embodiments,

In addition, a waterproof system and/or a system of airtightness that enables, for example, to channel ventilation (as described herein), or to protect from bad weather can be added.

In addition structural components such as systems to ensure the transverse rigidity or triangulation (e.g. bracing or diaphragm), or to ensure the rigidity during mobile uses, transportation or prefabrication, can also be added.

Various accessories of the system can be applied here, such as associated with the transport of fluids, the use of multiple materials, or use of different configurations, etc.

The embodiments can apply to a skin of solar sensors or any other skin for various uses.

Case of a Building Structure of the Diaphragm Type, in which the Skin Plays a Structural Role

System supported transverse rigidity elements or sheathing sheets or other structural solutions can be added to what has been described in the case of a self-stable structure. Sheathing sheets can be included in the building system. The Sheathing sheets can be inserted between the LSCs or below the LSCs. Continuity ties can be created as well.

### Sheathing Sheet Type of Solution

Certain embodiments can be used in “diaphragm” constructions for which the roof is traditionally made of wood or metal plates (sheathing sheet) in order to ensure the rigidity or the transmission of forces.

The objective is to have plates that will prevent the skin of the building from horizontally distorting, and that will pass this stability to the building structure (especially when using the roof). Some of the horizontal force is transferred onto this continuous plate. The building system enables the creation of this sheathing sheet in 2 ways:
1) Attaching a plate between the LSCs. This plate can be made of wood, metal or another material, and is dimensioned and attached to the LSCs so as to provide sufficient stiffness to match the constraints of the building. The plate can, for example, be made of wood and screwed or riveted to the LSCs, either directly or via a mounting part. In another example, the plate can also be made of metal.
2) This plate can also be mounted under the LSCs, either immediately under the LSCs or remotely attached to the LSCs provided that there is sufficient rigidity. This plate may also be placed far away from the LSCs, for example by being suspended from the hangers attached to the LSCs (e.g., by using sliding attachments) and/or integrated in a sub-structure or in a ceiling.

### “Bracing” Type Solutions

According to certain embodiments, a ‘bracing’ system can be created by implementing structural cross parts, on different possible geometrical models (see figures herein). The geometrical models can be two or three dimensional.

### Supporting Loads or External Forces

The building system's LSCs, or grooves or supporting profiles can be used to attach loads.

The system helps to solve the complicated issue of installing over-roofs, solar systems or other devices on an existing roof.

To limit the length of the description, consider the example of installing a solar system on a roof.

Assume the roof meets the requirements of closure, covering and sealing, and possibly of thermal insulation. It has a supporting structure, generally a frame located below it. The roof may be flat, horizontal or sloping. In order to install solar panels, the panels must generally rest on the roof and be attached to reliable supports, either by transferring loads to the carpentry, or by transferring the loads to the wooden, metal or concrete plates that sometimes can be found under the waterproofing material they support.

To hold the panels, a secondary structure is often set up, usually made of small profiles that lack structural capacity. These profiles therefore have to be frequently held and attached to a support. This attachment often involves piercing the waterproofing layer repeatedly, which is expensive and complex, and carries a significant risk of leakage over time.

Some of the embodiments overcome most of these difficulties because there embodiments have their own beams and can span long distances without supports or attachments.

### Sloping Roof Covered by Tile or a Similar Material

Certain embodiments (LSCs structure) enable bridging the existing roof without altering it, thanks to the wide span of the beams integrated in the building system solution. The existing tiles and sheathing sheet can be preserved.

In some cases it will be possible for the embodiments to be attached only at the top and bottom (ideally upstream and downstream of the waterproof plane so as not to pierce it), and in other cases, it may be attached to the roof with only a few holes (typically, there could have a cross beam at the top and bottom which can be attached to the roof with only very few holes). In this case, the waterproofing function can be used so as to avoid or reduce the inflow of water on the lower pre-existing roof and limit even more the risk of leakage.

In other cases, the roof will not have tiles or they will have been removed. For example, the existing roof may be made of a deck bearing a waterproofing sheet (there may be an existing seal waterproofing under the deck or above it). One will then be able to simply put down the LSCs on the deck, above the waterproofing layer if there is one (if there isn't one, it can be created traditionally or using one of the methods this system describes) such as to uphold the panels and ensure their ventilation. Thanks to the structural capacity of the system, it will not be necessary to attach the LSC at too many attachment points to the roof: very few anchor points will be needed, and these points will be located beyond the waterproofing surface. This will greatly reduce issues of water penetration and structural overloads.

### Case of Use in Open Fields

The building system embodiments are compatible with a type of solar power plant in open fields often referred to as “ground mounted”. Since the building system solution is self-supporting, a supporting cross beam can be installed at the top and bottom of the setup. This can be done very simply, with or without additional functions. It relates to any type of supporting structure that is stationary or mobile, permanent or temporary, above, below or otherwise.

The panels are attached to the LSCs. The LSCs support the panels between the two main anchor points (the cross beams). The main supporting structure may be made of metal, wood, masonry, or any other constructive technique. It can be stationary or mobile.

In addition to the previous case, one can add a waterproof and/or an airtight system that will enable the use of channel ventilation (see below for possible uses), or to protect from bad weather.

In addition, structural components can also be added to ensure the cross rigidity or the triangulation (e.g. bracing or sheathing), or to ensure the rigidity during mobile use, transportation or prefabrication of the configuration. The building system solution can also, in some cases, carry loads.

Various accessories of the system can be applied to this scenario e.g., transport of fluids, use of multiple materials, different configurations etc.

This building system solution is applicable to solar skins and any other type of skin, for any kind of use.

### Mounting it on a Flat Roof

When installing the LSC structure (building system solution) on a flat roof, an industrial building or otherwise, one can appeal to the logic that we have previously stated when discussing installing it in open fields and that exploits the structural capacity of the system. The wide span may be used to achieve large solar plans, attached by very few anchor points.

For example, a simple primary structure can be set up to support the parallel LSCs that is made up of a supporting element or beam in the lower part and another one in the upper part (the gap between the two beams depends on the project's configuration, but it may be as wide as the system's LSCs' span, which can be counted in meters or tens of meters). The beams support the crossing LSCs. Very large areas can thus be created with very few attachment points to the building, and therefore very little drilling and very little work.

If this mounting system is used to create sloping planes with the aim of maximizing solar performance, the plane will rise in height and leave large unused areas below it, which can be used for various purposes, regardless of whether it has been made into a waterproof roof. This space can be used to store exploitable equipment. This can help to solve the equipment problem (e.g. air conditioning installations) as the equipment often takes up the roofing space, which reduces the space available for the conventional installation of solar panels. In the case of the building system solution disclosed herein, the solar plane will be able to bridge over the equipment. The solar plane may also, in some cases, carry loads.

In some cases, the building system solution may also be manipulated thanks to the fact that it has its own structure and its own rigidity. It may be tilted, rotated or moved or else, sometimes to access the equipment and sometimes for other purposes. The LSC structure may also become mobile in order, for example, to increase the energy performance of the solar system or for other reasons. Efficient mounting techniques may also be used, such as the ones described elsewhere, or other methods adapted to specific cases.

These systems are obviously compatible with functions of heat recovery when necessary, as well as with any other function such as waterproofing, fluid, information, load carrying, etc.

### Inverted Structure

Certain embodiments of the building system solution has an inverted structure. Traditionally, in the world of building, the supporting elements are placed under the loads that need to be supported. Usually, the roofing complex of a building (roofing, waterproofing, insulation, rigidity, accessories, etc.) is upheld by beams located below it.

With our building system, not only do the LSCs create the space necessary to the ventilation, but they also act as beams. By definition, these beams are therefore located inside the roofing complex rather than under it. In many cases, the insulation or the rigid plates that make up part of the roof are located below the supporting beam rather than on top of it. Similarly, most of the loads usually borne by the roof (ceiling, equipment, fixtures, etc.) will be borne by the structure that is integrated into the building system solution.

This inverted structure principle is entirely new, and will find many unexpected practical applications in the world of construction.

### Complex Mountings on Large Buildings

In another category of applications, the functions of complex mountings may be divided into several layers. The skin complex can perform functions such as covering, waterproofing and ventilation or even structural rigidity (e.g., bracing or sheathing sheet or other) as well as the functions of insulation at the ceiling level, beneath or behind it, which can positioned remotely or according to a different slope.

For example, the building system can be used as a load carrying element, and loads may be suspended from it with appropriate connectors. One could suspend for example an insulating complex (which will allow in some cases for thicker insulating layers), a false ceiling, or numerous ceiling-related equipment such as electrical, heating, cooling, airflow, sprinkler, detection, smart equipment etc.

In this application case, all or part of these loads, and these elements can be hung or attached to the system, if necessary.

In other cases, we could have metal cladding, steel tray, wood or other structures, bracing, sheathing or sheet elements under, connected, attached to, or remotely suspended to the LSCs; and all of these elements can in turn carry loads or accessories, above or below them.

When applied to a façade or a sloping plane, the principle does not change, only the orientation and configuration change.

### Other Cases of Use

This mounting system described herein can be used with or without solar panels: panels can be replaced with materials of various natures, either to supplement a solar roof, or on a classic roof. The system can also be mounted without the plate at the top. Cables, gas or fluids in the can also circulate in the LSCs.

The system can also be used for large façades, whether they be uniform or made of various materials or products mounted according to this method, for example, by combining glass parts and solar parts, or even opaque parts, or any kind of parts and functions.

Cases with Sealing and Ventilation Duct

The building system embodiments may include, as described above, a waterproof and watertight system comprising notably a waterproofing film and airtightness solutions. When looking at an overview of the system, it appears that this configuration allows for an air circulation duct marked out by its 4 sides (the panels, the 2 LSCs and the underside, profiles or beams). The system can extend to great lengths if we lay out a series of panels and if the LSCs are long enough.

### Creating Large Areas

This building system embodiments therefore enable creation of small as well as very large solar panel planes. These planes can be tilted in different ways to create slopes, and can become mobile in some cases.

### Type of LSCs Used

The LSCs can be composed of several parts, any kind of forms and materials, with the aim to solve different problems. There are instances of one component in a single axis, or 1 component +1 mounting profile, or 1 component +1 spacer (or several)+1 mounting profile. We can have simple mounting cases or reversed mounting cases, cases with bracing and other functions etc. Cases that have thermal performance, with varying heights or advanced structural properties, cases with functions of communication, or intelligence, or fluid transfer, or other functions and uses can also be used.

### Mounting on a Façade

Most application cases described herein in relation to roofs naturally apply to facades, vertical planes, sloping planes, be they attached to the building or otherwise.

### Mobile Mounting

The system allows for creating standalone planes. One main advantage is that the planes can be manipulated. They can be designed and made so as to be transported, moved, or operated.

This allows the creation of mobile planes, be them autonomous or motorized, manually operated or controlled intelligently.

### The Longitudinal Supporting Component and its Accessories

To simplify, the word Longitudinal Supporting Component (LSC) will refer to the longitudinal element that enables the mounting of the panels. It can be made of a profile, a rail, a beam or otherwise, and may be made of one or more components or materials. The height of the LSC is variable. It can be calculated by the expert in the field according to the functions the system has to fulfill (e.g., supporting functions, thermic functions, structural functions) or characteristics of the works it accompanies. Its height can in most cases vary between 3 and 50 cm.

The LSC, depending on the case of application, may have various forms and functions. The LSC may, in some application cases, be the only support, with multi-functions, to ensure at once the attachment of the “skin” elements, the covering panels, the facades or otherwise, and the support of this skin; and in some cases the support of the whole complex on which it rests. In some cases, the LSC can replace structural elements, and can also fulfill other functions.

When an embodiment of the system is integrated to a building, the LSC can act as a basic component: not only does the LSC have a support function, but it can also circulate fluids, gases or cables, as a substitute to the usual cable trays and/or piping paths of the building. The LSC may include outlet vents, sockets, grilles, devices support. The LSC may ensure autonomic functions, etc.

### Realization

The LSC may be made up of a central portion (which can take any shape, or materials such as a Z, I, or T-shaped beam, a multi-beam, plain wooden beam, etc.) plus an attachment system to the main support (e.g. the girders of a building), and a part favorably enabling the fixing of the covering panels (e.g. solar panels). Attachment to the building's primary structure can, in some cases, be made via anti-vibration supports, or supports guaranteeing either the electrical insulation or the electrical continuity (for example grounding).

The LSCs can be rails, beams, supports or various profiles, consisting of a single piece or several pieces combined. The LSCs can be made of metal, wood or other materials. The LSCs can be of any height, typically from 3 to 60 cm. The LSCs may be solid or hollow, or a combination of both. The LSCs may or may not have a structural function. The LSCs can also be used as supports or rigging hardware, or as conductors, e.g., thermal conductors, electrical conductors, information conductors, fluid conductors (e.g., for air or liquid). The LSCs can contain fluid pipes, electricity pipes, information pipes or otherwise; they can include connectors, connections or connecting pieces.

Depending on the function it has to fulfill, the LSC can take many forms, sizes and materials. For example, the LSCs may include gutters or gutter brackets, sealing supports, insulation supports, devices to support loads or accessories. The LSCs may be solid or hollow, circulate fluids, cables or pipes; it may be pierced or include openings or exchangers. The LSCs may include devices enabling to connect multiple LSCs if, for example, the system is of great length.

Although the LSC can be made of single profile, it is an advantage in a series of cases that it can also be made of several parallel parts.

One can thus create various configurations:
a) Of heights, of performance or of different functions
b) That combine one or more basic elements.
c) That combine many optional accessories (gutters, sensors, grilles, ventilations, power supplies, cables or pipes, sensors, connectors, insulators, active or passive systems, etc.)

One may also wish, in order to simplify the installation, or to meet financial standards or legal requirements, to be able to differentiate between the elements of the roof for example (structure, closing, waterproofing, insulation, for example) from those that make up the support of the solar panels.

### Configuration Examples

Configurations include:
a. First, a mounting profile or base beam, which provides the main support (supporting beam function) of the system and guarantees its attachment to the main structure (for example the main beams of the building), and that supports for example a waterproofing sheet, and/or thermal insulation and/or elements of structural rigidity, and/or other loads. This profile may also fulfill other functions, as we shall see.
b. Second, an upper profile, attached to the precedent, and that will allow attaching covering panels, and may also fulfill other functions
c. In some cases, in order to achieve a greater height or to fulfill other functions, one or more intermediate components or profiles can be introduced between the base profile and the upper profile, or nearby.
d. These profiles can be connected by mechanical processes such as screwing, bolting, riveting and bending, or by gluing or through other processes. In some cases, it will be possible to put together the structural capacity of these various elements in order to create through combination a very strong beam. They can be assembled on site or in the workshop.
e. To improve the performance of the complex, an insulator (for example thermal or electrical insulation, or otherwise) can be introduced between one or more of these profiles. A thermal insulator, for example, allows to break the thermal bridge between a cold and a hot surface. An insulator can also be introduced inside the profiles if necessary.

This LSC can have the function of electrical conductor (for example to form the electrical grounding) or to circulate information.

It can also be used to transport fluids or gases, or for a whole range of other functions.

The LSC (mono or multi composite) can be created or equipped so as to fulfill exactly the functions required for the project.

One can imagine cases of applications that use some or all of the following:
a. Structural Support
b. Support of the covering panels
c. Support of waterproofing, waterproofing
d. Support for thermal insulation, thermal insulation
e. Ventilation duct or circulation of fluids
f. Other fluids or information circulating systems
g. Other exchanger systems
h. Maintenance Support
i. Support, guidance, control of maintenance tools
j. Adjustable, mobile or programmable elements
k. Connectors fit for large dimensions
l. Decorative or architectural elements
m. Support of external loads
n. Fencing elements at the ends (grilles, vents, caps or plugs, or others)
o. Elements connecting to ventilation or external fluids circulation systems
p. Sensors of various types
q. Communication elements
r. Structural elements (e.g. sheathing sheet, bracing, continuity ties, transport frame, etc.)
s. Sensors, communication elements, active or intelligent elements, or elements related to smart systems
t. Accessories (e.g. system of fall protection, walkways, other security systems or other accessories)
u. Anti vibrating support, electrical insulation between materials, adjustment blocks or control systems, etc.

### Junctions and Connections Between LSCs:

Some applications require connecting multiple LSCs end to end lengthwise, e.g. when realizing works of large dimensions. One may then wish to introduce connection pieces, which depending on the circumstances may have structural functions, thermal insulation functions, waterproofing functions, fluid or information circulation functions, sensor functions, or other functions.

### Thermal Expansion and Dimensional Variations:

The LSCs may expand under the effect of temperature variations if they are made of metal.

Similarly, the support on which they are attached may experience dimensional changes or displacements, due to temperature changes or other phenomena.

Therefore it is necessary that:
a. The fastening of the LSCs onto the main support takes the risks into account (for example by fasteners allowing a certain play)
b. The connecting piece located between the LSCs that are put end to end takes into account this expansion, either by deforming or slipping or sliding, for example.

One may also encounter phenomena related to mobility applications, or of an active or smart nature, which may induce changes in the size, angle, slope, constraints, etc. The linkage systems can be tailored to these specifications.

### Thermal Expansion and Sealing

Cases that involve successive LSCs can cause a problem for the waterproofing: if a rigid waterproofing is used, such as a folded metallic sheet, one may wish for this sheet to be made of a single piece covering the length of several LSCs in order to avoid any risk of leakage due to a faulty connection. If the waterproofing sheet or the successive LSCs do not undergo the same movements or dimension changes, we are faced with a problem of thermal expansion.

If the sheet cannot adapt to the dimensional variations of its support, the solution is to avoid attaching it mechanically to the LSCs (e.g., using screws) over its entire length. However, it can for example be attached to a single LSC and slide along the following LSCs or have a sliding fixation lengthwise.

The sheet should then be held still without being blocked longitudinally. To do this, one can for example introduce a blocking system through longitudinal profiles, fixed or removable, or through longitudinal runners, enabling the sheet to be held still and possibly pressure to be applied on it in order to press it against the support. The solution may also include a sealing system if necessary to ensure the airtightness and waterproofness.

### Structures:

That the LSC can act as a beam has many advantages.

Structure: Some cases of application will use the LSC merely as a structural support, with or without covering panels, with or without an outer skin complex to the building. This can be used for various types of uses.

Supporting loads using LSCs: In some cases, the function of supporting load will be useful. Sliding support systems can therefore be used. The support slides may also, in some cases, be used to fix the upper panels. These functions are described in the chapter dealing with mounting configurations.

In some cases, the LSC will be equipped with load-bearing solutions, either by direct screwing or through the use of slides with sliding and adjustable attachments, or through substructures or fasteners of various types.

### Attachments:

The covering panels will be attached to the LSC by appropriate means. These include direct screwing on the LSC, screwing through clamps, attachments via attaching clamps onto sliding elements through the support slides, or holding it still through appropriate profiles.

In some cases of application, we may favorably exploit a central groove in the upper part of the LSC to insert a “T-Clamp” piece suitable for holding the panels while minimizing the gap between them, such as to increase the surface of coverage or of solar sensors.

### The Duct, the Waterproofing and the Accessories

Certain embodiments of invention allow, in some cases of application, to create a ventilation duct under or behind the surface, in the thickness of the skin complex. This duct may be of variable length, width and height, it can be made of various materials and circulate various fluids. This duct can allow a free or mechanical flow of air, or be connected to external networks of fluid circulation.

The sides of the duct can be made of different materials or products (e.g. waterproof layer replaced by glass, solar panel replaced by a glass panel or a diffuser, a grid, a video screen, etc.). Moreover, it is often necessary for the outer skin to be waterproof, not only to protect it from the weather conditions, but also to protect it against condensation, which may occur in the outer skin, especially if the latter is composed of solar solutions (condensation is due to the heat transfers around the solar panel).

### Duct Constitution

The following are examples of configurations.

Full length duct: This duct can cover the full length or height of the photovoltaic underside (or of any panel's underside) without interruption. It may be open to the airflow at both ends or at only one end. The airflow can be natural, mechanical or forced. It can stand alone or be part of a complex system.

Duct of partial length or width: The ventilation duct can be shorter or longer than the panel plan. It may have halfway openings, connections, etc.

Duct opened on some sides: The duct is not necessarily continuously closed on all sides. In addition, it can also, in some cases, be supplemented by a wall from another system (e.g. the roof of the building on which it is built). Lastly, in some cases, ventilation is achieved without all sides of the duct being closed.

Duct connected to halfway air or liquid flows: The duct can be more complex. It may be connected to surrounding ducts or to other systems, it can be connected to the inside of the LSCs, or to the underlying building, etc.

The option of mechanizing the flows: We can introduce forced ventilation means, either into the duct, or at either end of the duct, or at both ends. It should be noted that the LSCs may also play a part in the ventilation process and/or in the flow control. The duct can also be connected to a network as described elsewhere.

### Connected Duct

The duct may be connected to the ventilation, heating or cooling networks of a building, or to an external system. A particular application may include an adjustable system allowing the duct to sometimes do the circulation autonomously, with the air evacuating outwards, and in other circumstances to be connected to the network.

The Ends of the Duct and how they Fit into a Construction

The duct described above may be open to the outside air or connected to an external network. The interfaces with the outside world are therefore different.

### Open Duct

For many reasons (physical protection, protection against insects, animals, grass, etc.), one may wish to secure the entry and exit points of the duct while enabling ventilation.

Devices such as grids, grates, gates, valves or others can thus be used where the duct is in contact with the outside. These closures can take different shapes, materials, architectural expressions or techniques:
1. The closures may be related to the design of the building or structure, be incorporated into architectural elements or be architectural elements themselves. The grid can be decorated or have a specific volume.
2. The closures may be fixed, removable or mobile. In the interest of maintenance, we may wish them sometimes to be openable. The openings can be locked, mechanized, individual or common to several ducts at once.
3. The closures may include mechanical, electronic or smart devices (opening systems, mechanical ventilation systems, sensors, transmitters, etc.)
4. Their conception can depend on solutions of robotization, mechanized construction, maintenance, or system exploitation
5. The end pieces may also play a part in the complex's sealing

In some cases, in particular to improve protection against wind, snow, ice, rain or external aggression, the expert in the field may choose specific configurations, for example by positioning the entry and exit points of air below or above, laterally, or across the LSCs or within another volume.

Devices to clean the vents, defrost them, remove the snow etc. (for example with electric heaters, vibrating devices or by moving parts) may be used too.

The conception of these grids can depend on the maintenance arrangements, such as the outdoor or indoor cleaning, the defrosting.

### Connected Duct

The duct may be connected to a forced ventilation system that is either connected to the main structure, or is linked for example to an adjacent building, or is external. One may wish to re-use the thermal energy generated by the system, or on the contrary to inject fluids in it (such as hot air or cold air).

Each of these cases will lead to tailored technical solutions, but what they have in common is that the inside duct described above will be connected, permanently or not, to blowing and suction systems, usually via ducts or pipes.

The heat exchange operation is described herein.

These outer ducts may be visible from the outside or the inside, or they may be hidden. They may lead to design original solutions as to how to handle technically and architecturally the ends of the system.

With a connected duct, one may want to prevent the water trapped into the outer skin's duct to flow into the connected air duct, using ad-hoc technical solutions.

A possible application is to connect the duct to the air management system of a building.
1. Thermal energy, such as hot air, can be used or recycled through the ventilation, air conditioning or heating system of the building. For example, instead of heating up cold, outside air and blowing it into the building, the hot air can be used, which significantly reduces energy consumption.
2. Thermal energy can also be converted in order to, for example, be transferred to a heat transfer fluid that in turn will supply the heating and cooling devices of the building.
3. It is made clear that this energy can be supplied to the heating or cooling systems of the building, whether the exist (possibly modified) or are to be created.
4. The system and the building can be arranged to share blowing or extraction functions. For example, the duct can be integrated to the building's forced air circuit.

### Direct Blowing

The duct can also be used as an air, heat or cold diffusor, or otherwise when the system is set up in a building. It may become a distribution network.

For example, if the system is also the wall of an area, facade or roof, it can be equipped with vents, possibly adjustable or controllable, that can circulate air into the area or suck it out. Similarly, we can circulate or extract other products (gas, liquid, light, information, etc.).

One can thus create active thermal skins for a building. The LSCs and the duct may have separate or complementary roles, and circulate the same flows or different ones. This skin can therefore control the thermal or hygrometric levels of the outer panels and/or the area. It can, for example, circulate air into the area (e.g. to heat or to ventilate it) and/or suck it out of the area (e.g. to ventilate it). LSCs and ducts can be assigned different roles.

### The Sealing and the Accessories

The duct described above may, in some cases, be waterproof and/or airtight.

Sealing can be achieved in several ways: through covering systems, through the waterproofing layers typically used for construction (e.g. asphalt base sheets, PVC or otherwise), through folded, formed, welded or assembled metal sheets, (e.g. folded aluminum foil, zinc or steel sheet, or other metals), or through other solutions, such as resins or composite-based solutions that are either directly applied to form the duct, or applied otherwise, possibly through a system of joints.

### Waterproofing

According to certain embodiments, the closure of the duct on one side consists of solar panels (in other cases of application, it may be composed of different panels or it may be replaced by other materials, as mentioned above) that do not always guarantee perfect waterproofing to outside water (e.g. rain, immersion, etc.) or inside water (condensation or other). One might therefore be faced with a situation where there is water inside the duct and it might leak. In some cases of application, one may wish for the duct to be waterproof.

### Sealing Solutions

One solution is as follows: a waterproofing layer is positioned between the LSCs or under them, or over a supporting element located between the LSCs or under them. The layer closes down the part of the duct that is opposite to the panels.

### Conventional Configurations

In some cases of application (depending on the configuration, local regulations or the materials used), the waterproofing layer can crawl up along the LSCs on each side of the duct (not necessarily on all LCSs), or up along a different support in order to guarantee the waterproofing function.

The waterproofing layer may also be blocked under a drip or equivalent while still complying with height and quality standards if they apply.

The waterproofing layer may be mechanically fixed if necessary, either by being directly attached to the LSC or to a vertical support, or by being held against this support, possibly by an appropriate device.

This waterproofing layer may be applied in one or more parts, both width wise and lengthwise.

The waterproofing layer may be made of different materials, such as a conventional waterproofing material (e.g. asphalt-based waterproofing sheet or PVC membrane, or an uninterrupted layer posed in hot or cold conditions), plastic (in the form of sheets or casted pieces, for example), metal or any other solution. Every waterproofing solution is here concerned.

### Use of Metal

With respect to sealing, when using metal, one may want to use steel, zinc or aluminum sheets amongst other that would guarantee without interruption the closure of the lower part and the sides, and would guarantee the global sealing of the system lengthwise through overlapping: the upper sheet possibly covering the lower sheet on some distance.

Cases with Large Sheets

An even more reliable sealing solution may be envisaged, in which a single sheet or layer (regardless of its material) is used over the entire length of the duct concerned. If this sheet is made of metal, it may be delivered to the desired size, or manufactured on site with the use of a machine (e.g. a bending machine), which may form a metal of a length not limited by the size of the plates or by transportation problems. The machine could for example be installed on site in order to create on demand some of the piece necessary to the installation.

If, in certain cases of application, one wishes to create a sealed duct that is longer than the LSCs, and made up of several successive LSCs systems for example, an uninterrupted waterproofing can be created, partly by bridging the gap between the LSCs (possibly by introducing a support, sliding or not, to hold it still between the LSCs).

### Dimensional Variations

The LSCs and the whole duct can undergo thermal expansion, the functional play using the gap between the LCSs. The waterproofing solution can undergo dimensional changes that may compromise its effectiveness (if rigid) or its lifespan (if it is flexible and must undergo the dimensional variations that are imposed upon it). Some materials may have the flexibility and elasticity needed. When using rigid materials, one may introduce an overlapping system that allows the upper sheet to slide on the lower sheet in order to adapt to the dimensional changes imposed by the LSCS. If a rigid sheet is used (e.g. metallic) and covers the entire length of the duct it may thus deal with multiple LSCs end to end lengthwise and fixing it onto the LSCs may be a problem: if the sheet is rigidly attached to the LSCs (e.g. screwed or riveted into the LSCs), the dimensional variations of the sheet and the supporting LSCs might conflict. One needs thus to avoid rigidly attaching the sheet to its side supports, at least on some sections of the length.

It can be attached using sliding systems that allow it to be held still while still being able to expand or move longitudinally, independently from the dilatations of supports on which it relies.

### Airtightness

One may wish in some applications (e.g. when using the duct to circulate air) for the duct to also be airtight (note: we can also do the sealing at panel plane level, without using a ventilation duct). It should be noted that airtightness and water tightness may be needed or achieved separately or together. A watertight system is not necessarily airtight.

The technical solution will depend on the components or on the selected cases of application. Regarding the sealing of the plane of the outer skin: if this plane is made of modular panels, the sealing issue between these modules may have to be addressed. If this plane is made of a single panel or a cloth or any other method, adapted solutions may be used in the framework of the embodiments.

Depending on the cases, one may want to deal with a series of problems, some of which are considered below:

Airtightning the Plane Constituted by the Panels, or their Equivalent:

The airtightness between the panels, and between the panels and their support, may be provided by the embodiments of the system. The technical solution may vary depending on the characteristics of the panels, the nature of the supports, the nature of the environment or other factors.

When using conventional solar panels, one solution amongst others may be to achieve a sealing frame around each panel, and to prevent air leakage between the panels. A peripheral joint to the panel may be set up under the lower part of the panel and the panel may be pressed against the support with sufficient pressure to achieve airtightness.

Longitudinally, sufficient pressure between the panel and the LSC can be created in order to achieve the desired level of tightness.

Transversely to the LSCs a series of new parts may be added to provide transverse support in addition to the support on the LSCs. This way, a continuous pressure on the four sides of the panel can be achieved, even in the gap between the LSCs. Therefore, in addition to the previously described LSCs, cross bars would be placed under the panel's edge as a means of applying pressure (e.g., using direct screw, clamps, or pieces that hold the panel by its upper part). The set enables to compress the joint over the entire width and to seal at once around each panel and between the successive panels (See figures herein).

In some configurations, these added cross bars/pieces can also fulfill other functions, including structural rigidity (e.g. be used as bracing or continuity ties between the LSCs).

Joint solutions directly between the panels can also be developed in this framework.

One may also develop or use panels with frames or mounting principles that have favorable shapes to the management of airtightness and/or water tightness.

### Sealing of the Other Sides

If the rear side of the panels or of the outer skin has been made waterproof and a gap exists between the outer skin and the sealing, one may need to verify that the waterproof system is also airtight, and/or to complete it if need be.

One can also design a system to channel the air only regardless of water tightness on all sides. Flexible ducts for example, or other solutions can then be used.

### Sealing of the Plane Constituted by the Waterproofing Sheet as Described Above:

The waterproof layer or sheet may, if it uses appropriate materials and if used in the case of application considered (otherwise, it may be replaced by other methods or techniques), also be airtight. There may be however a sealing problem at every end of this layer: on the side edges and the longitudinal edges.

### Sealing of the Longitudinal Edges

If the waterproofing layer is applied on a single LSC and consists of a continuous sheet over the entire length, it is enough to seal the two ends of the system. However, if the waterproofing layer is composed of several overlapping sheets, we may address the issue of air leakage between the overlapping sheets while guaranteeing the possibility of thermal expansion if necessary (thus of sliding a sheet on/over the others).

A good solution is to use a single sheet over the entire length, which eliminates this problem.

### Sealing of the Side Edges

In some cases of application, the waterproofing sheet will be made of adhesive materials that guarantee by themselves the air tightness of the side edges (it should be noted that all solutions adhesive to the lateral edges or fixedly attached to the side edges will have specific problem to solve if the system runs over multiple LSCs with expansion).

We can also use waterproofing materials (such as asphalt sheets, plastic sheets, or other) with a degree of flexibility or elasticity that can ensure the air tightness on the lateral edges by being pressed against the supporting LSC along the entire length of its side edge (the solution also sometimes works on longitudinal edges). Compression can be provided through various systems, such as a longitudinal piece (e.g. a metallic profile) placed in the side portion of the sheet, which presses the sheet against the LSC along its entire length. The piece can be screwed to the LSC for example, or pressed against it by other devices.

When using non-compressible materials (e.g., metallic sheets), one may use a system of joints comprising a flexible material forming a joint, applied on one or more sides of the waterproofing sheet near its edge, and pressed against its fixed support (such as a LSC) by a compression system (screwing, clipping, stress system or other devices). A device based, for example, on a system of joints and pressure that doesn't involve screwing the waterproofing sheet to the LSC guarantees the airtightness while allowing the sheet to slide along the LSC in order to enable the plays of expansion.

### Sealing of the Two Walls Constituted by the LSCs at the Junction Points:

If the sealed duct has to be extended between several LSCs and if these LSCs are separated by a gap (for example to provide clearance or allow for thermal expansion), one may wish to ensure water tightness and airtightness in the gap between the LSC.

There are then 2 main options:
a. Wrap, possibly punctually, these LSCs with a sealing product that enables an expansion play
b. Place between the LSCs some connection pieces to block the flow of air and/or water while allowing the slidings or distortions necessary to accommodate the change in distance between the LSCs without breaking the system. These pieces can for example be made of metal, plastic or other materials depending on the characteristics of the structure.

### Sealing Between the Ducts, and Circulation Between the Duct or Across the LSCs

In some cases, one may want to create links or connections between two parallel ducts, for e.g., the circulation of fluids or cables, or for various types of exchanges. Cross systems are then to be used. Various solutions will be put forward depending on the case. We will describe here a few examples. Other cases of application are possible.

### Crossing of Cables or Conduits

In the case of crossing cables or conduits: the first priority is to protect the cable against damage, including those caused by being in contact with aggressive elements (e.g., a metallic rail). A hose may cross the LSC from end to end, so as to protect the protective layer of the cable or conduit. When using sealed ducts, joints may be added to ensure the non-circulation of air between the duct and the inside of the LSC, or even between the two ducts thus getting to interact.

### Air Flow

Communication, airflow or gas flow systems can be created between parallel ducts, either permanently or adjustably.

### Circulation Between the Inside and the Outside of the LSC

The LSC can also be used as conductors or pipes. Communication/link/connection/circulation systems between the LSCs and the ducts or between the LSC and the outside, or other environments can then be used. These devices can be fixed, adjustable, automatic or controlled.

The LSC may, for example, contain cables or pipes that may be connected to the outside of the LSC through similar systems to those described above, or through other systems.

The LSC can also be used to circulate gases or fluids. One may then wish to circulate between the inside and the outside the LSC, for example with grids, grilles, vents or openings systems, or with valves or dampers systems that regulate the flow. When using multi-components LSCs, air can also flow, if necessary, between these components.

### Sensors and Accessories

The LSC can be equipped with sensors or any other objects connected to an external network, or a large number of accessories. Their implementation may require special sealing solutions.

### Recapturing or Using Heat or Cold

The system described herein enables the dissipation of the heat generated by solar sensors/panels (or by the outer skin) in order to limit the rise in sensor's (or skin's) temperature (solar sensors' effectiveness decreases with the increasing temperature), and to recapture the heat for reuse.

Conversely, it enables to introduce hot or cold air inside the complex, or to organize other forms of thermal exchanges, including heat transfer fluids-based ones.

All this is also true in other cases: the solar sensors can be replaced by other products, or by glazing for example.

By extension, this solution applies to all cases of roof or facade ventilation, regardless their making process, to any air extraction solution derived from solar skins, and to any system to recuperate that thermal energy, as well as any system that uses the notion of air or fluid flow or storage in conjunction with these skins, whether they are solar or not.

### Air Flowing in the Duct

Device to capture airflows: the proposed system can be thought of as an air duct parallel to the solar sensors (see the passage devoted to the creation of ventilation ducts).

The ventilation principle is as follows: air enters the duct in one place and flows until another point (often an end, but not necessarily). During this course may occur a temperature exchange, particularly between the air and the panels or skin, whatever its nature.

This airflow can be completely natural or controlled (e.g. by opening/closing valves) or be controlled by a ventilation system, or be connected to an internal or external network.

The reverse is also true: it is possible to inject air or fluids into the duct, for different purposes, or to enable or block the flow of air or fluid.

### Simple Ventilation

In this case, the air flows freely in the duct described above. The air can be static or moving naturally (e.g. by convection or under the wind) or through external action (e.g. forced ventilation).

The underside of the panels is a hot surface (possibly, but not necessarily, due to the conversion of solar radiation into heat) and the air introduced into the duct is cooler. A heat exchange occurs as the air cools the panels and becomes in the process increasingly hot, which will improve the electrical performance of the panels and the fresh air will slowly heat from the contact with the hot surface of the panels: we will obtain hot air. It derives that both of these effects can be used.

Ventilation can work naturally. A convection effect causes the hot air to rise and leave the duct, thereby drawing in cooler air at the other end.

The ventilation may also be forced or mechanized to better control the flows. Blowing (e.g. fan) or extraction systems may be used to manage the movement of air.

### Connecting to a Network

The duct can also be connected to external air conditioning system, or to a network (e.g. the ventilation or air conditioning system of a building) or a specific network. The air or fluid extracted from the duct can then be used in different ways: to participate in the heating/cooling of a building (or other structure), to get cold out of hot air; it can be injected again into the duct, used as a heat cushion or as a regulator, etc.

### Use of LSCs

The LSCs can be used to circulate liquids or gases, e.g. carrying hot or cold, and active or passive heat exchange systems between the LSC and the air contained the duct can be created. All devices or applications described herein may then be transposed to these other cases and the devices, functions, uses or systems derived from them, are also covered by this patent.

### Use of Thermal Energy

The use of thermal energy may be thought of in two ways: benefiting the outside, or benefiting the system, and often both.

### Benefiting the System

One may wish to use the heat exchanges or the airflow capacities to benefit the system, in particular to improve its performance or from a maintenance angle.

One may wish for example:
a) To cool the skin, for example by circulating cool air such as in the following cases: 1) in the case of a solar skin, to optimize the temperature of the panels and in turn their performance, 2) in the case of a skin in contact with the public, or a glass skin, etc.
b) Heat the skin, for example to: 1) optimize the operation of the panels, 2) change the physical conditions e.g. during inclement weather, snow or ice, by blowing in hot air.
c) Create a strong air movement, for example: to clean or clear the conduit or to evacuate elements that would obstruct the airflow

### Benefiting the Outside

The thermal energy may be recovered or converted by means of a simple heat exchanger, or used directly.

Conversion: The air extracted from the duct can be fed to a thermic converter that transforms energy, for example by transferring it to a liquid support or by producing cold out of heat.

Direct usage: This hot air can also be used directly to help heat or cool the building or for other uses. In some cases of application, the extracted air may be used for external applications, such as industrial or domestic applications (e.g. drying, heating, or agricultural applications). In other cases, this air can be introduced into the building's air blowing system as a primary source: it is much more efficient to heat warm air to reach the desired temperature inside the building, or to cool fresh air. Other scenarios are made possible by this building system. When used for different purposes, the logic remains the same; the parameters are simply adjusted differently.

Other usages: One may also wish to maintain the skin to a certain temperature to benefit specific functions e.g. this may contribute to the performance or the thermal insulation of a building or its indoor comfort, etc. A hot wall effect can be created (e.g. hot or cold facade or roof), possibly by stimulating or slowing down, or even blocking the airflow, or the system can be used as a diffuser or extractor of hot or cold air into the areas.

### Construction and Maintenance

The cost and reliability of the construction are important components of the analysis of both the solar systems and the building systems. On site assembly is an important chunk of this cost.

To reduce the cost and improve the quality and reliability of the installation are two prerequisites to the development of solar systems. To achieve this, the embodiments include efficient methods, and tools and may include automation aspects.

The maintenance of solar systems is a crucial issue. The embodiments can significantly reduce the difficulties, costs and risks associated with working at heights (e.g., working on a high roof top). Some aspects of these solutions are linked to the characteristics of the system and others may also be used in other contexts.

### Prefabrication

The embodiments relate to workshop prefabrication, on-site prefabrication, the fabrication with post positioning, related robotization, and related methods and tools.

It is advantageous to use working methods and mechanized tools such as those described herein to make the prefabrication process and the on-site assembly efficient.

Here we describe the embodiments in view chunks of the building that are prefabricated in a workshop or pre-assembled close to their final location, or assembled on site but before their final positioning.

In the case of solar skins, entire sections of solar fields can be created, which can be pre-assembled and positioned on the building they were made for or on their allotted location if it is not a building.

In the case of a building, chunks of the roof or facade complex can be prefabricated: instead of assembling the components on site layer after layer, the entire complex (e.g. all or part of the structural elements, the cross rigidity, insulation, waterproofing, ventilation, covering panel and wires in the case of solar panels) will assembled, transported it to its final location and connected to the supporting structure. This will apply to either the entire roof or façade if they are small in size, or chunks of the roof or façade that will be transported finished, assembled, wired and ready to install, or partially installed in some cases. In the most successful cases, there will only be left to attach and connect, and add the finishing touches on the sides, which will save time and money, and improve the quality and monitoring/control. In other cases, we will take the prefabrication as far as possible or desirable. This is made possible by this construction system and its structural qualities.

In the case of an integrated solar skin, or of chunks of roofs or facades, we don't create solar systems but finished chunks of buildings, which are prepared in advance and assembled on site.

### Plug and Play

With Solar Systems:

chunks of solar fields are fully prepared, assembled, wired, etc. either in the workshop or on a suitable location, then simply transported (e.g. by a crane) and installed in their final position. Pre-assembly can be complete or partial depending on the project requirements. With roofs or façades of buildings, the complete sets—which may include the whole skin complex of the building, ranging from the structure to the outer skin (solar panels or other finishing element) and possibly including its sealing, insulation, complementary rigidity, fluids or information circulation and other functions—are prepared in advance and tested before implementation. There is only left then to deal on site with the assembling (including rigidity and sealing of the connections, fastening to the main support and finishing pieces on the sides) and connections. In some cases, prefabrication will only involve some elements, other parts being assembled on site.

Plug and Play:

instead of building solar installations on site i.e. building a structure first and then fixing the panels while connecting them to the power system, a set of operations that usually takes place on site, often on the roof or high up, the sets here are mounted, wired and fixed in advance and they only need to be posed in the desired location. The supporting structure (as well as all the required pre-installed features) that will receive the set will have been set up in advance, regardless whether it is a building or otherwise. In the most advanced cases, there is only to attach the prefabricated part on the support structure, to make the connections and finishing touches, and to connect the cables coming out of the set to a network on hold. This will greatly simplify the mounting since there will be far fewer operations to be done on site. The physical mounting of individual panels, their connection, their grounding, and the tests will be done prior to installation in easier and safer conditions (e.g. in a workshop, or on the ground or on a site chosen for this purpose). This is possible thanks to the structural rigidity of the support that enables the construction and transportation of whole chunks. This is a genuine “Plug and Play” system since the installation can start producing only a few minutes after arriving on site. This involves redesigning the electrical conception of the assembled set and the supporting set.

### Kit Construction

The prefabrication and “Plug and Play” solutions described herein allow for the creation of kit systems, delivered complete and ready to assemble. This may have several aspects as described below.

Kits Ready to be Imposed on Existing Structures can be Created:

The sets will get there complete, and be assembled, connected and installed on the site in just a few minutes. The size and nature of the modules will depend on the requirements of the project, and the size of transport available. A project can be built by assembling several modules. Projects can be made one by one, but a range of industrialized products may also be developed on this model. This applies particularly to the solar equipment projects of existing buildings, residential, commercial, institutional buildings, etc.

Kits Ready to Assemble on New Constructions:

The system may be integrated to new constructions, be them industrialized or not. It will be possible to deliver ready to assemble, “Plug and Play” complete sets to builders who will only have to mount them on site. They will have made sure initially to integrate this solution in the conception of their project. For example, whole ranges of buildings incorporating this technology can be developed, whether they are traditional individual residences, prefabricated individual residences, or various types of constructions incorporating prefabrication, or any other construction project.

Kit constructions: The system allows to envision a revolution in rapid construction: it enables to prefabricate whole sections of buildings, with structural capacity and in some cases energy capacity. It thus becomes possible to design entire buildings conceived with this technology, completely prefabricated and delivered ready to assemble. They may be assembled in a few hours and immediately provide a quality building envelope, and may be equipped with finishing or comfort elements and dispose of their own energy. They can be created one by one or a full range of ready for use products can be created. This is obviously a good solution to humanitarian emergencies, military or industrial applications, temporary housing, unusual geographical situations, housing, offices or other rapid constructions etc.

### Prefabrication

Since the construction system described above is structural, it may have in itself the rigidity necessary to the moving of completed elements, as opposed to the conventional systems that often rely on supporting structures and cannot constitute complete sets rigid enough to be transported.

However, even if the longitudinal rigidity is achieved by the LSCs system, and if specific solutions can also achieve lateral and torsional rigidity, it is undesirable that the finished work deforms in any way during transport and installation operations, especially if the parts have to be tilted in any direction before they arrive on site.

One solution is to create framework rigid in all planes, on which will be fixed the prefabricated elements, possibly from their assembling to their transportation, manipulation and final implementation.

It will be useful to prefabricate the most complete and finite sets possible. For example, in the case of a roof, the project will be conceived with the aim of providing the necessary supports and dimensions. Complete chunks of roofs can be made, including for example their own structure, thermal insulation, waterproofing, integrated solar coverage, but also possibly their ceiling or false ceiling, or elements of lighting, ventilation, etc. In short, everything that makes a roof or is supported by it. This example is obviously applicable to all possible cases such as carports, independent solar planes, facades, roofs or non-solar facades, or any kind of construction. The structures designed according to this method are covered by this patent.

Workshop Prefabrication:

Workshop prefabrication has many benefits, but it runs into dimensional limits related to the maximum size of road or rail travel. However these limitations can, to some extent, be countered since we have developed techniques to connect several sub-elements, so as to create larger final elements after assembly on site. Ideally, the constructions are completely finished before transport. Whether the construction to which the elements are to be incorporated requires extra on site operations will depend on specific conditions.

On Site Prefabrication:

On site prefabrication allows to assemble much larger pieces—as long as we can carry the fabrication tools—(because it is no longer limited by the dimensions imposed by transportation), that can be carried to the point of installation, for example with a crane. The size may then be a large as the structure can build, possibly with the help of large frameworks, or the space available on the site, the size of the crane, the assembly processes, or other parameters. The advantage is that instead of performing mounting operations in difficult conditions, such as work at height, on a slope, in bad weather, in unsafe conditions, or in the absence of sufficient natural light etc., the work will be done in better conditions. The mounting can for example be done horizontally or at ground level or not exposed to the weather, etc. This will include significant financial gains, a strong risk reduction, faster realization, better-controlled quality and therefore better guarantees. A prefabrication area can be set on the ground or in a favorable location and the finished or semi-finished items be transported then.

Fabrication with Post-Positioning:

Construction can also be performed in the final location, but not in the final position (e.g. horizontally) and the chunks be tilted or positioned differently afterwards. For example, this may be the case if large sloping surfaces are built, whether on the ground or on a roof terrace for example. To avoid the inconvenience of having to work several meters high, it is advantageous to build the whole system on the ground and to lift or tilt it at the very end, using appropriate lifting and fastening means. Even the connections may be made in advance, in some cases.

Using Automated Tools:

These mounting methods can be made extremely efficient and reliable when using the automated tools described herein. Staff can also work longer hours in better conditions, at lower costs and with improved safety. With on site assembly (with or without post positioning), the mobile walkway principle can be used as described in the chapter on maintenance. In this case, the walkway is used for the mounting and it supports the machines as they carry out all or part of the assembly operations. In effect, a walkway of this type can be used in the workshop or on the prefabrication site. It can also be used in the case of on site assembly at the final location. There is only to install its rails and guidance systems, even if it is temporarily (if a project requires a permanent walkway, it may of course have it). Otherwise, one can conceive a mobile, removable or adjustable walkway that is brought to the construction site by the installing contractor for the required time.

### Maintenance Tools, Methods and Machines

The technologies described herein also aim to rethink how to build and maintain solar buildings or building skins. The maintenance tools are therefore part of the embodiments.

The tools described below can be mechanical and manual, but they can also be connected to computerized monitoring or a remote control system.

Several methods are described below:
1. The systems operate under human control: an agent placed nearby manually operates the equipment
2. The systems are mechanized: an operator located nearby controls the systems from a short distance via physical connection or radio
3. The systems are controlled by a remote operator that uses the data, measurements, images and observations, controls, commands and upward or downward parameters of the system
4. The systems operate automatically, semi automatically or expertly, via intelligent programs
5. The system can also be used for maintenance by recording recurrently a variety of parameters or observations transmitted by sensors and stored in a central memory. The operations going on may also be recorded.

Rolling Maintenance Walkway:

The plane made of solar panels can be combined to a maintenance tool designed specifically for this purpose. It is always difficult to maintain a roof or facade, especially when the latter is made of fragile materials, as it is with solar sensors, which are often made of glass. Nevertheless, in particular for cleaning or replacing faulty components, it is necessary to intervene regularly on this surface often placed high up or on a slope, which increases the operating costs of the equipment as well as the difficulties and risks. One of the conditions for success is thus to render the maintenance easier, which will enable it to be done more often if necessary (e.g. to increase the frequency of cleaning, which can be very important for solar surfaces). The system proposed here may be used manually, automatically or robotically, depending on the cases.

The Walkway:

A rail is placed in the top and bottom side of the plane concerned (for example a roofing plane, a facade plane or any other building plane, solar or not), and a system consisting essentially of a beam that connects at the top and bottom a rolling system to the rails is set up. It allows for this beam to move laterally in order to go in front or above the plane described above such as to carry out all maintenance operations. This beam can be made in different ways depending on the constraints of each particular case. To simplify, we will call it the “walkway”. The construction system put forward in this patent enables us to build this walkway very simply: the LSCs are usually span on their own length without hallway support and, in some cases, they are attached at each end to the main girders. This girder may support the rail guiding the maintenance walkway. In some cases, it may be interesting to set up this walkway early in the process and use it for the actual construction works. It may also be disassembled and reassembled as many times as needed (e.g. brought on site for construction, and punctually brought back to maintenance). In this case, it can be made so as to adapt to different configurations, to be folded, transported and adapted from one project to another.

The Walkway's Equipment:

The gateway can be made of the rolling beam described above to which can be added various optional equipment. It can be:
a) A simple beam for technical support
b) A walkway for pedestrian traffic, which may include a floor, stairs, railings, or a motorized system.
c) It can feature some equipment for other purposes, such as communication

It may be moved manually or by motor, manually operated or controlled by a computer.

During periods of non-use, this system can be stored for example on the side of the plane concerned, the protrusions can be folded to avoid shadows, or for aesthetic reasons or for other reasons, and the system can even be placed at the back of the concerned plane to avoid any shadows.

The walkway may include a series of equipment and gear enabling the maintenance of the plane, especially if it is a solar plane. These optional gear/equipment may be stationary or mobile, possibly by sliding on rails supported by the walkway. They may also in some cases of application be designed to move in all directions thanks to special robotic arms.

The system developed allows, in some cases, to carry out fully automated maintenance operations e.g. night time cleaning via cleaning tools, lighting, sensors or CCTV.

The equipment and gear may feature:

Watering:
a. From the simple watering hose to sophisticated systems distributed over the entire length,
b. Optionally can be under pressure,
c. Optionally with different angles, possibly adjustable
d. Optionally with water at different temperatures (we may wish to use hot water, for example by recovering the heat generated by the solar systems)
e. Any device that allows to spray, inject, project or use chemicals, cleaning or mending products.
f. All these systems may be fixed, adjustable or remotely controlled

Cleaning:
a) From a simple scraper to mechanized brushing systems, e.g. based on the principle that is used in car wash
b) Systems/methods used in to clean glass facades,
c) Snow and ice removal systems either mechanically, by blowing or by using hot water or other products or methods.
d) The cleaning can also be done manually if the system is equipped to transport people

Lighting:
a. Technical lighting of the concerned plane
b. Lighting of the structure (e.g. lighting of the supporting building)
c. Lighting, luminous displays or other signals meant to be viewed from the outside
d. Devices to flash a panel (measure its performance for a given lighting)

Other:
a. All camera controlled systems and other sensors, transmitters or testers
b. Cameras, thermal sensors, electrical sensors, weather sensors, wind sensors, motion or presence sensors, or any other sensors that can be installed in order to either work on the concerned technical installation, or for other purposes.
c. Positioning accessories/devices e.g. GPS or other millimetric devices etc
d. Devices to measure the light, sunlight, impact, etc. (this allows to remotely control a solar system and analyze its performance)
e. Different accessories such as ultrasonic, alarm, radar or light transmitters etc
f. Robotic tools to perform direct manipulations, tests or interventions.
g. Articulated robotic arms that can perform various functions, and various mechanical tools or tools with a specific task
h. Panel testing systems, e.g. flashing, electrical test, waterproofing test, etc.

Building or maintenance systems, such as systems designed to hold, lift or set up panels or other components like thermal insulation boards, waterproofing, etc, robotized screwing/unscrewing systems that are either fully automatic, either remotely controlled by an operator.

Alternatively, a similar multifunction system can, in some use cases, be achieved without a rolling walkway but with articulated arm systems that fulfill the same functions but on work of different shapes or conception processes.

Depending on the configuration and the application, the system described here may be permanently installed on a plane (e.g., roof), or be moved around from structure to structure when needed. Only the supporting rails will then be fixedly attached. The automated construction operations are describes below.

Walkway for Several Planes:

The above-described walkway was described in the classical case of a building in order to simplify. Let us now imagine that this walkway is used for several locations instead of one.

Not only does it roll on a rail that is parallel to the roof, but, if the site has several comparable planes, it can be used successively for several planes. It can move by itself, using a rail system or be move from outside, for example with a crane

The system embodiments can be used not only for buildings: it can become a totally new tool and method for building and maintaining large ground mounted solar plants, which often feature dozens or hundreds of parallel solar planes, sometimes hundreds of meters long. If these planes are built using the above-described structural LSCs and if the planes are long enough, the solar plant can be built and maintained using this walkway principle, thus generating considerable cost reductions and performance or quality enhancement.

The walkway can be a mobile version. The contractor's tools would include such walkways that would be made to adapt in size or specifications to different projects or sites. The contractor brings the walkway, may be dismounted to be remounted on site, installs it on the on purpose rails parallel to the plan to be worked on, and the manual or automated operations can start. Same is true for maintenance operations.

Use in the Workshop:

The same principle of walkway can be used for prefabrication operations. As we shall see below, such a walkway is used to perform the construction of chunks of buildings, be it on site or in the workshop. The walkway's design, construction, programming, equipment and use are similar.

Robot for the Inside of the Duct:

The system described herein enables the creation of ventilation ducts on the underside of solar panels, and more generally to create space behind or below the surface plane, whatever its nature. We may thus need to access this space or to perform maintenance or observation operations or otherwise.

It is essential that a ventilation duct is unobstructed and free of obstacles, spider webs, nests, debris etc., but also to ensure that nothing is damaged and everything works perfectly. If there is a problem we need to be able to solve it. It is also desirable to be able to perform tests.

The use of the system described here is not limited to cases with a solar skin and a system of LCSs: by extension, the system can be used for any other case.

According to certain embodiments, a robot can be sent, regularly or when necessary, into the duct for inspection or maintenance; at night, for example, when the system is idle.
a. Basic scenario: the robot carries out a straightforward video inspection under remote control.
b. More advanced scenario: the robot goes to the site on its own, opens the doors of the ducts, films and analyses the images to detect potential problems. He can at the same time can suck, clean, measure, etc.
c. More advanced scenario: The robot is sent on site by the central computer control of the solar system because it has detected a problem. He inspects the scene, films and analyses the images, finds the problem, submits its analysis and proposes a possible intervention to the human controller who gives out the necessary instructions. In some cases, the robot can fix the problem by itself.

The embodiments will benefit from the fact that the proposed construction system has parallel LSCs on both sides of the duct that is thus closed. The LSCs will be used to guide and/or support the robot that will be able to move within the ducts for review, maintenance or to carry out different interventions.

The robot is like a carriage that runs on, under or between the LSCs. It may be motorized or may be moved by an external force. It is designed to adapt to all configurations of surfaces that may be inspected, such as ducts, and can be made or tuned in different ways, including with variations in width, height, length, inside space arrangement, climatic conditions, slope and other parameters, and functionalities. For industrial production, there may be adaptable versions that have a common chassis and adjustable or configurable parts.

In its simple version, it is connected by a cable/winch ensuring mobility and/or safety, and by cables in which circulate power and data. In more elaborate cases, the robot is powered. In some cases, it can use the LSCs as data and energy carriers, or transmit data by radio.

An example use is the regular inspection and maintenance of the ducts, materials or equipment that can be inspected from the LSCs. Depending on the nature of the installation, the inspection may be outsourced to a contractor that will adapt its robots to site conditions, complete the mission and leave with its robots. In other cases, there may be on-site equipment tailored to the requirements of the site.

In some cases (e.g., on large sites with difficult access), the maintenance may be automated: a rail may be set up parallel to the plane at the end of a series of LCSs and it brings the robot to the entry of the duct (or to the gap between the rails in some cases). The robot is inserted into each duct successively or into the selected duct. The grids that close the duct should be designed so as to allow for easy opening by this system. The system of rails and beams described above for the maintenance walkway of the upper part may also be used here by combining the two functions. The walkway and the robot may work together.

To avoid damaging the equipment or the connections, the set will be equipped with sensors to detect obstacles and/or with cameras or sensors to identify them before making any decision. The robot can be autonomous, remotely controlled or semi-autonomous, i.e. working autonomously until a human pilot takes control.

The robot can be equipped with range of tools and gears, which will continue to evolve over time. These tools may include some of the following:
a. A system of camera control or other sensors, transmitters or testers, or more
b. Cameras, thermal sensors and humidity sensors, electrical sensors, weather sensors, wind sensor, motion or presence detectors, or any other sensors may be installed, either to work on the technical installation concerned or for other purposes.
c. Positioning amenities e.g. GPS or other positioning equipment
d. Different accessories such as ultrasonic, alarm, radar, light transmitters or etc

Lighting:
a) Technical lighting of the concerned area
b) Infrared lightning, or with a particular radiation (e.g. to detect structural flaws or other visual information)

Watering:
a) From a simple watering hose to sophisticated systems distributed over the entire length,
b) Optionally under pressure,
c) Optionally with different angles, optionally adjustable
d) Optionally with water at different temperatures (we may thus wish to use hot water, for example by recovering the heat generated by the solar systems)
e) Any device that allows to spray, inject, project or use chemicals, cleaning or mending products.

All these systems may be stationary, fixed, adjustable or remotely controlled

Cleaning and aspiration:
a) From a simple scraper to mechanized brushing systems, e.g. based on the principle used in car washing, with a brush designed to avoid any risk of damage
b) System and products used in cleaning glass facades,
c) Systems of snow or ice removal, either by mechanical removal, by blowing or by the use of hot water or other products
d) Local sucking or sucking that is connected to a centralized system
e) Robot vacuum cleaner type technologies that are able to reach every corner automatically may be used

Robotic tools to perform direct manipulations, tests or interventions.
a. There can be articulated arms and tools that can perform various functions, mechanical tools or tool that can perform specific tasks. The robot may be able to perform complex operations such as connections or assembly/disassembly.
b. Systems can be conceived to test the panels, as well as vacuum systems for holding, lifting or setting up panels, robotized screwing/unscrewing systems, either fully automatic or remotely controlled by an operator.

Another possible use is participating to the construction works of the outer skin, or of the solar system, using the robotization and automated construction principles that are described below. See dedicated paragraphs.

The robot may also be programmed to perform expert functions.

Note: This tool may also be used, in specific variants, in configurations where the duct is open and it is only aimed to circulate near the surface of the main plane.

### Robotization: Processes, Tools and Software for Robotized Mounting

Automation makes sense in this industry because we are describing a completely repetitive process: the complexity of millions of different buildings turns into assembling very similar pieces. The panels are often the same, as well as the LCSs. So, the waterproofing or insulation is often the same, etc. Most of the processes are performed lineally and are well suited for automation. Most of the manual operations are painful and dangerous if performed on a roof. They are easily repeatable by a mechanized process.

The complex task of building a solar roof can be decomposed into a few simple operations that can be performed hundreds of times a day per ad-hoc machines under computer supervision. This is will be a real step forward in the building industry and will make building using the invention more cost effective than classical roofs.

The software can comprise components, each one performing one function, for example. Specific functions are activated depending on the specific case.

The assembly of the roofing complex (or other cases of application) can be performed either in the workshop (prefabricated), either in an on-site workshop, or on site. In each of these cases, the invention proposed here enables to robotize all or part of the assembly operations.

The automation or robotization of the building industry have run into the problem that the works are all different and that in the absence of repetition, the robots are not always effective. But embodiments of the system solution we have described herein enable a high level of standardization: it relies on the size of the modules, the solar panels or the plates, which is constant and known in advance. Then, the system embodiments transform the whole construction of a roof or a façade into a meccano game, and the spacing used is defined by the dimension of the surface panels. All components are repetitive: the LSCs, sheathing sheets, insulation plates, waterproofing, etc., and are always mounted in the same way from one site to the other with several variants options. It is possible to develop and test methods and tools for application in the workshop before deploying them on site.

In addition, one will try as much as possible to prefabricate entire complexes instead of applying successive layers like it is done traditionally in the building industry. This is an ideal case to develop prefabrication, automation and robotics. It is a revolution in the building industry.

According to certain embodiments, the tasks performed by robots may vary depending on the projects and the level of prefabrication. Depending on the case, the technical definition of the project to develop, the availability of labor and the technological advancement of robotics, the tasks may be distributed variably between robots and humans agents.

According to certain embodiments, robots may have their own lighting, positioning and devices of control and self-testing. All operations are recorded and the information is stored. In addition, if the numbering of the assembled parts can be accessed, a complete history of the installation can be recorded, and then transmitted to maintenance.

According to certain embodiments, robotized installation, combined with 3D design, allows to simulate the installation before it takes place and then carrying out according to the plan. The system continually monitors its own work and will detect any difference between what it does and what is expected. If necessary, it may ask for outside assistance.

According to certain embodiments, the elements are prepared in advance, numbered according to plans, and supplied close to the mounting robot by a delivery robot. The preparation of the parts may also be partially automated e.g. to test some of the panels, cut some planks or check the dimensions, the preparation or the wiring, or otherwise.

According to certain embodiments, the robot knows the plans of the work to be performed and has several means to navigate in space and position itself precisely. In case of discrepancy, it will call for assistance.

According to certain embodiments, the settings may be recorded; everything filmed and lighted if necessary. The installation may take place day or night. For example, may be recorded the tightening torques used, the connection tests or the performance of the panel on the day of installation, etc. The cause of a possible failure may thus be found, while noticing that the reliability is much better than if it had been assembled manually due to the precision of the tools and the quality of controls.

Necessary tests are carried out at every step, and recorded. In case of failure, an alert is raised and the system may either automatically intervene or seek outside assistance.

According to certain embodiments, some of the installation tools may be stored on site for future maintenance, especially in very large installations. In other cases, they are kept in an installation tools kit that will be recovered after use. A large site may also have a single mounting kit that will be set up where it is needed, if necessary.

In addition, according to certain embodiments, all or part of the assembly operations may in some cases be performed manually, but retaining all the benefits of the quality controls described above: the elements remain numbered, and it remains possible to film the whole installation operations, plus to know who is responsible and liable for each move. Optional tools can be designed to record and send the information to the computer system that controls the execution. For example, the screwdriver used to fix the panels may record and pass on the dynamometrical torque used, the time of the screwing, and check its quality. This principle may be applied to all construction tools, for example for the creation and control of the connections, for electrical testing, for checking the seals etc.

### On Site or Workshop Assembly

The Process:

If there is a maintenance walkway as described above, it may be built before the roof so as to be usable for installing the roof. The tools and process are then quite similar to those used in the workshop. If there is no maintenance walkway, or if the mounting conditions are different, one may either create a provisional one (this equipment becomes part of the equipment of construction), or support the robots with other means, but either way the principle remains the same. Robots can ensure or contribute to all or part of the following tasks (more tasks may be added during the development of the concept):

Installing the LSCs:

Setting up the LSCs may be done differently depending on the project. When there is prefabrication, they will be installed in the workshop on the supporting cross beams and will be fixed manually or robotically, with the option of using a framework to ensure exact positioning.

The LSCs are attached to the main structure: fixed structure in the case of on site assembly, portable structure in other cases.

Mounting the Accessories:

Depending on the case, there may be the various components of the system e.g. a plywood, insulation, waterproofing, etc that need to be set up. Their installation may be manual or automatic (in this case, carried out by the same robot or by another one). The repetitive nature and the quality requirements of the installation of pre-cut wooden boards or of pre-cut insulation plates, and their possible screwing onto the LSCs (for example), are easy to robotize in the workshop, and a little more difficult to achieve on site.

Optional Installation of a Waterproofing Layer:

There are several ways of waterproofing. All may be installed in an automated way, the tools being adapted to each specific case.

Flexible Waterproofing:

In the case of using a flexible waterproofing layer, for instance by using asphalt-based sheets, the sheet will be rolled out between the LSCs, and shaped to the desired profile, possibly by using heat, then it will be carefully applied onto the sides while the planned fastening is carried out. This operation is laborious and delicate when performed manually, when working at height or in bad weather, but here it becomes fast and of a consistent quality, defect-free, and real-time controlled. It can be automated due to its repetitive nature by taking advantage of the proposed system.

Synthetic-Based Waterproofing:

When using plastic or resin-based materials, the tools and processes may be adapted accordingly.

Metallic Sheet Waterproofing:

When using a bent metal sheet, it is possible to prepare in the workshop the plates, formed and cut to the correct profile. But here, a mobile and adjustable bending machine may also be developed to fit the needed profiles. Fixed to the end of the duct, it uses a roll of metal foil that it rolls out and shapes directly at the outlet of the duct. The sheet is set up in the duct as it comes out of the folding machine. The folder may move from duct to duct along the rail if there is one. It creates a long, continuous sheet (ideally of the length of the duct, but in some cases several sheets may have to be used), which will slide until it reaches its allotted slot. A precise check is performed on site. Then the mounting robot implements the pieces that hold the sheet still.

Air Tightening:

One or more additional stages may be required for airtight mountings, or when assembling accessories, or in particular configurations.

Installing the Panels:

The robot brings the panels, flashes them (this is an optional operation that can be performed at another time), positions them precisely, connects them, attaches them (this procedure may vary depending on the type of installation) and if necessary, adds accessories and finishing touches.

An Example of an Automated Process:

To illustrate, let us use the example of building a solar roof on a building. It should be noted that building a large solar plant at ground level, a carport, or a non-solar building that uses panels would be relatively similar. It should also be noted that the technical settings will vary with the nature of each project; this is only one example of how the process works.

The automated process could be as follows:
a. Step 1: the components are prepared, cut, numbered (e.g. with RFID chips or other identification solutions). At this point, it should be noted that the panels may be flashed for selection before installation if the necessary equipment is in place. This allows for elements with the same characteristics to work together, and thus increase the overall performance.
b. Step 2: the support is prepared: in this case, it is the supporting building along with its main beams and rails guiding the walkway. An exact tracing would enable us to determine the future position of each roof LSC on the roof.
c. Step 3: A verification of the support is performed. It can be done manually, with the operators benefiting from the presence of the walkway to inspect the construction more closely, or the walkway may conduct verification operations. A level control may also be performed and the misalignments be compensated by implementing specific solutions (e.g. wedges under the LSCs)
d. Step 4: The LSCs are brought onto the walkway, the walkway takes them to their assembly point, lifts them and implements them. The walkway double-checks the positioning and fastens them either manually or automatically.
e. Step 5: plywood plates (sheathing sheets) are brought onto the walkway, which positions them between the LSCs, secures them and screws them in.
f. Step 6: thermal insulation plates are brought onto the walkway, which positions them between the LSCs, secures them and attaches them.
g. Step 6: the walkway is equipped with the tool that creates waterproofing plates of all lengths, profiled and cut made-to-measure. The waterproofing sheets are created on site and set up, held still by suction. They are then put in place with the tools available on the walkway.
h. Step 7: the solar panels are brought onto the walkway, possibly after a sorting phase depending on the tests. The walkway lifts them with its suction pads and sets them up on their final location. It fixes them to the LSCs using for example its screwing tools.
i. Step 8: the inside robot works under the panels in parallel. Each panel may be flashed if necessary. Then the robot (or a human intervention) plugs the connectors on the underside and stores the cables on their allotted slot. An electrical test on each panel is carried out.
   The solar roof, thus, is built almost automatically. The main elements have been numbered and identified, and all the mounting or testing operations have been recorded or filmed. A database keeps a record of all the operations. It is the same for maintenance. This data may then be used to analyze the life of the equipment, but also in case that there is a problem.

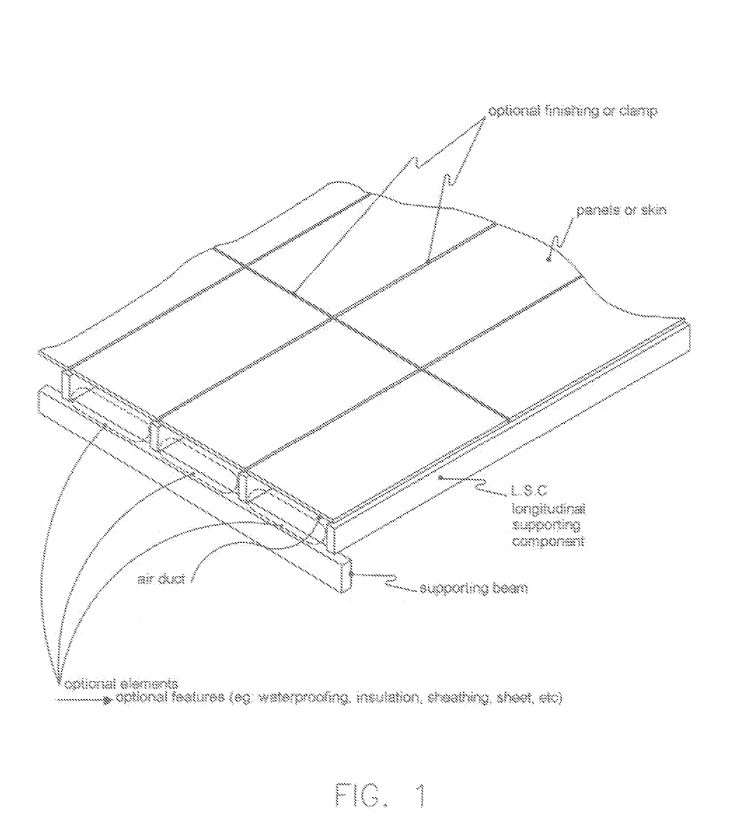

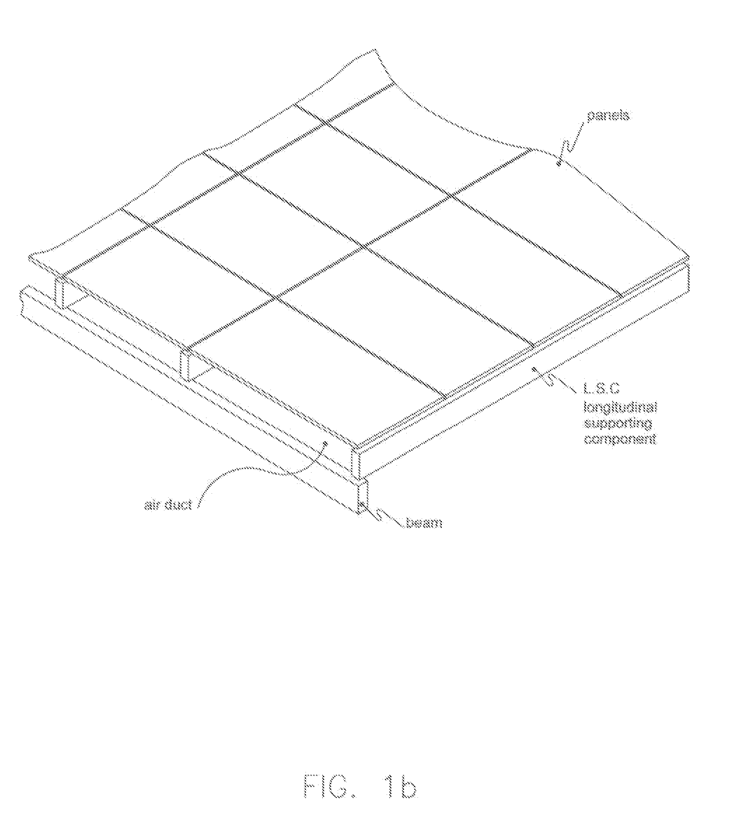

### FIG. 1

This perspective view shows a typical example of application of the invention. The outer skin is built in lieu of a classical roof, not on top of it. The same system could be a facade.

In this case, the outer skin complex is made of several layers: a supporting beam, which can be any structural component of a building or of the supporting structure, bears Longitudinal Supporting Components (LSC), which bear the top layer of panels.

The LSCs are parallel to each other, and following the slope, if any. Their spacing is variable, generally equal to the panels' width or length, if the top layer is made of panels.

The space between the parallel LSCs may be used as an air duct if needed. This air duct may fulfill many functions, including ventilating the skin, for example when it includes solar panels.

If the top layer is made of panels, fixation clamps or finishing components can be used if needed or desired.

The invention enables to meet a wide variety of requirements and to build many kinds of skins in many different cases. The cases of application may include a lot of optional features, such as waterproofing, insulation, sheathing sheet, structural components, fire protection, people's safety, loads bearing, etc. . . . .

### FIG. 1b

FIG. 1b is the same as FIG. 1, but it shows a case in which the covering panels are installed in landscape direction and the LSCs are spaced accordingly.

NB: the top covering layer could be made of a continuous surface instead of panels.

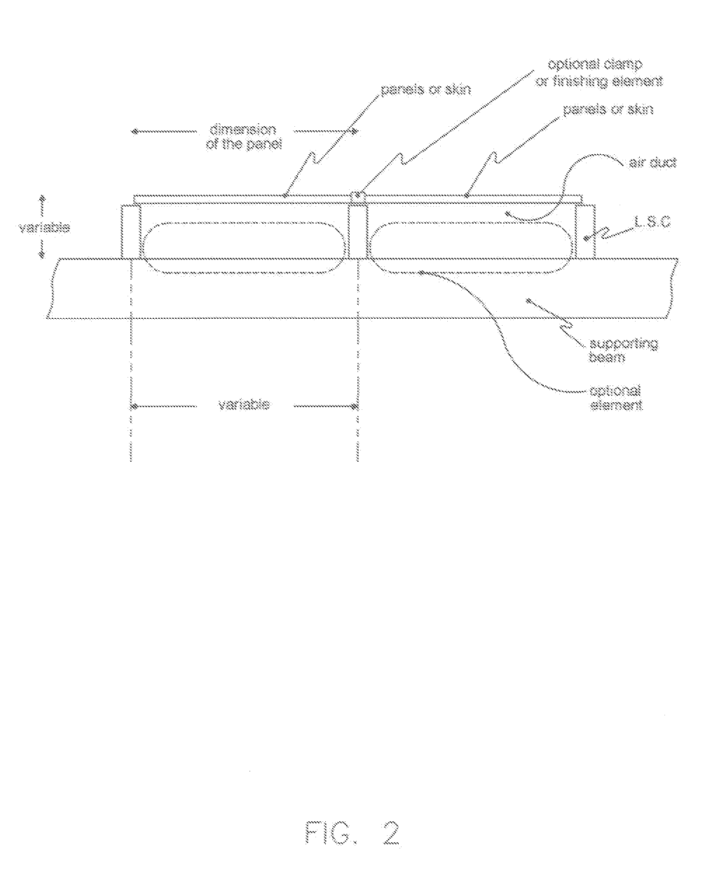

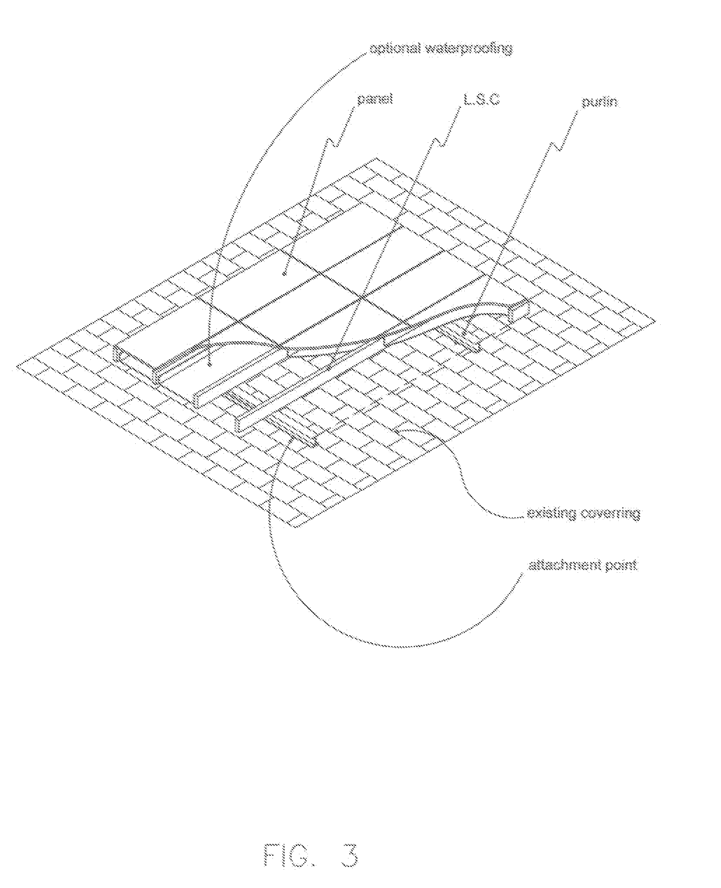

FIG. 2 shows a section view of the same configuration.

The LSCs' height is variable as well as their spacing.

The LSCs are attached to supporting beams, which can be any structural component.

The upper skin or the panels are attached to the LSCs, possibly screwed to the LSCs or using optional clamps, and finishing elements can be used between the panels.

The space between the LSCs can form an air duct under the outer layer.

Some optional equipment may be installed between the LSCs or below them, or even above them in some cases.

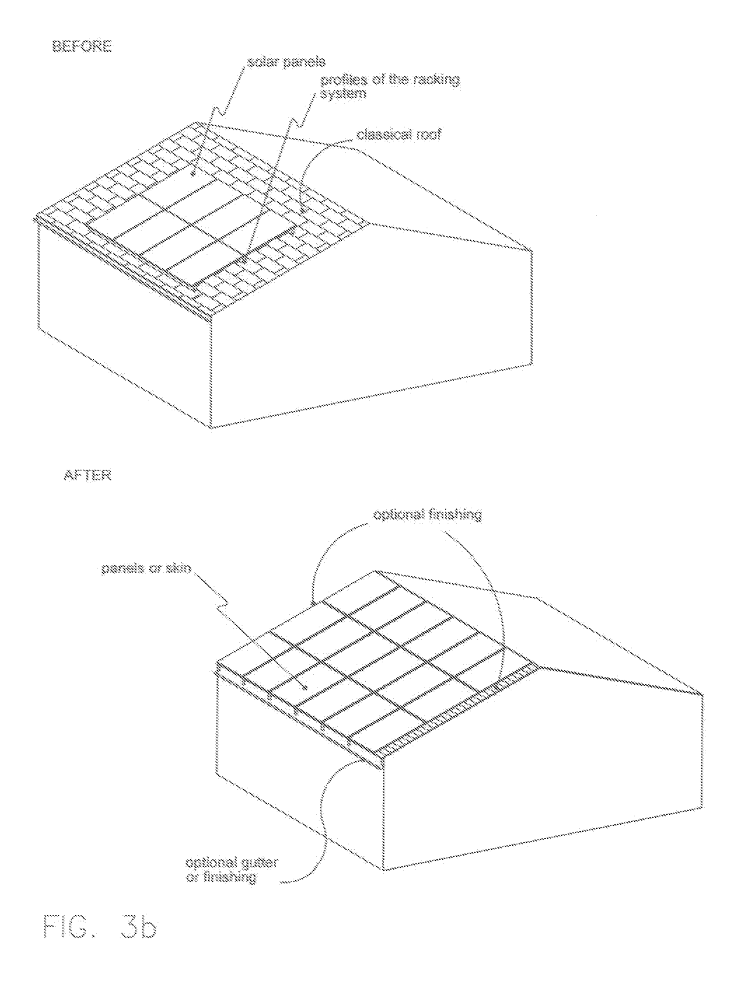

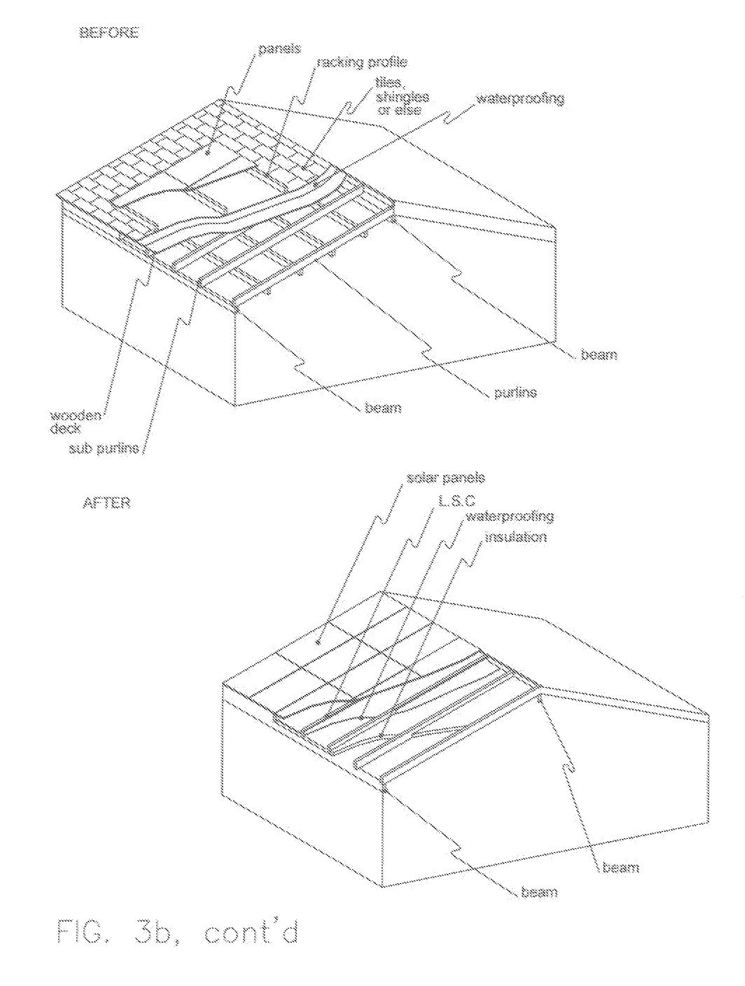

### FIG. 3

This perspective view shows a case of application in which the invention is not used as a replacement of a roof: it is used to create a mounting system on top of an existing roof. For example it can be used to install solar panels on an existing roof with very few attachment points, thus reducing dramatically the leakage risk due to puncturing the covering, as well as the cost of labor. In this example, the LSCs are supported by 2 transversal purlins and these purlins are attached to the underlying structure by very few fixations, ideally only 2 per purlin. The structural capacity of the LSCs is used to create long spans from a purlin to another.

Optionally, a waterproofing solution can be included in the set, in order to further reduce the risk of leakage (if no, or very little water runs on the existing covering, the risk of water leaking through the attachment points is very much reduced. To run on the roof, water would have to flow from the top of the sloped roof, above the outer-skin system, and in many cases this can be prevented by proper design).

FIG. 3b

This figure shows 4 perspective views of the same typical building. The 2 upper views show completed buildings and the 2 lower ones are exploded perspective views showing how the roofs are built.

The 2 left views (top and bottom) show a classical roof (one example among many other possible ones), noted “before” and the 2 right ones, noted “after”, show an example of application of the invention's outer skin solution.

Both have solar systems. In the classical set, a racking system is mounted on a classical roof in order to attach solar panels. In the proposed set, the solar system IS the roof and there is no need for an additional structure.

In the classical set, a classical carpentry made of beams, purlins and sub purlins supports a roofing deck (generally a wooden deck or a metal deck), which is sometimes used as a sheathing sheet helping to create a diaphragm, and which supports a waterproofing layer and a covering such as tiles or shingles or else. Then, if a solar system is desired, a racking system has to be created, comprising racking profiles, which support solar panels. This means that an additional structure is built on top of the previous one, and it has to be attached to the roof. It turns out that most of these mountings include aluminum profiles installed on the slope, parallel to the gutters, which means they stand in the way of the natural hot air flow below the panels and do not help their ventilation.

In the proposed set, the new system completely replaces the roof, instead of being added to it. It may constitute the whole roof of the building or a part of it.

The top layer may be made of various products, including panels (or even solar panels) as well as glass, grates, walkways, etc.

The roof may be completed with various accessories, such as gutters, air duct grilles, optional finishings, etc. . . . .

There is no need for purlins or sub purlins because the LSCs are strong enough to span from the top beam to the lower beam (in the case of large roofs or of special buildings, the set may be different, but the LSCs may still replace a large part of the carpentry).

The set may include thermal insulation (often between the LSCs or below them), waterproofing, may be a sheathing sheet supporting the waterproofing layer, or other features.

Solar panels may be the top layer. They are attached to the LSCs without any need for a racking system. The solar panels get warm, but air may flows in the air ducts created by the LSCs' parallel and slope-wise mounting, and ventilate the panels. No leak is to be feared since there is no racking system puncturing a waterproofing sheet.

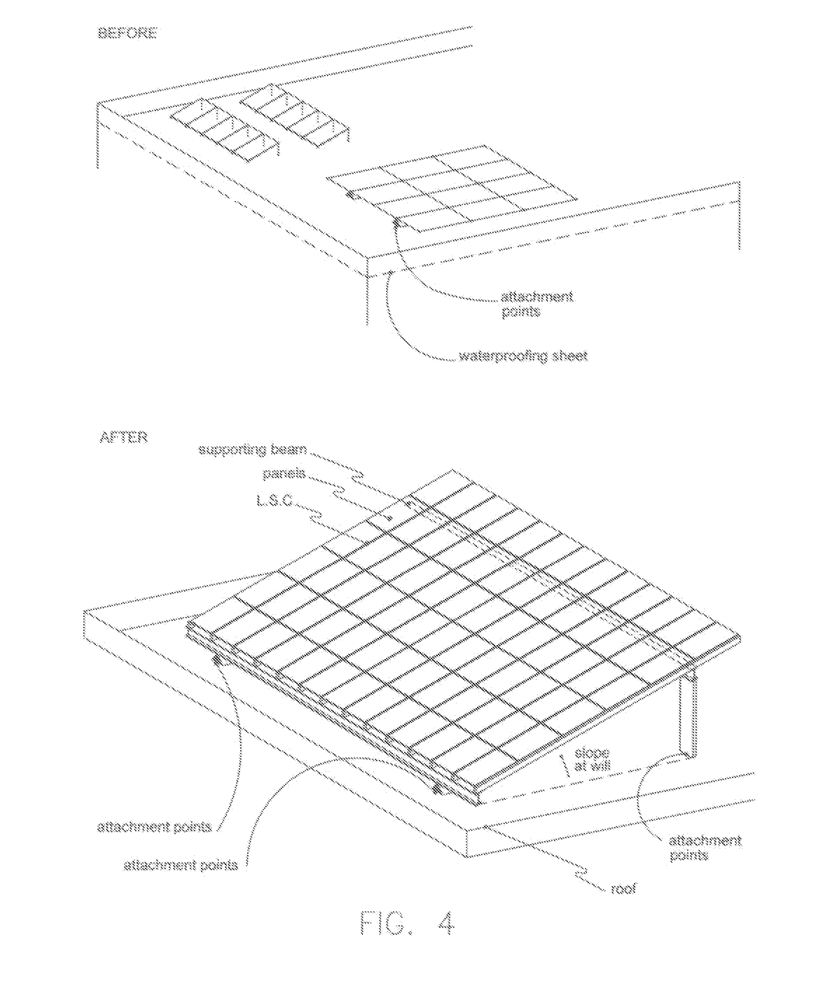

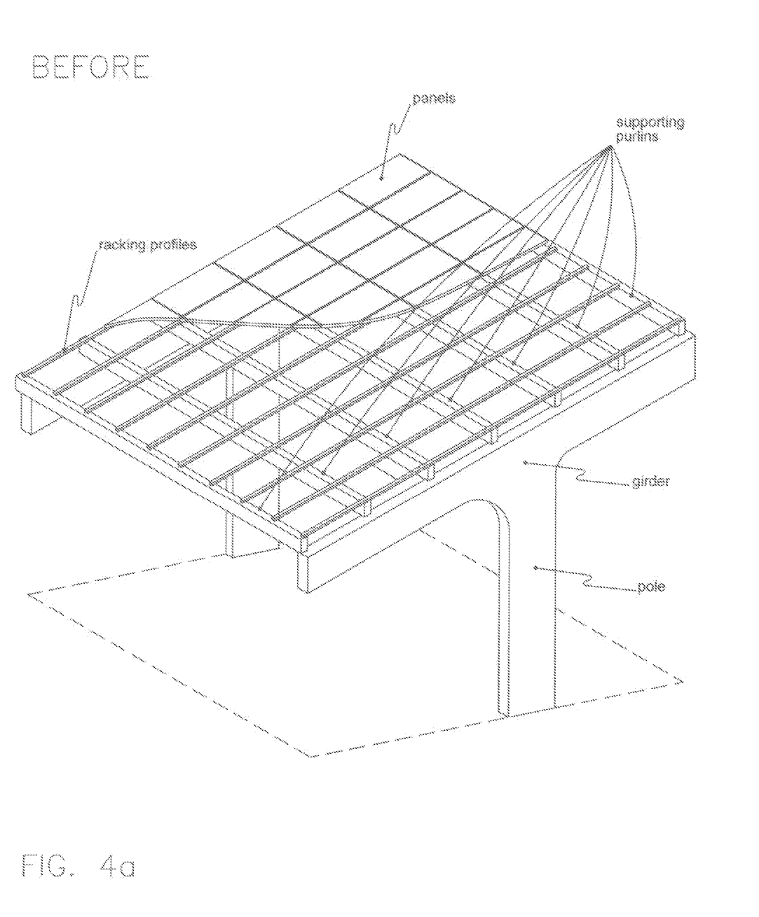

### FIG. 4

This figure shows various ways of creating a solar array on an existing flat roof.

The upper drawing, called “before”, shows 2 examples of solutions solar installers had to use, before the invention, to attach their panels. On the left example, they would create small sloped racks, which would hold a few panels per row. They would have to create many rows. This solution often means few panels can be installed and many attachment points are required, which is expensive and a source of leakages. On the right, another very classical solution is to install panels horizontally, which means more panels can be installed but they are less efficient because they cannot optimally face the sun. All that we said before about attachment points and their drawbacks is still true.

The lower drawing, called “after”, shows an example of what the invention enables in such a case. A very large and continuous array of panels can be created, since the LSCs are structural components: they are able to span from a top beam to a lower beam (these beams do not need to be at the end of the LSCs, there may be some cantilever). This way, it is only necessary to attach these 2 beams, optimally with only 2 points per beam, so 4 attachments for dozens or hundreds of panels, to be compared with dozens or hundreds of holes in the previously described solutions. The solar array can very easily be sloped at will: it only takes to raise the upper beam and support it with poles . . . .

This example shows that the invention can be used to completely replace any kind of solar racking system, even if the intent is not to create a building's roof. Optionally, the set can be equipped with an infinite number of additional features and fulfill a lot of additional functions.

### FIG. 4a

This figure shows 2 perspective views of an example of a solution for a carport, possibly a solar carport. The upper view is the classical one, the lower one is an example of what can be achieved using the invention.

In the upper view, which shows the previous kind of solution, the solar panels are attached to tiny racking profiles. Being too weak, these profiles have to be supported by many transversal beams, which in turn have to be supported by girders and poles.

In the lower view, which shows an example of what the invention enables, we understand the advantage when the profiles on which the panels are attached (the LSCs) are also a beam: most of the layer of supporting beams is no longer needed. So, in this example, the LSCs are only supported by 2 beams (one on top, one on the bottom). As a result, the construction is much quicker and economical.

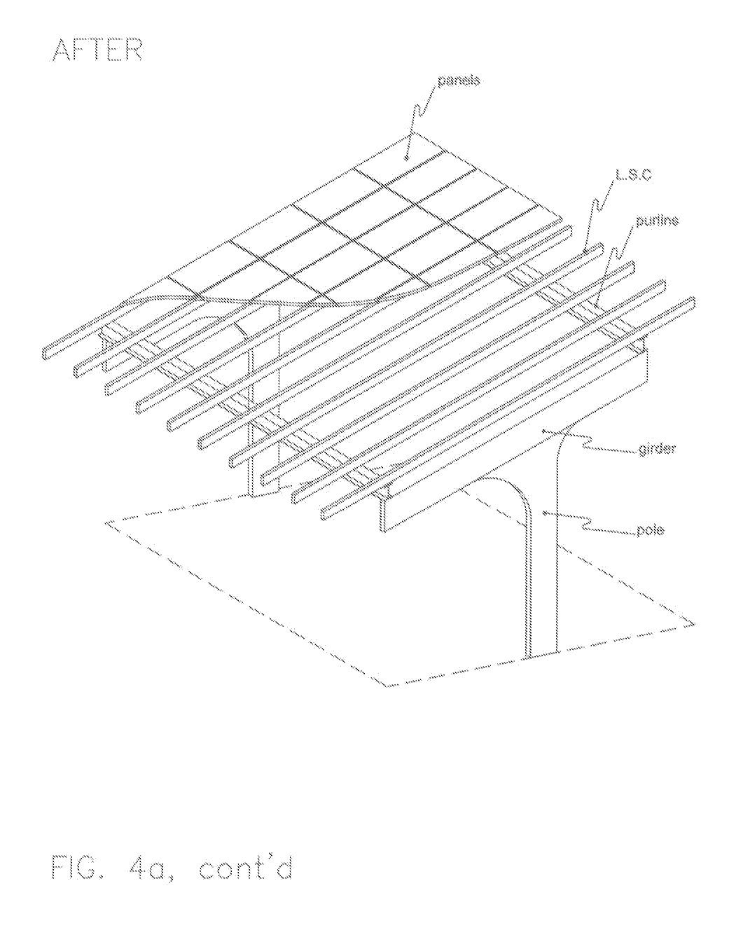

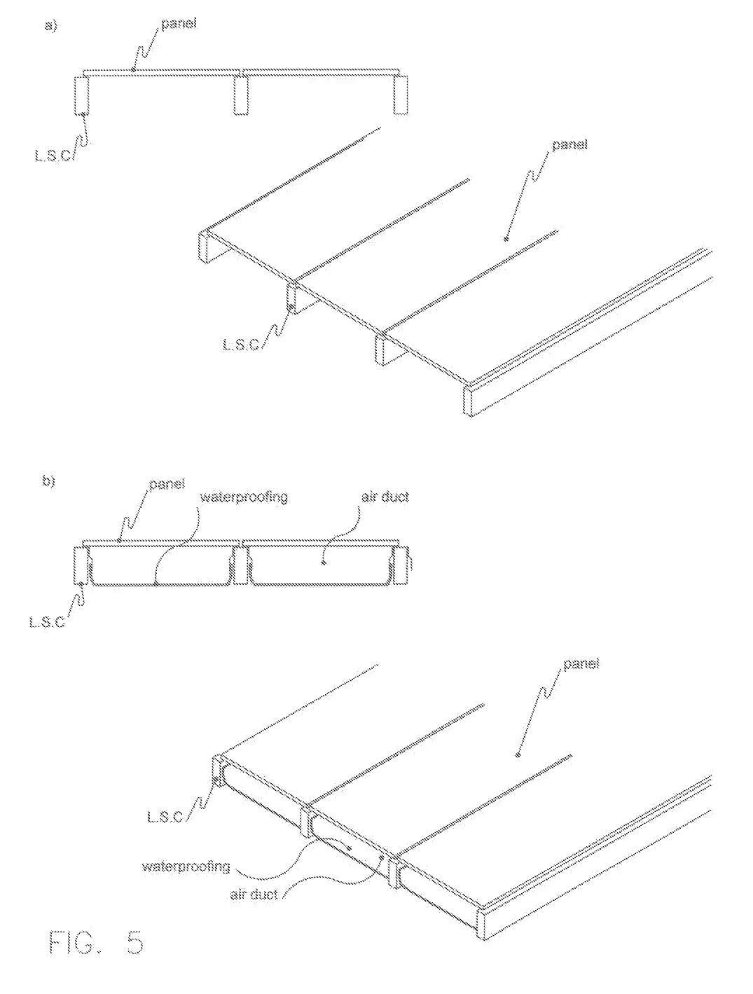

### FIG. 5

This figure shows various examples of application of the invention, forming various kinds of outer skins. Building the solutions showed in these schemes may imply specific components.

Each case is illustrated with a section on the left and a perspective view on the right.
a) Simple case: Panels (or other skin) are attached to parallel LSCs
b) Waterproof skin: same as above, but a waterproofing layer is added between the LSCs. The skin becomes waterproof while the space between the LSCs becomes an air duct.
c) Insulation: same as above, but an insulation layer is added below or above the waterproofing layer, between or below the LSCs.
d) Diaphragm: same as above, but a rigid sheet (for example a plywood or a metal sheet) is placed between or below the LSCs, below the insulation layer.

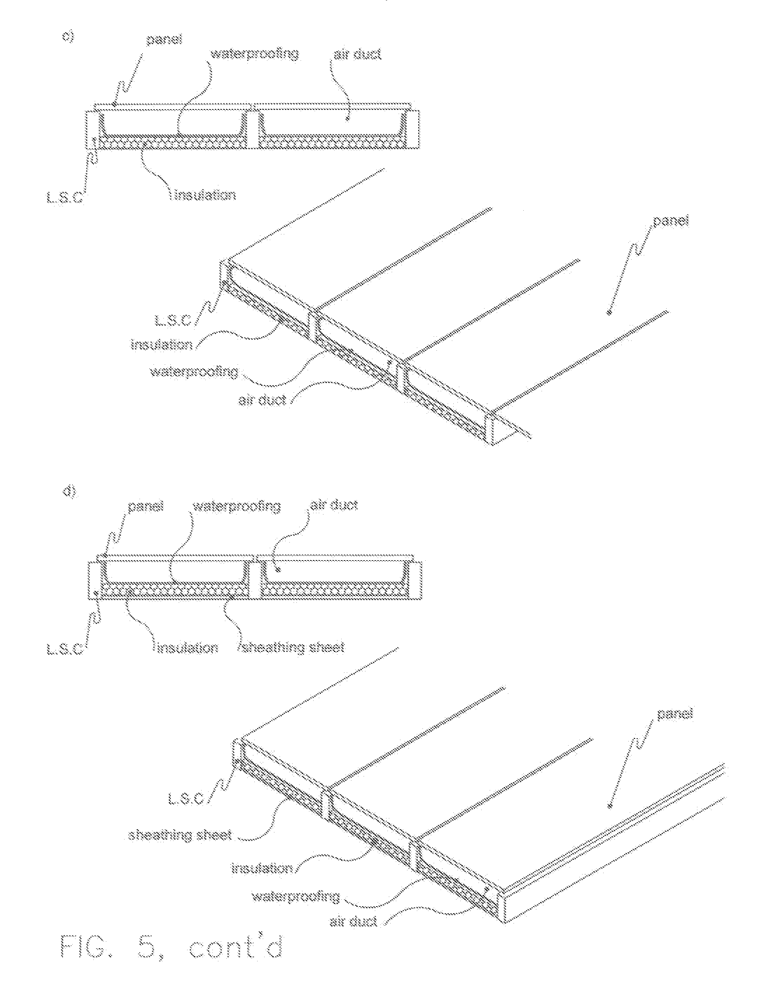

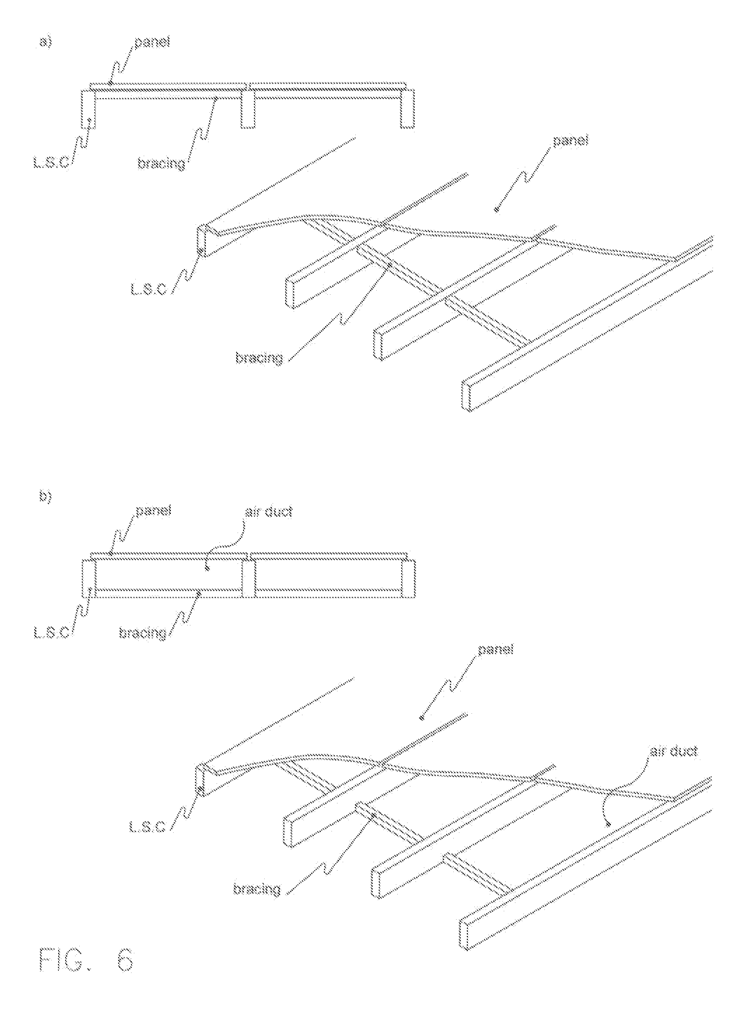

### FIG. 6

This figure shows various examples of application of the invention, forming various kinds of outer skins. Building the solutions showed in these schemes may imply specific components. A infinite number of combinations are possible.

Each case is illustrated with a section on the left and a perspective view on the right.
a) Upper bracing: Panels (or other skin) are attached to parallel LSCs. Additional cross components permit to archive transversal strength and to act as horizontal bracing parts. They may be placed in the upper part of the air duct.
b) Lower bracing: Panels (or other skin) are attached to parallel LSCs. Additional cross components permit to archive transversal strength and to act as horizontal bracing parts. They may be placed in the lower part of the air duct.
c) Bracing and waterproofing: same as above with a waterproofing layer on top of the bracing components. An air duct is created, not blocked by the bracing components placed below.
d) Bracing, waterproofing and insulation: same as above, but here the cross bracing components are placed in the insulation layer. This creates a fully functional roof, insulated, waterproof, ventilated, and fulfilling structural functions. A sheathing sheet may also be placed below or above the bracing components, still adding functions.

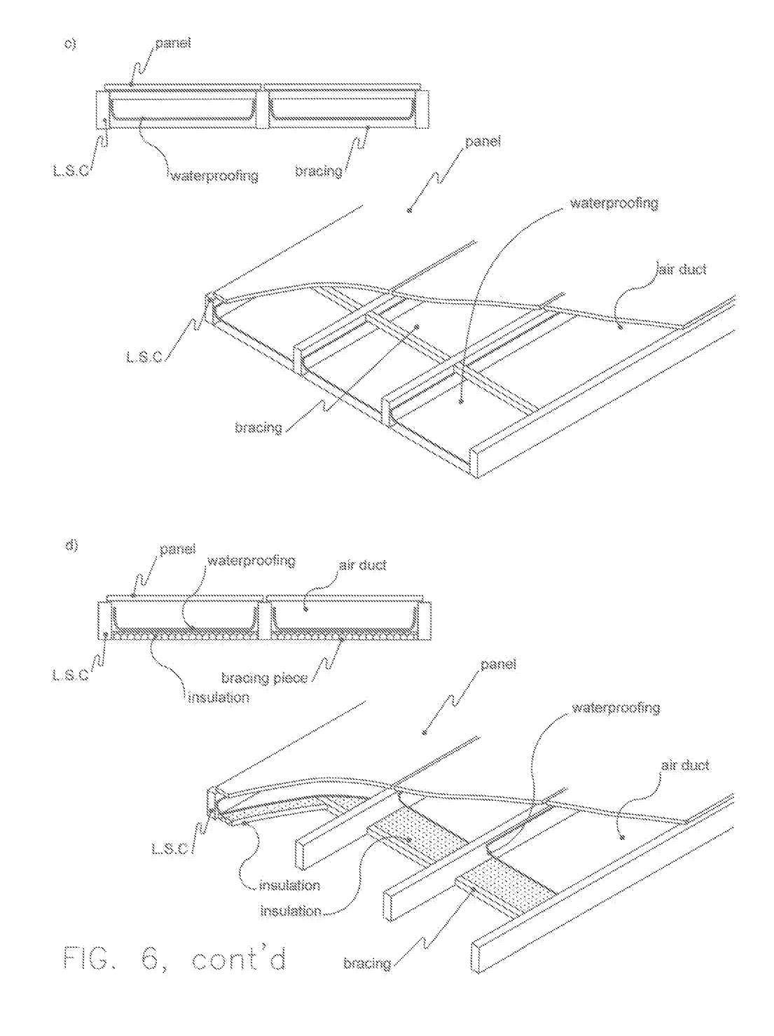

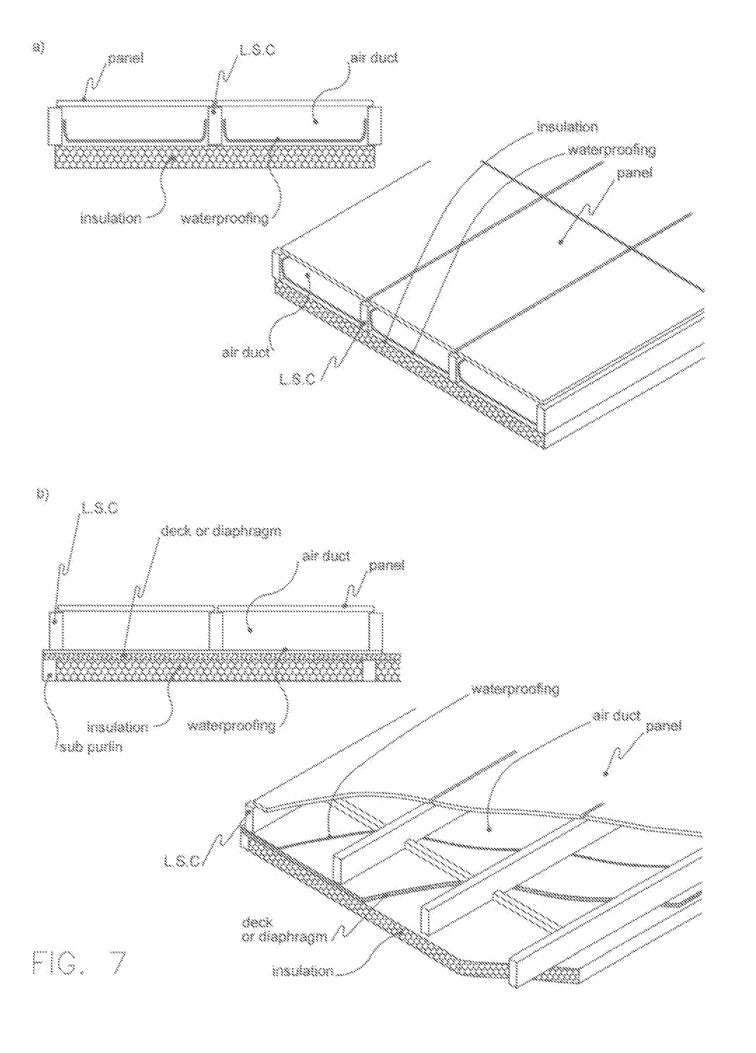

### FIG. 7

This figure shows various examples of application of the invention, forming various kinds of outer skins. Building the solutions showed in these schemes may imply specific components. An infinite number if combinations are possible.

Each case is illustrated with a section on the left and a perspective view on the right.
a) Insulation below: Panels (or other skin) are attached to parallel LSCs. A waterproofing sheet is placed between the LSCs, thus creating an air duct. A layer of insulation is placed below the LSCs and the waterproofing sheet.
b) Diaphragm: the LSCs are placed on top of a classical diaphragm roof made of classical carpentry with purlins and sub purlins, insulation, deck or diaphragm (for example sheathing sheet), waterproofing. In this case, the insulation runs below the LSCs and it forms the 4th side of the air duct (the 4 sides are: top skin, left LSC, right LSC, waterproofing).
c) Corrugated metal: a corrugated metal sheet is attached to the LSCs through connectors and it supports insulation and waterproofing layers placed below the LSCs. If the waterproofing touches the LSCs, then an air duct may be created. The panels or the outer layer are attached to the LSCs.

### FIG. 7b

This figure has 2 drawings (a perspective view and a schematic section) showing a case of application of the invention, with a LSC made of several components in order to achieve a greater height of the complex as well as thermal break.

A panel (solar or not) is attached on the top of a bi-component LSC. Below is a waterproofing sheet, which lies on a thick insulation layer and goes up on the sidewall of the LSC in order to create a raised edge. The insulation layer lies on a sheathing sheet; itself supported each side by the LSC.

In this example, the LSC is made up of 2 components in the same axis: a lower one and an upper one. The upper one is specially designed to hold the panels and the protect the waterproofing sheet with a drip. An air duct automatically exists since there is a waterproofing sheet between the LSCs. The lower component of the LSC is designed to attach the LSC to the supporting beams and to support the sheathing sheet and/or the insulation or waterproofing layers. The 2 components may be attached together in various positions. This way, the resulting LSC may have various heights, and the outer skin complex may have the desired height. A thermal break system may be placed between the 2 components, thus increasing the thermal performance and avoiding condensation problems. The gap between the LSCs may be adjusted depending on the panels' size.

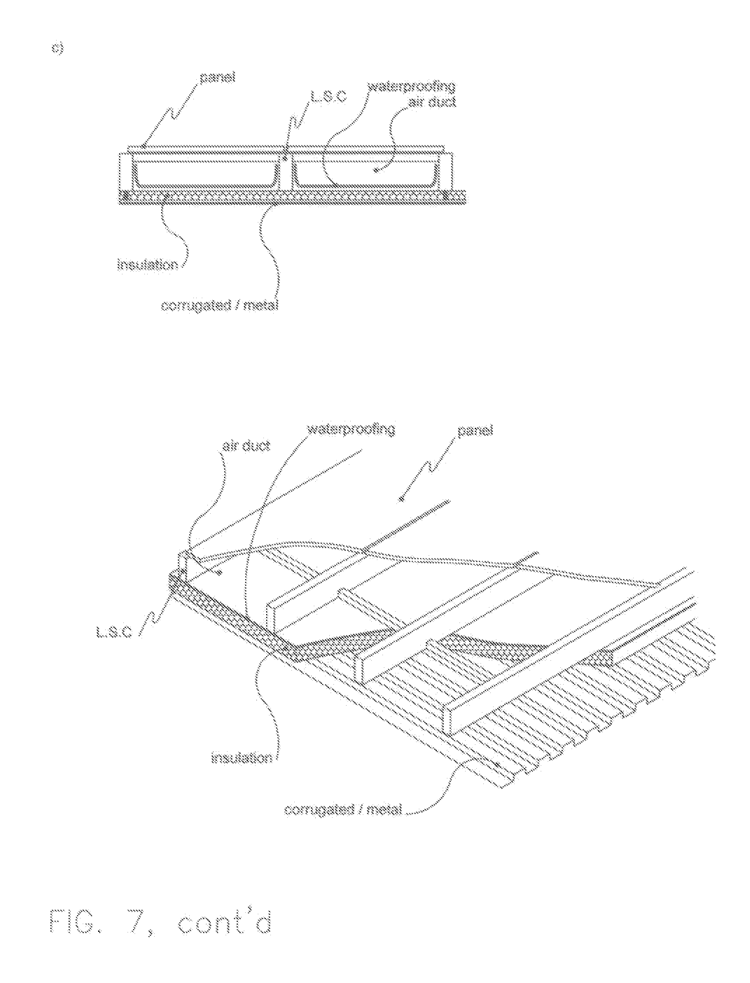

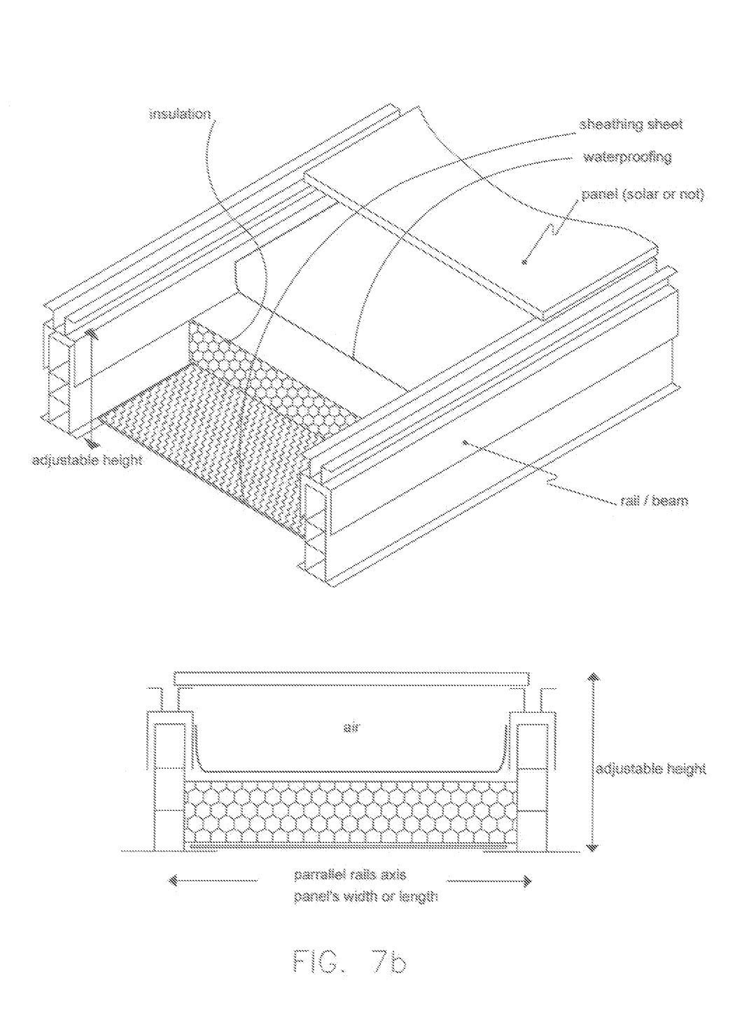

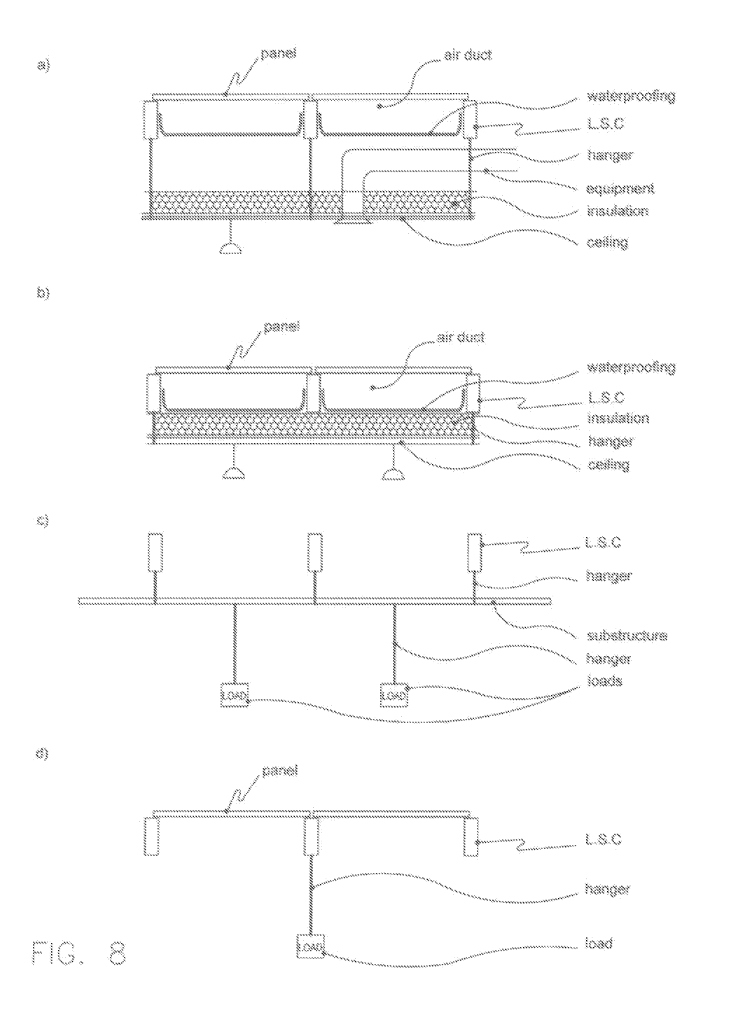

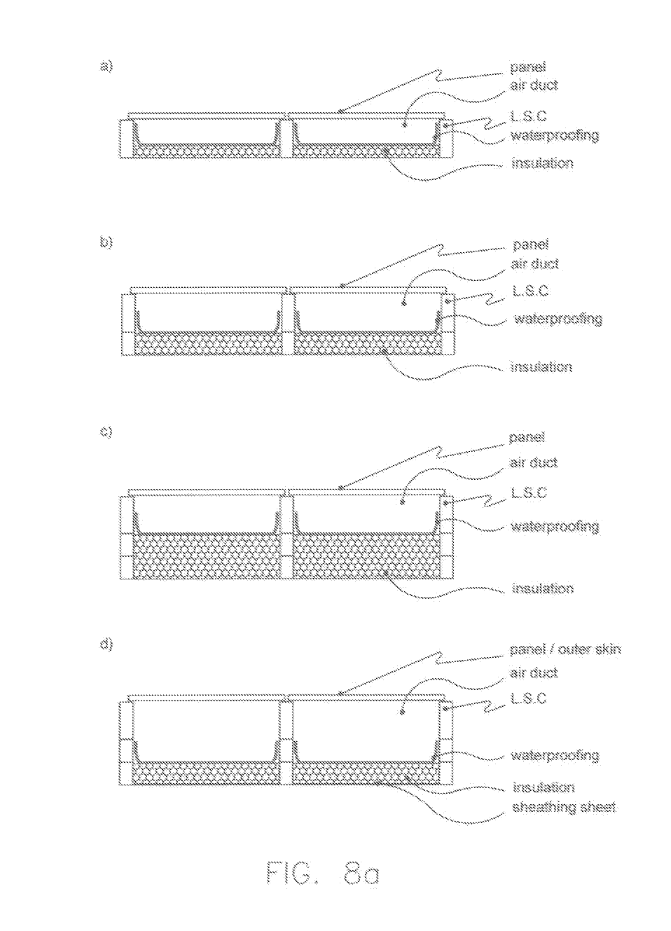

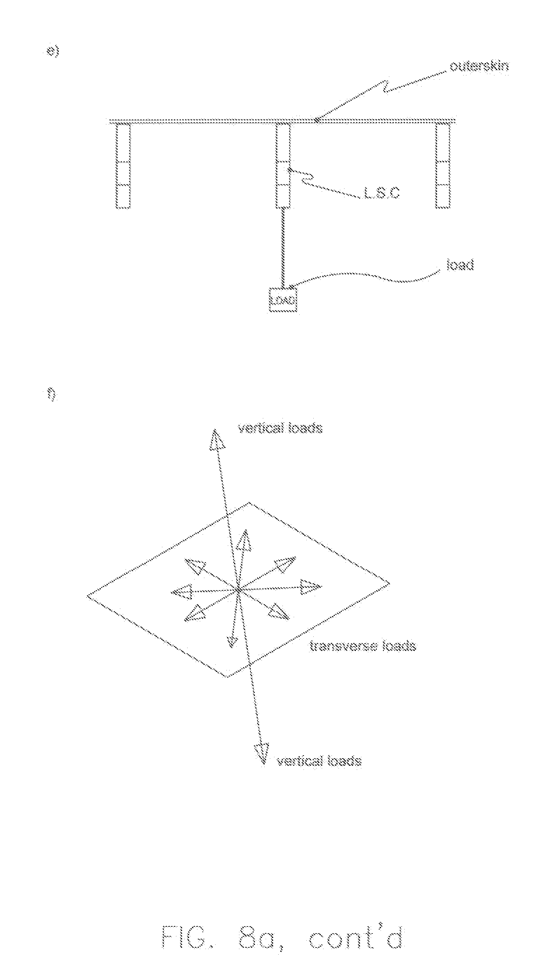

### FIG. 8

This figure shows various examples of application of the invention, forming various kinds of outer skins. Building the solutions showed in these schemes may imply specific components. An infinite number if combinations are possible.

Each case is illustrated with a section
a) Distant suspended insulation: Panels (or other skin) are attached to parallel LSCs. A waterproofing sheet is placed between the LSCs, thus creating an air duct. A ceiling is hanging to the LSCs. It may support a layer of insulation and various equipment such as air conditioning, lighting, other loads, etc. . . . .
b) Close suspended Insulation: Panels (or other skin) are attached to parallel LSCs. A waterproofing sheet is placed between the LSCs, thus creating an air duct. A layer of insulation is placed below the LSCs, either attached to them or laying on the ceiling below. A ceiling is hanging to the LSCs. It may support various equipment such as air conditioning, lighting, other loads, etc. . . . .
c) Suspended loads via substructure: a substructure is fixed to LSCs. It enables to support various loads.
d) Directly suspended loads: panels are attached to parallel LSCs. Loads are directly suspended to the LSCs.

### FIG. 8A

This figure shows various examples of application of the invention, forming various kinds of outer skins. Building the solutions showed in these schemes may imply specific components. An infinite number if combinations are possible.

Each case is illustrated with a section
a) Simple roof: Panels are attached on the LSCs. A layer of insulation is attached to the LSCs. A layer of waterproofing is placed on top of the insulation and goes up on both sides, thus creating an air duct.
b) Extended LSC: same as above but a higher or a multi-component LSC is used to provide more thickness to the outer skin. This additional height is used to increase the thickness of the insulation layer.
c) Super extended LSC: same as above but the height of the LSC has been extended possibly by using a 3-component system. A very thick insulation layer can be installed.
d) Super thick air duct: same as above but the additional thickness provided by the extended LSC is used to increase the thickness of the air duct. This example uses a sheathing sheet to provide additional or rigidity.
e) Load bearing: in this example an outer skin is attached to the LSCs and loads are suspended to the LSC.
f) This diagram shows that vertical and transversal loads can be taken by the system.

### FIG. 8b

This figure shows 3 examples about structural settings.
a) A case of construction in which the panels are supported by LSCs. Both ends of the LSC lie on a supporting beam. For example, in this case, the LSCs span from wall to wall.
b) Same as above, but LSCs span in cantilever beyond the beams.
c) In this example of construction, several LSCs are connected end to end using optional connectors. In this particular example the end of each LSC rests on a beam of the building.

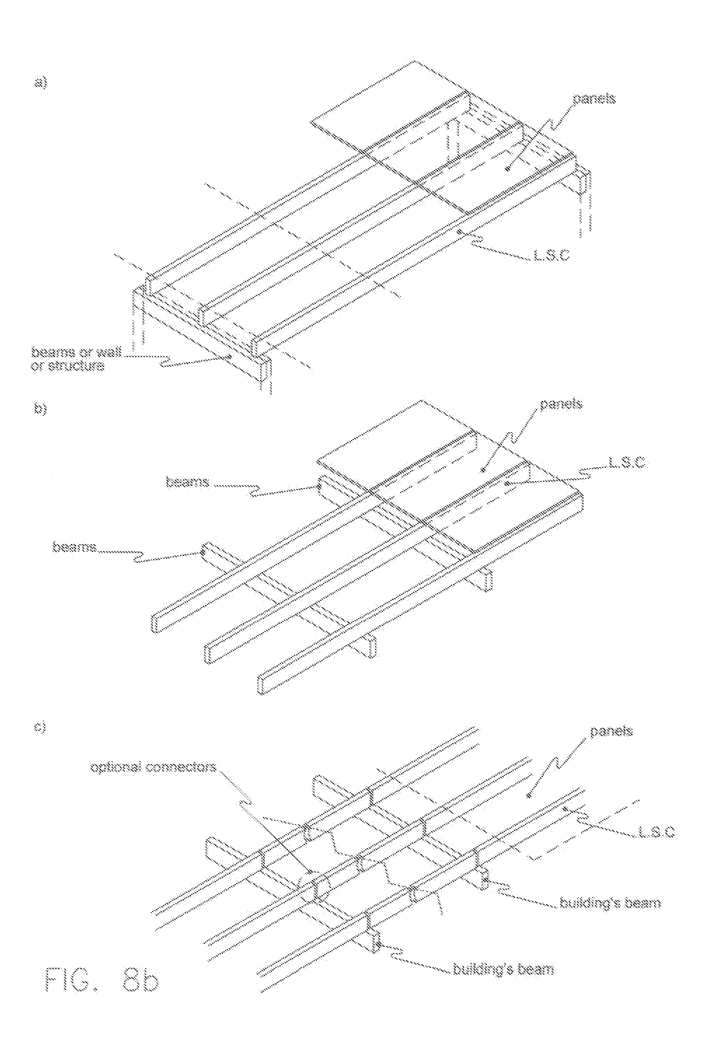

### FIG. 9

The figure shows 3 examples of installation.
a) The system makes up the whole roof of the building and provides structural rigidity in several directions.
b) Example of ground mounted system in which the array rests on a beam at the lower end of the LSCs and on an elevated beam at the upper end of the LSCs. Instead of being on the ground, this example could be built on a slab or on the roof of a building.
c) Example of cantilever mounting, taking advantage of the structural capacity of the LSC. In this particular case, the whole system would be supported by a lower beam and a half way support.

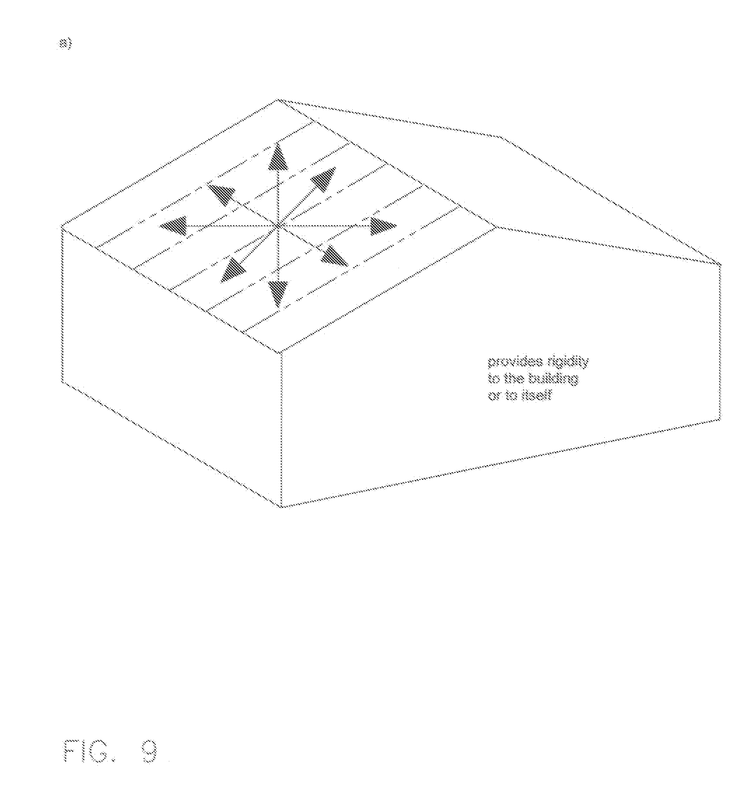

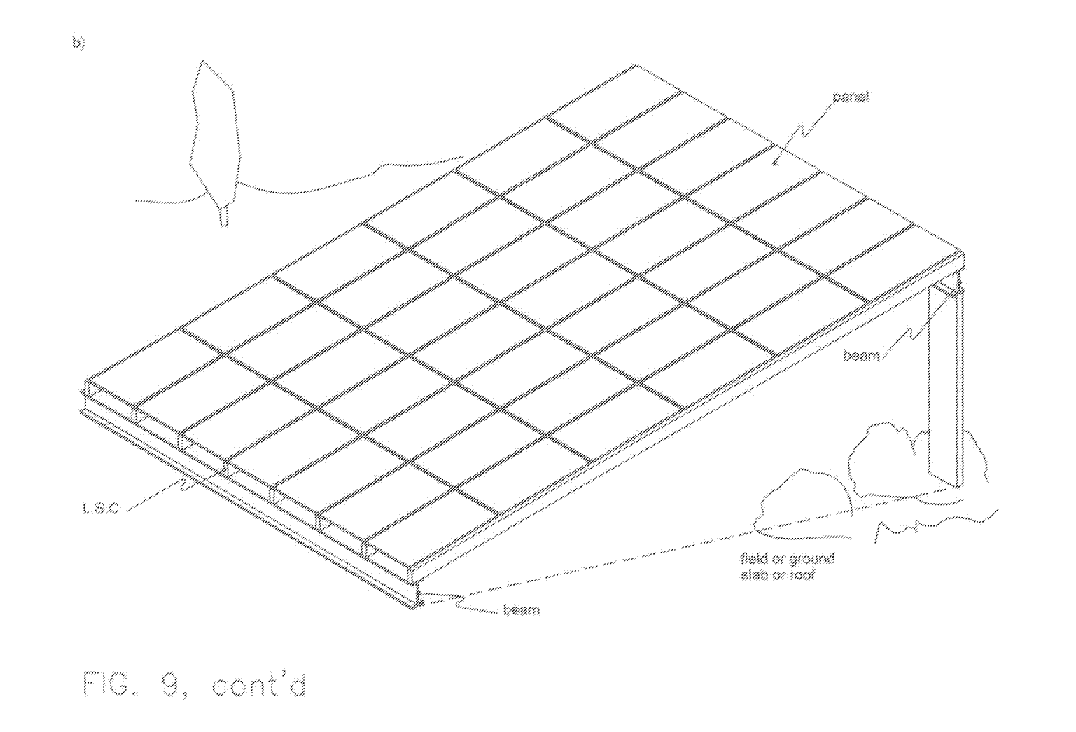

### FIG. 10

FIG. 10 shows 3 examples using the structural capacity of the invention, both illustrated with a perspective view on the left and a side view on the right.
a) Example in which the system rests on 2 beams. The lower beam is classically supported from below and the upper beam is suspended.
b) Example of a construction process using a crane to lift a chunk of a roof. In this case the roof is made of panels and LSCs, and it comes with its supporting beams, which may help provide the rigidity necessary for transportation.
c) Another example of usage of the structural capacity of the LSC: the LSC is used as a beam that supports suspended loads and does not even carry panels.

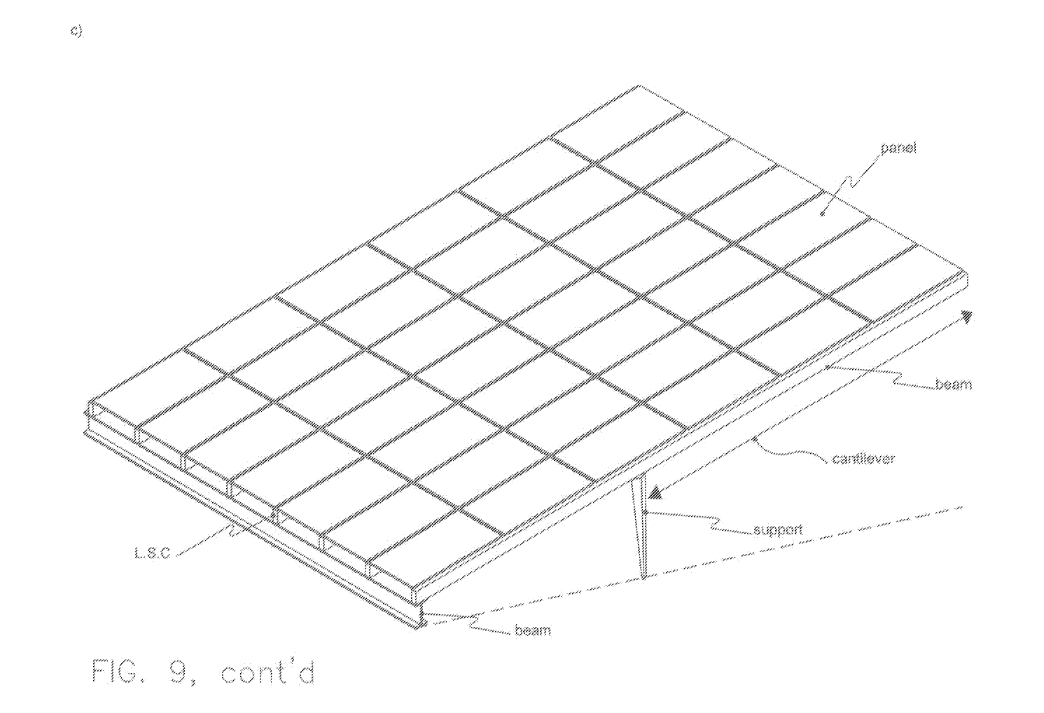

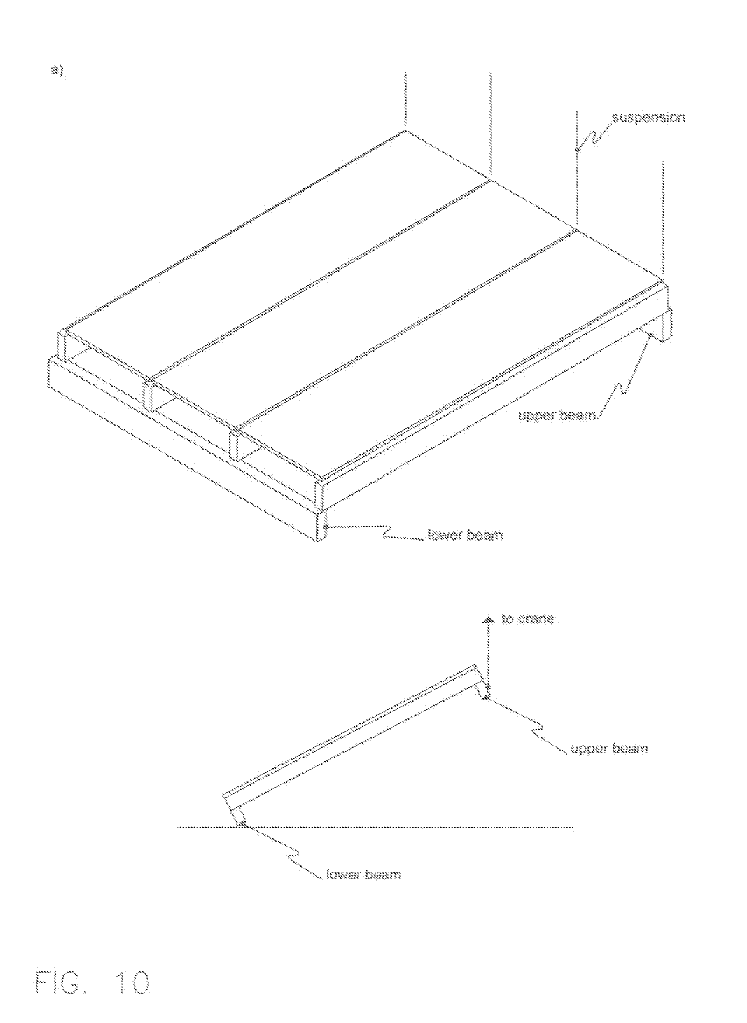

### FIG. 11

This figure recapitulates the main options and adjustments allowed by the system. These configurable points are detailed in the next figures.

The top view shows a schematic section of a basic unit (one panel wide). From the top:
the outer and its many possible details and variations will be described in specific drawings, including the clamps and finishing parts.
The LSCs, their details and variations, as well as the optional gutters, rails and accessories will described in specific pages.
The inner layers, the many ways they may be built and their optional features, such as waterprrofing, sheathing, insulation, etc. . . . ) are described in specific pages.

The lower view sums up the main adjustable aspects of the LSC:
The top and fixation feature are described in specific pages
The rails, gutters and accessories' details and variations are described in specific pages
The LSC it self is described in specific pages with some of its details and variations
The foot and attachment's details and variations are described in specific pages.

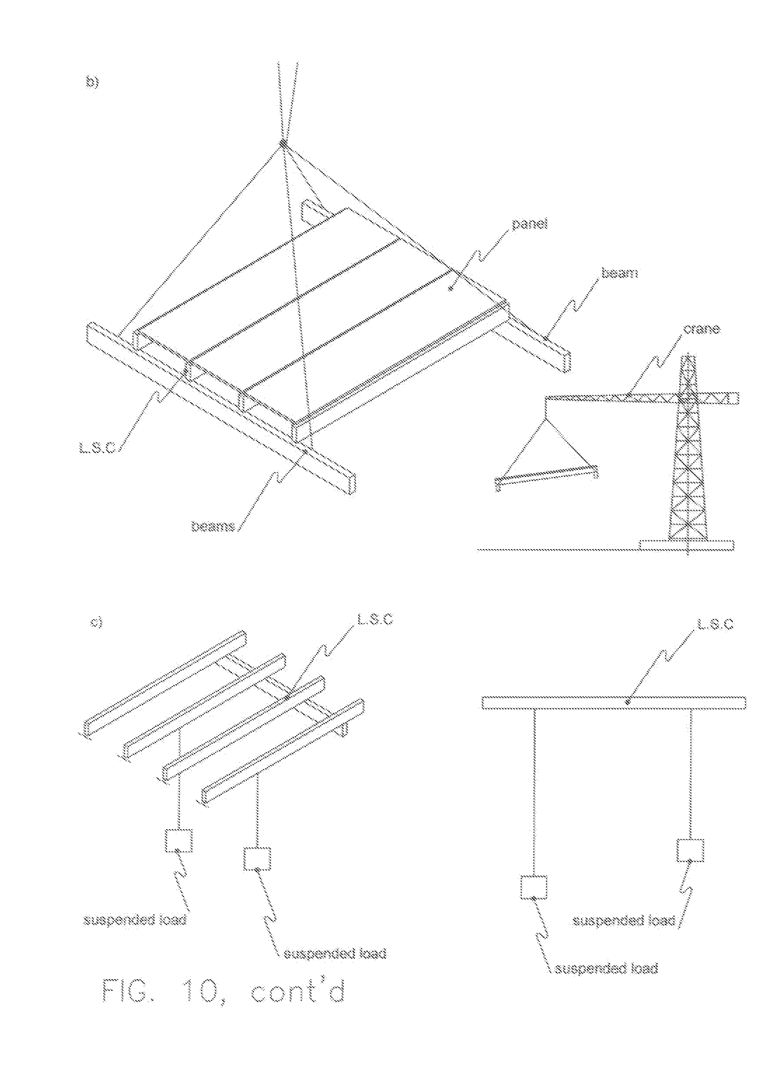

### FIG. 12: Examples of Outer Skin Variations

This figure is about the outer layer and the ventilation.
The top part of the figure shows a large perspective view and several small schematic sections.
The perspective view shows a typical application of the invention, in which LSCs support an outer layer. Several examples are showed here:
The outer layer may be made of any kind of skin or panels. For example: solar photovoltaic panels, solar water heating panels, glazing, luminous panels, gratings, decorative panels, etc, as well as other materials such as textile, etc.
The air ducts may be open or closed or protected by grilles, grates, finishing parts or else
Gutters may be part of the system
Of course, many other configurations are possible.

The schematic sections give more examples:
a) Classical application with solar panels as an outer layer, air duct, waterproofing and insulation,
b) Same as above except that the solar panel is a solar water heater, and that the lower components are optional (waterproofing and insulation)
c) The outer layer is made of solar panels, or glass or something else. Heat collectors may be placed inside the air duct. The air duct is closed in the bottom.
d) The system carries an outer layer made of decorative panels, and, in this example, nothing is placed in the lower part of the LSCs
e) The whole outer skin is transparent: the outer layer and the inner layer are made of glass.

The lower part is about ventilation.

The air flow may enter the air duct in many ways, among which are schematized here:

1) Linear air flow, air intake between the LSCs

2) Air intake between the LSCs and on the top of the air duct

3) Air intake between the LSCs and below the air duct

4) Air intake only from the bottom

Of course, many other configurations are possible

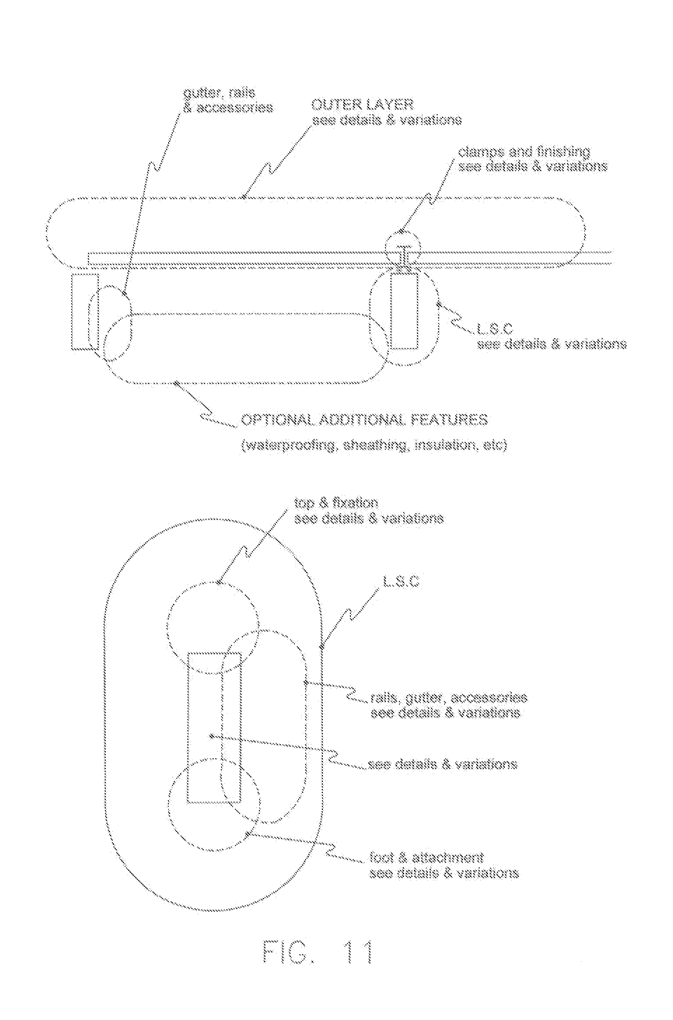

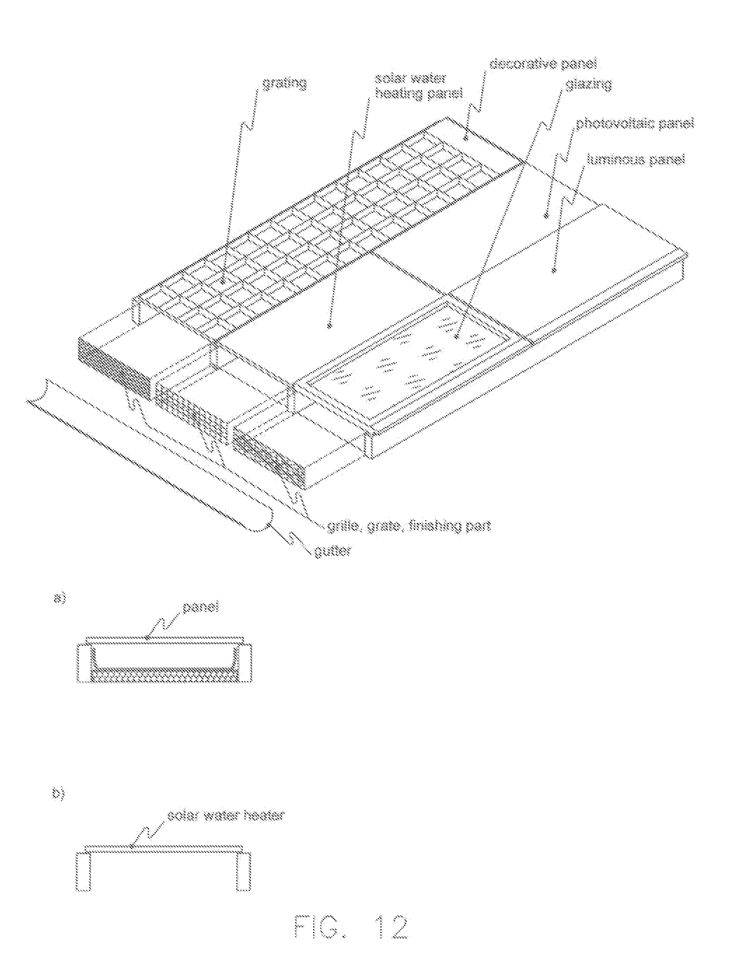

### FIG. 13: Examples of Configurations on a FaçAde

This figure shows a perspective view with an example of a vertical façade.

Vertical LSCs create vertical air ducts with lower air intakes using grilles or grates. The outer layer that is attached to the LSCs is made of various kinds of panels: solar water heater, glazing, finishing panel, door, photovoltaic panel, luminous panel, grille, glass, etc. . . . . It might also be materials that are not panels.

On the right side, the invention is used to turn a part of the façade into a vertical greenhouse using glass outer panels and a volume behind it. The air duct may be classically between the LSCs or extended to the whole depth of the volume, or both with 2 different air ducts. In this example, a horizontal grate provides some mid-level flooring.

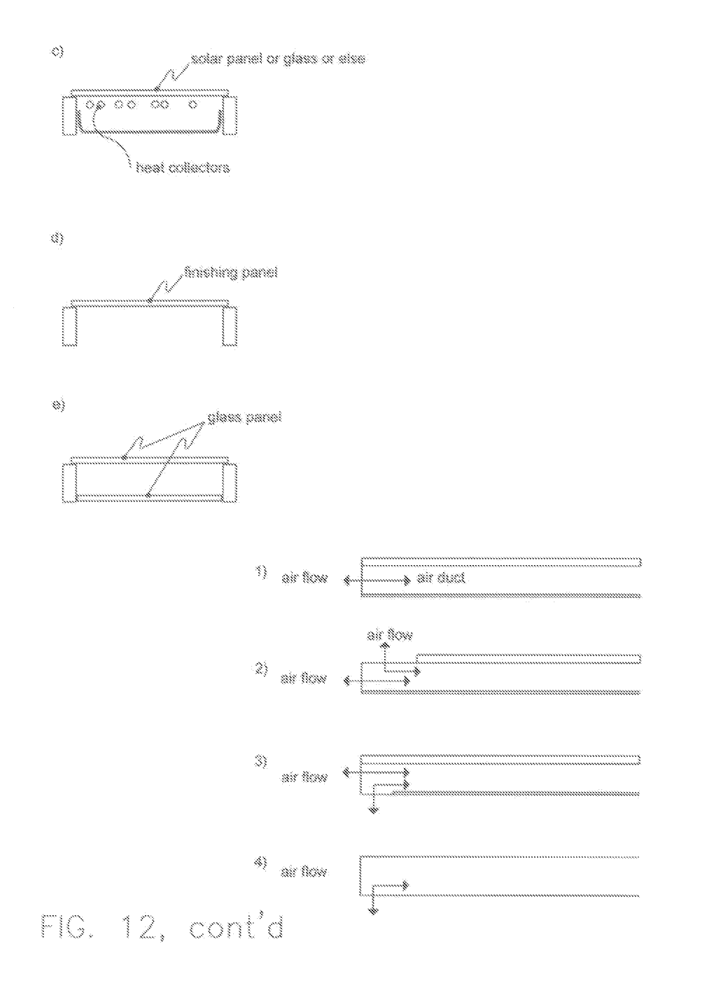

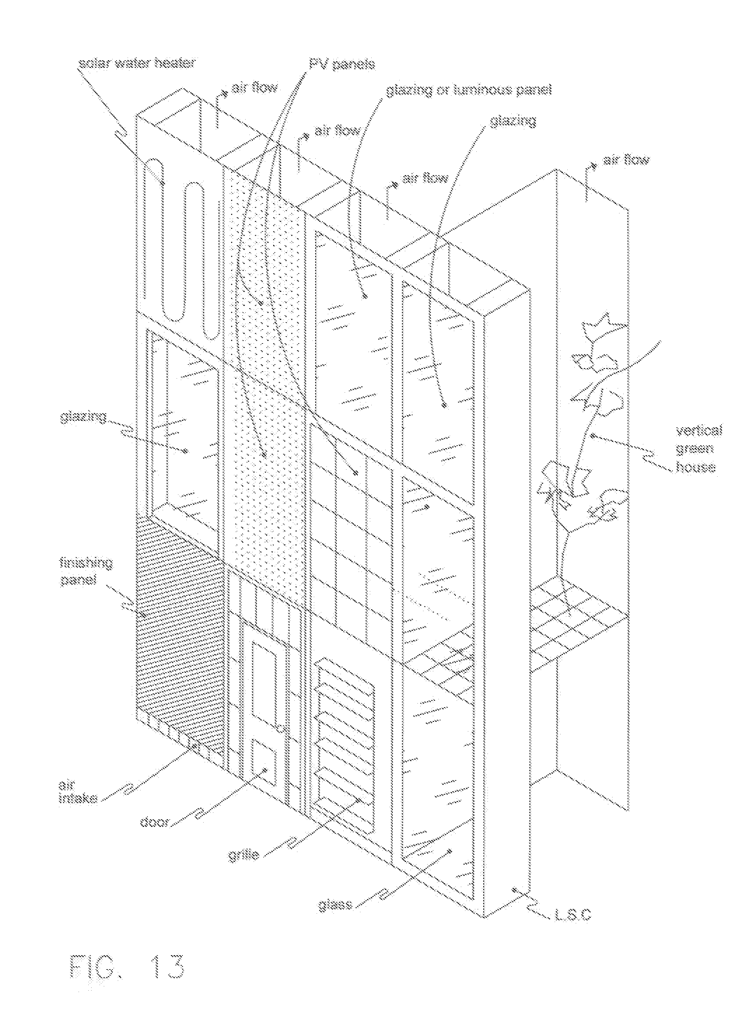

### FIG. 14: LSC, Examples of Embodiment

The figure shows a perspective view of an example of LSC.

In this case of application of the invention, the LSC is made of a lower rail, a central portion and upper wings. It bears an optional double gutter component, including a gutter for water on the top and a cable tray below it (wires or pipes or other systems may circulate here). The gutter is attached to the central portion or the wing.

The lower rail provides support to a bolt that attaches the LSC to a supporting cross beam, which may be any structural component of the supporting structure.

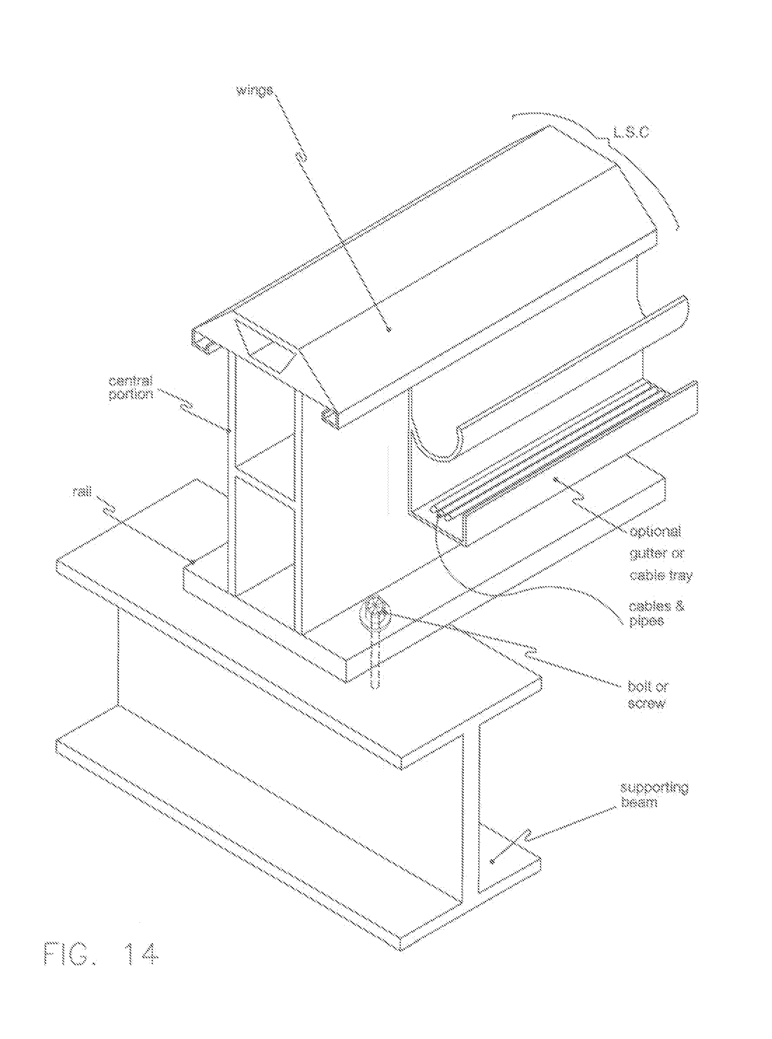

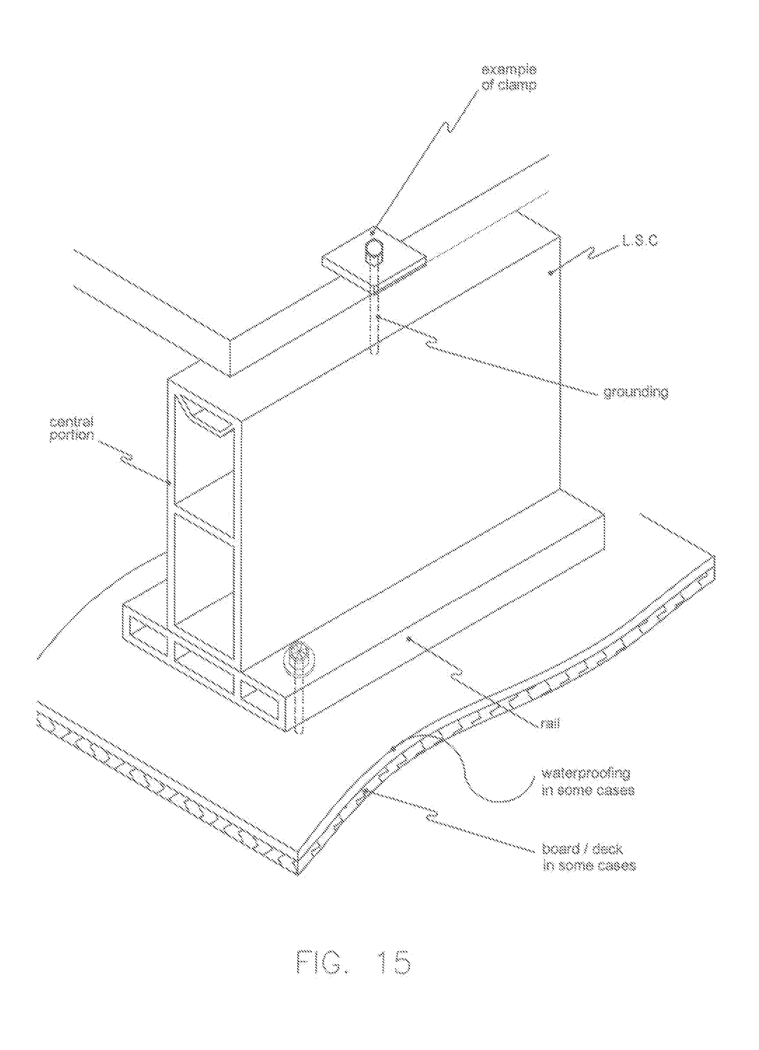

### FIG. 15: LSC, Examples of Embodiment

The figure shows a perspective view of an example of LSC.

In this case of application of the invention, the LSC is made of a lower rail, and a central portion. In some cases, it may be mounted on a deck or a board, which may bear a waterproofing layer. The LSC supports panels, for example attached by a clamp, which may also provide electrical grounding through the LSC.

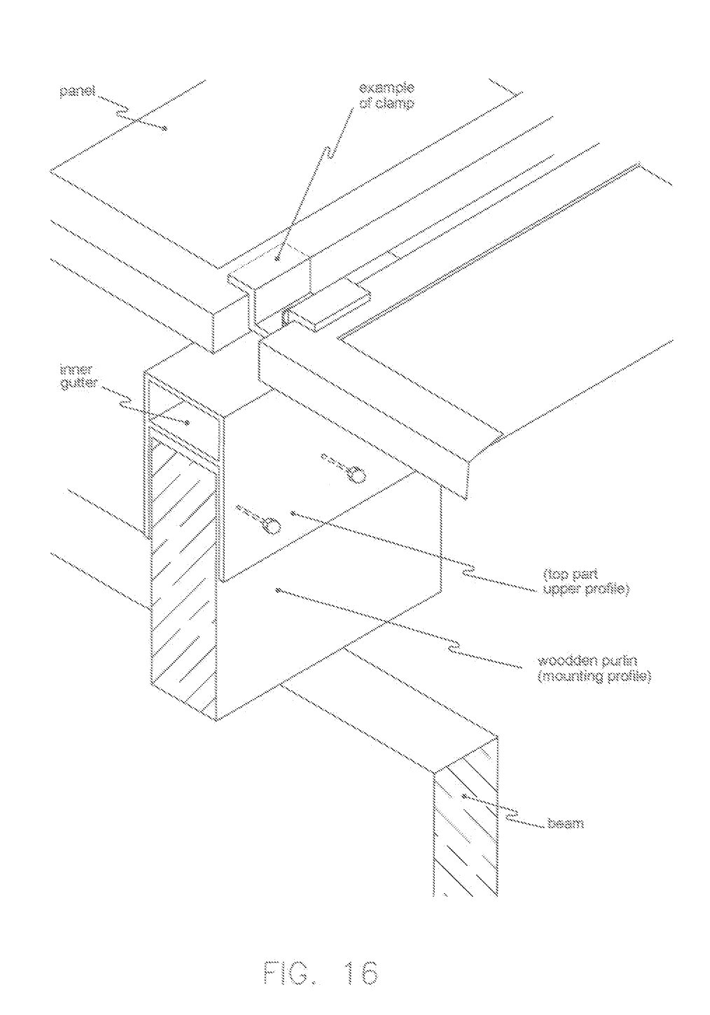

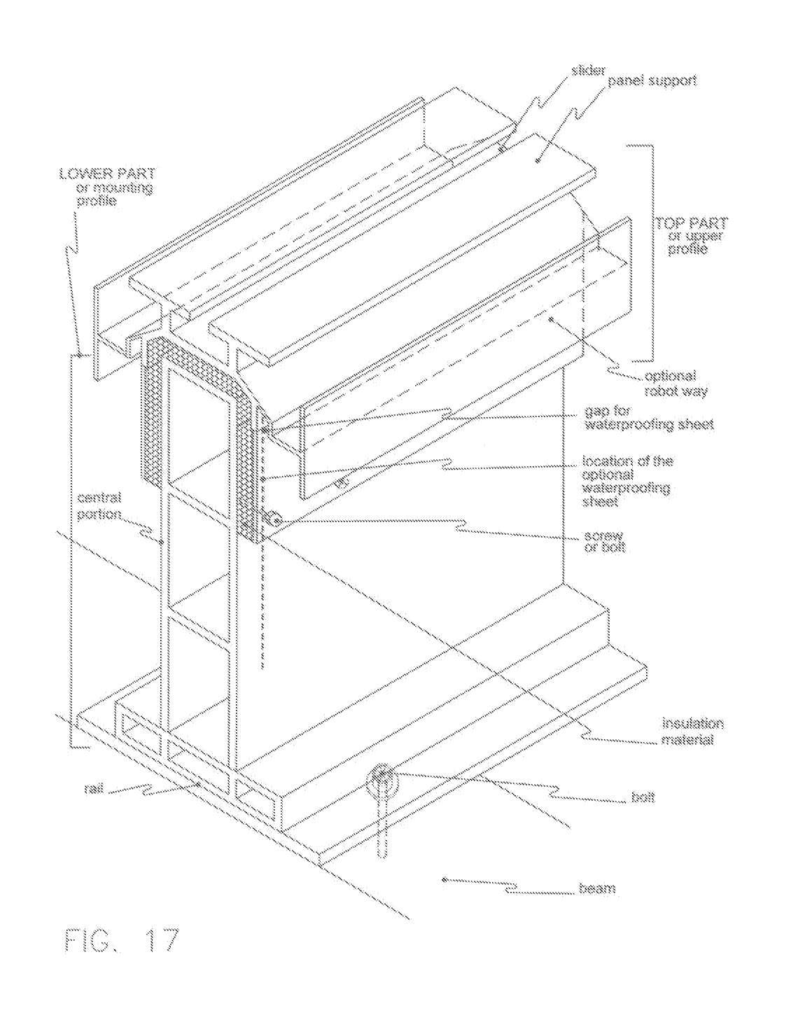

### FIG. 16: LSC, Examples of Embodiment

The figure shows a perspective view of an example of LSC.

In this case of application of the invention, the LSC is made of a wooden purlin completed with an aluminium cap with allows for attaching the panels, for example through clamps. The top part may include an inner gutter to drive water away (water may penetrate through the clamp fixation holes). The aluminum cap is attached to the wooden beam using classical fixation solutions. The LSC is attached to a beam or any structural component of the supporting structure.

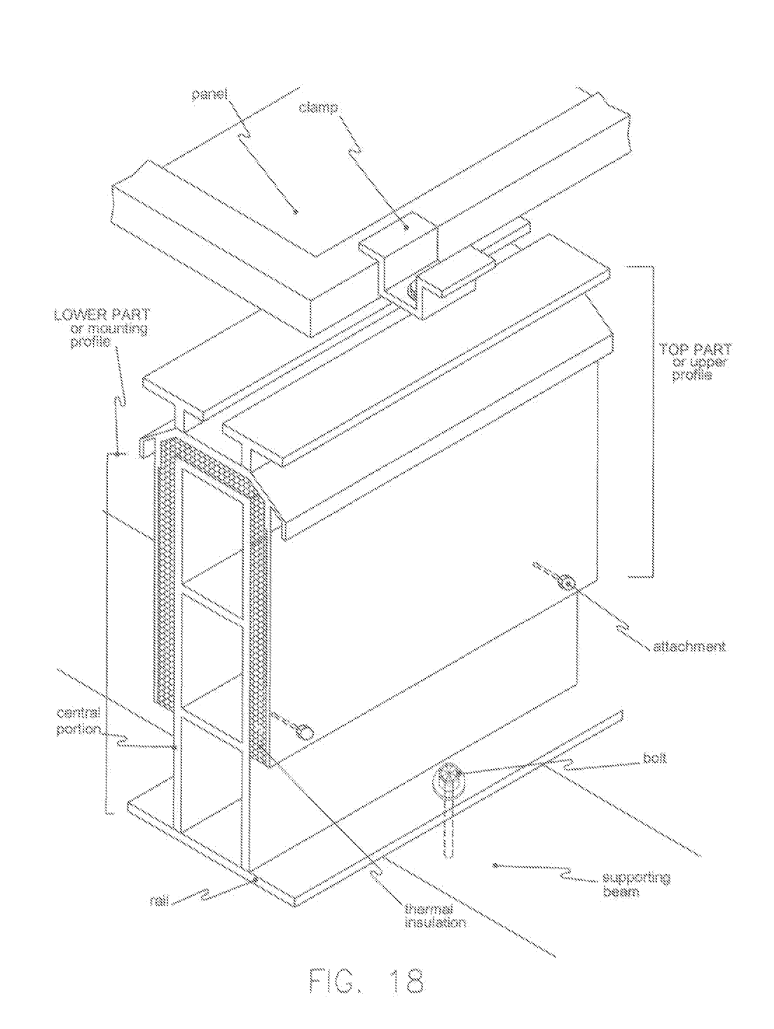

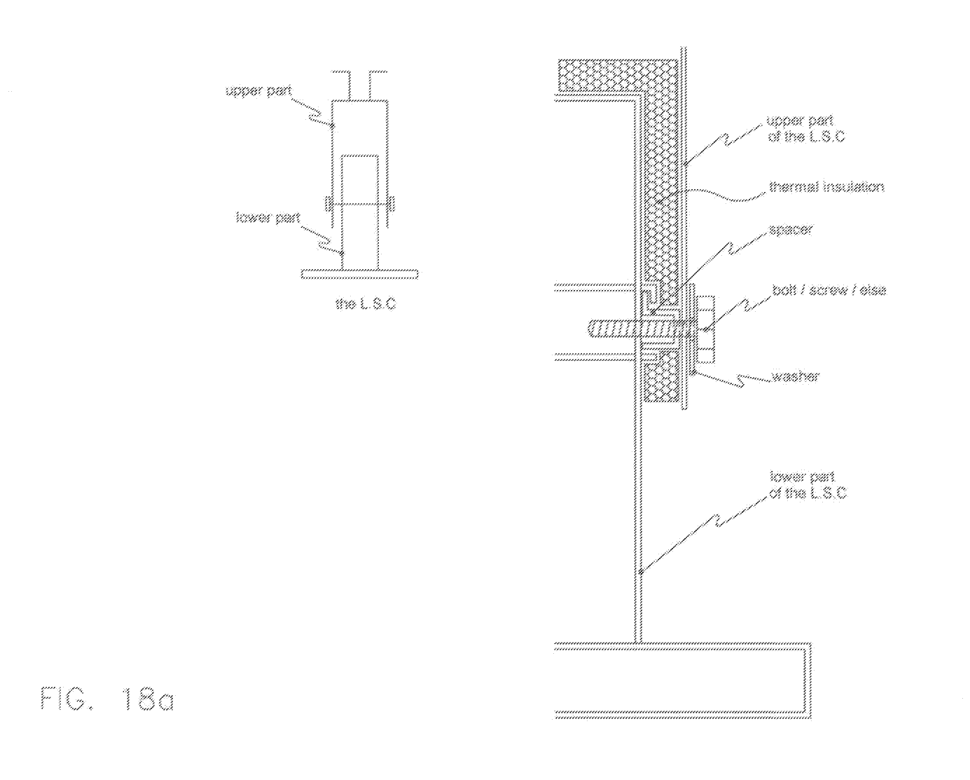

### FIG. 17: LSC, Examples of Embodiment

The figure shows a perspective view of an example of LSC.

In this case of application of the invention, the LSC is made of a lower part and a top part.

The lower part is composed of a lower rail and a central portion. The lower rail forms 2 levels to provide support to the bolt that may attach the LSC to a supporting beam, and to various optional features such as sheathing sheet, insulation, waterproofing, or else. The central portion may be formed as a tube in order to provide strength, as well as room for lateral fixations. It may be calculated and designed according to its specific functions or to the loads it has to deal with, including with thicker walls or strengtheners.

The top part is connected to the lower part using screws, bolts, rivets or any relevant means, optionally using spacers. The top part wraps around the lower part on 3 sides. It includes an optional robot way and a gap designed to fit a waterproofing sheet. A thermal break may be created between the two components using an insulation material placed between them. In this case, the top part includes 2 special horizontal pads on which the panel may be either directly attached or placed and attached using clamps. The clamps may take advantage of the slider provided. Whatever the mode of fixation of the panels, there is no drilling the aluminium cap, and so no water leakage behind the optional waterproofing sheet.

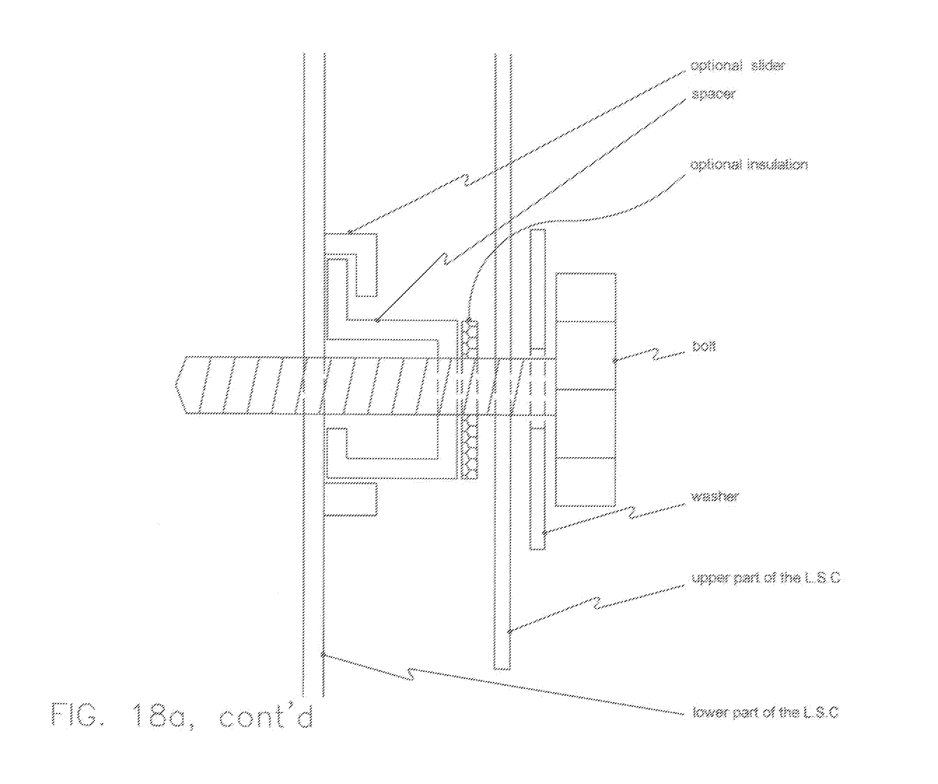

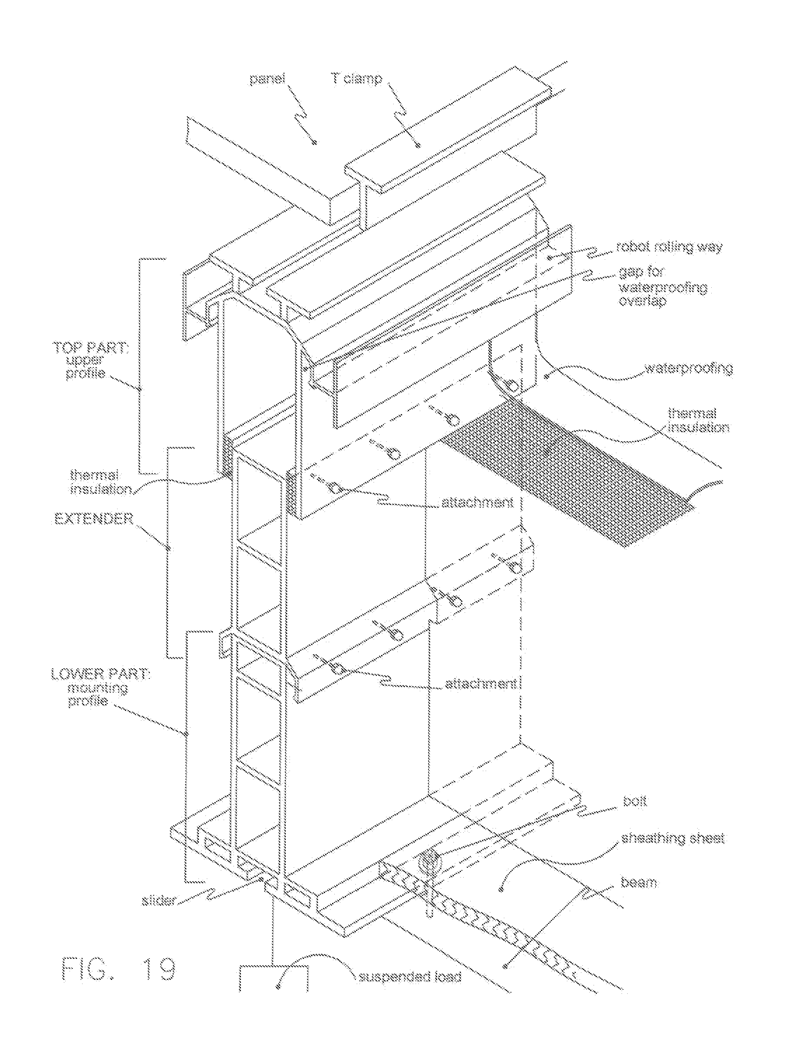

### FIG. 18: LSC, Examples of Embodiment

The figure shows a perspective view of an example of LSC.

In this case of application of the invention, the LSC is made of a lower part and a top part.

The lower part is composed of a lower rail and a central portion. The lower rail provides support to the bolt that may attach the LSC to a supporting beam. The lower rail may also provide support for various optional features such as sheathing sheet, insulation, waterproofing, loads, or else. The central portion may be formed as a tube in order to provide strength, as well as room for lateral fixations. It may be calculated and designed according to its specific functions or to the loads it has to deal with, including with thicker walls or strengtheners.

The top part is fixed to the lower part using screws, bolts, rivets or any relevant means, optionally using spacers. The top part wraps around the lower part on 3 sides. It includes a gap designed to fit a waterproofing sheet. A thermal break may be created between the two components using an insulation material placed between them. In this case, the top part includes 2 special horizontal wings on which the panel may be either directly attached or placed to be attached using clamps. The clamps may take advantage of the slider provided. Whatever the mode of fixation of the panels, there is no drilling the aluminium cap, and so no water leakage behind the optional waterproofing sheet. In this case, the top part is designed in such a way that it provides sufficient lateral walls to allow for either covering most of the lower part or for being raised enough to increase the LSC's height whilst still being attached to the lower part.

FIG. 18a: Multi Component LSC Connection System for Thermal Break

This figure, with 2 section views, describes an example of solution for attaching the top part of a LSC to the lower part in respect with the thermal break. The section on the right is an enlargement of a detail of the left one.

The question here is the following: how can the upper part be strongly connected to the lower part (and even achieve structural continuity) without breaking the thermal break?

If the 2 components are directly screwed together through the insulation material, it will either bend the wall and crush the insulation on a large area, thus reducing the thermal break, or create a weak connection without reliable structural capacity. Therefore a spacer is put between the 2 components so that they can be screwed tight. Optionally, a slider may be created on the aluminium wall to help position the spacer. If this spacers are located only under the screws/bolts, the thermal break they may create is very limited, and mostly cancelled by the washer. A thin layer of insulating material can also be put on the outer face of the spacer, still improving the thermal break.

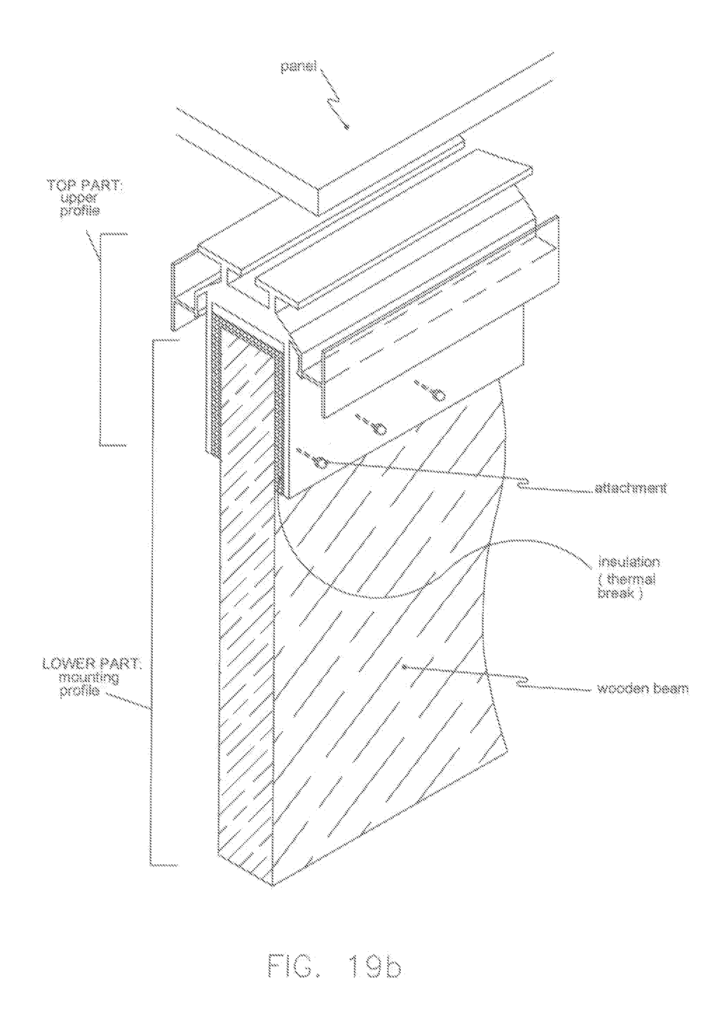

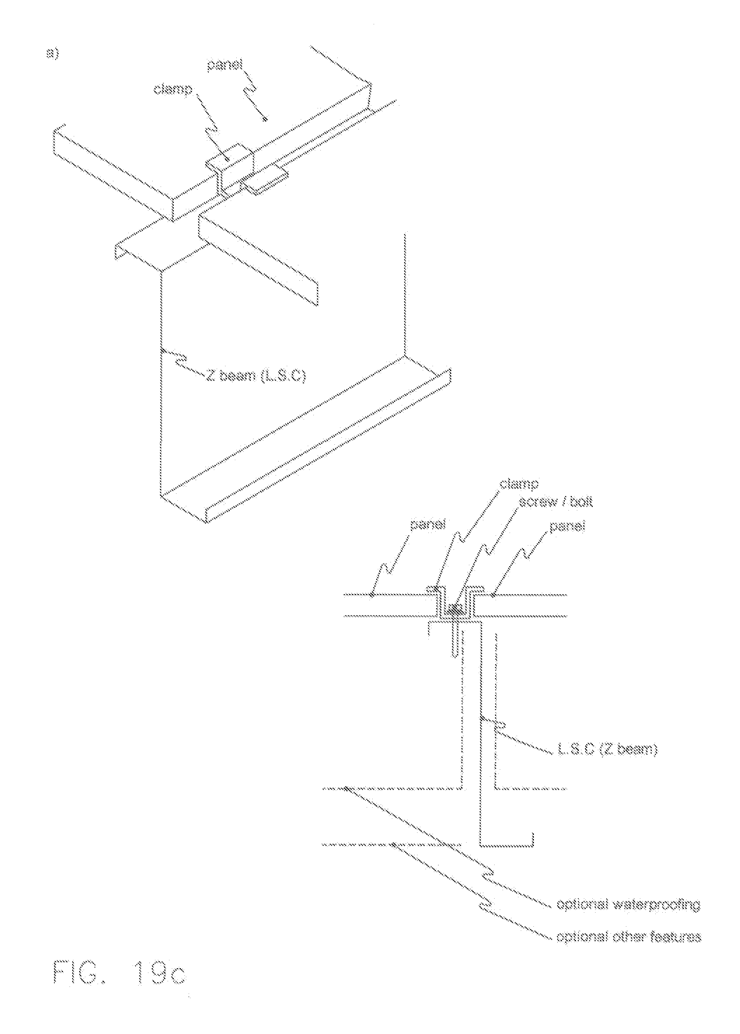

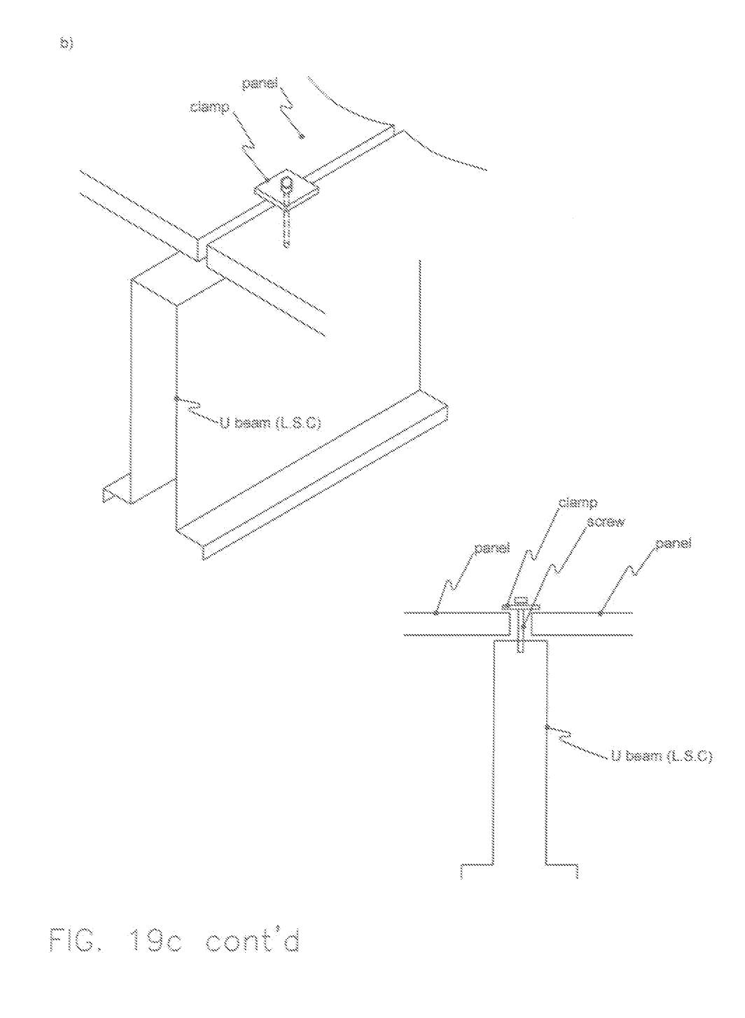

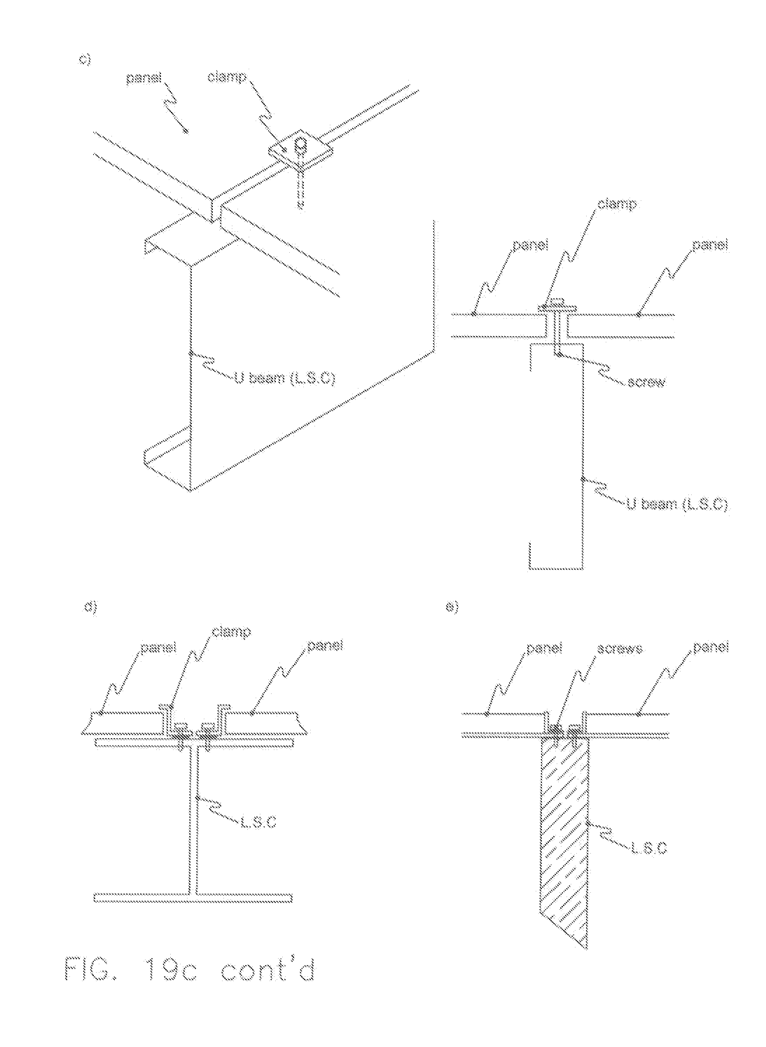

### FIG. 19: LSC, Examples of Embodiment

The figure shows a perspective view of an example of LSC.

In this case of application of the invention, the LSC is made of a lower part, an extender and a top part.

The lower part is composed of a lower rail and a central portion. The lower rail provides support to the bolt that may attach the LSC to a supporting beam. The lower rail may also provide support for various optional features such as sheathing sheet, insulation, waterproofing, loads, or else. The central portion may be formed as a tube in order to provide strength, as well as room for lateral fixations. It may be calculated and designed according to its specific functions or to the loads it has to deal with, including with thicker walls or strengtheners. In this specific case, a slider is created in below and allows for attaching loads or suspended loads.

The extender is designed to increase the LSC's height. This may help use thicker insulation, thicker air duct or other functionalities. In this case of application, the extender is made of a tube and a lower part designed to wrap around the top of the lower part it is attached to. Usually the thermal break is created at the top part level, but it may also be done between the extender and the lower part, using insulation material.

A top part, which may be the similar to one of those described in FIG. 17 or 18, or else, is attached on top of the extender and a thermal break is created. This version of the Top part includes a robot rolling way. The fixation solution using spacers as described on FIG. 18a may be used here too.

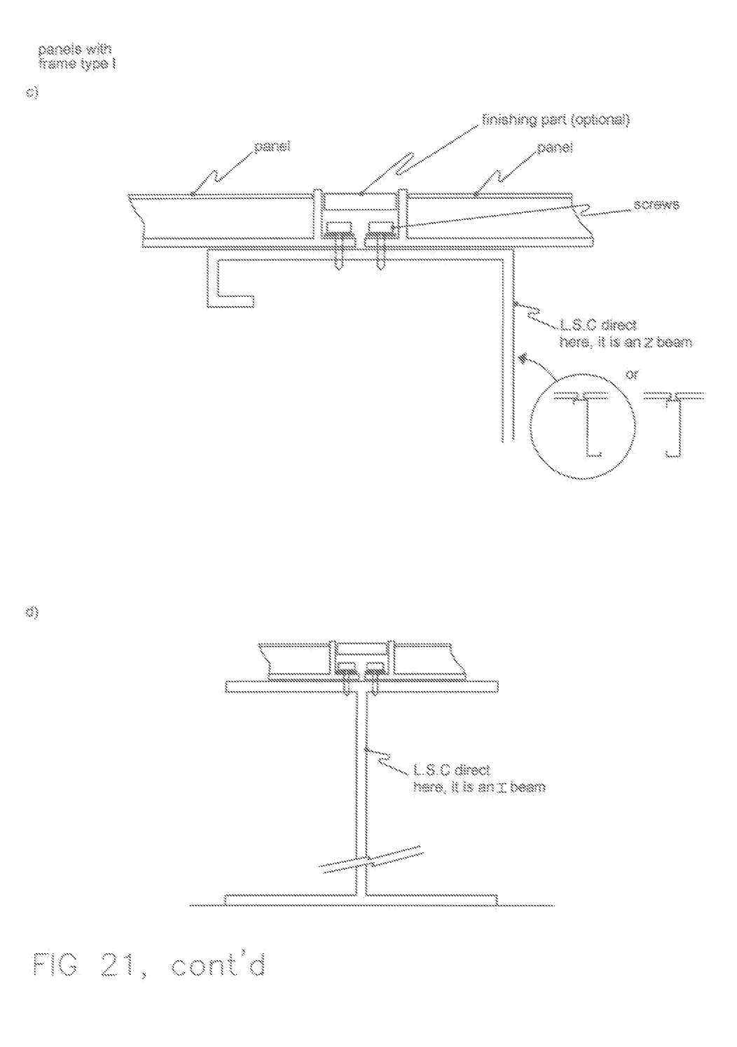

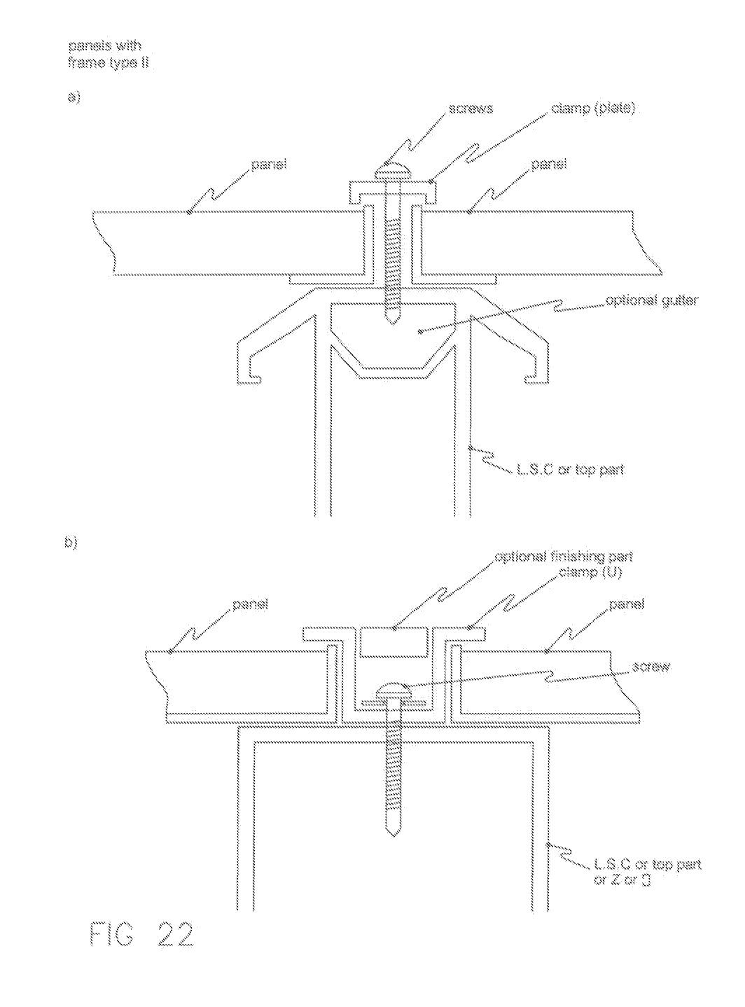

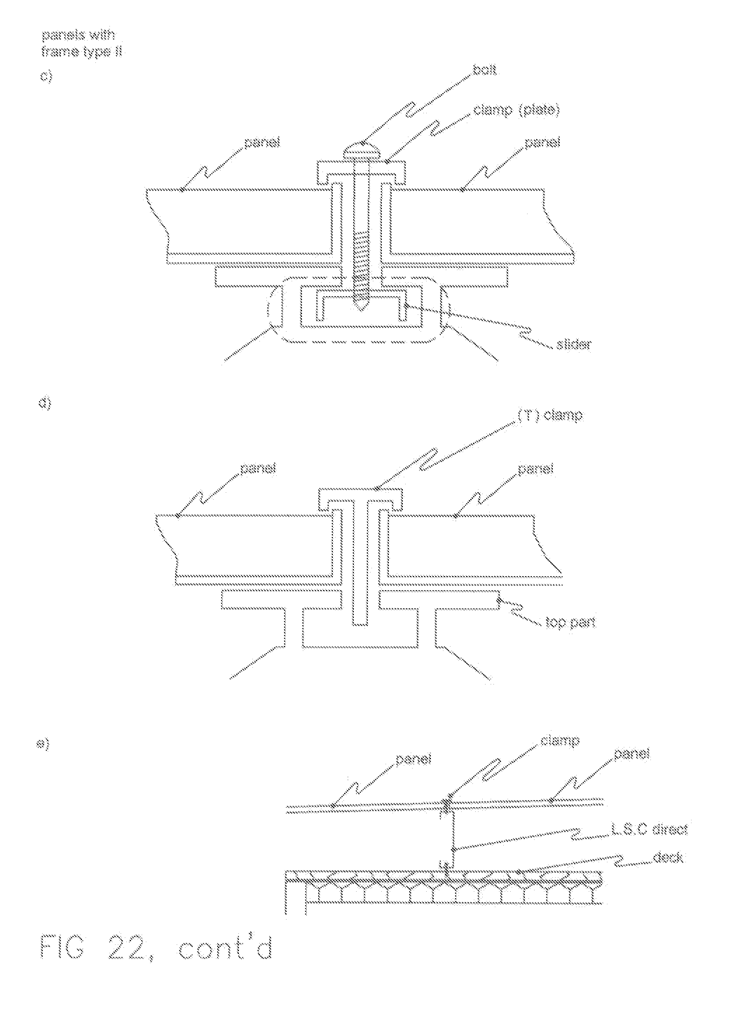

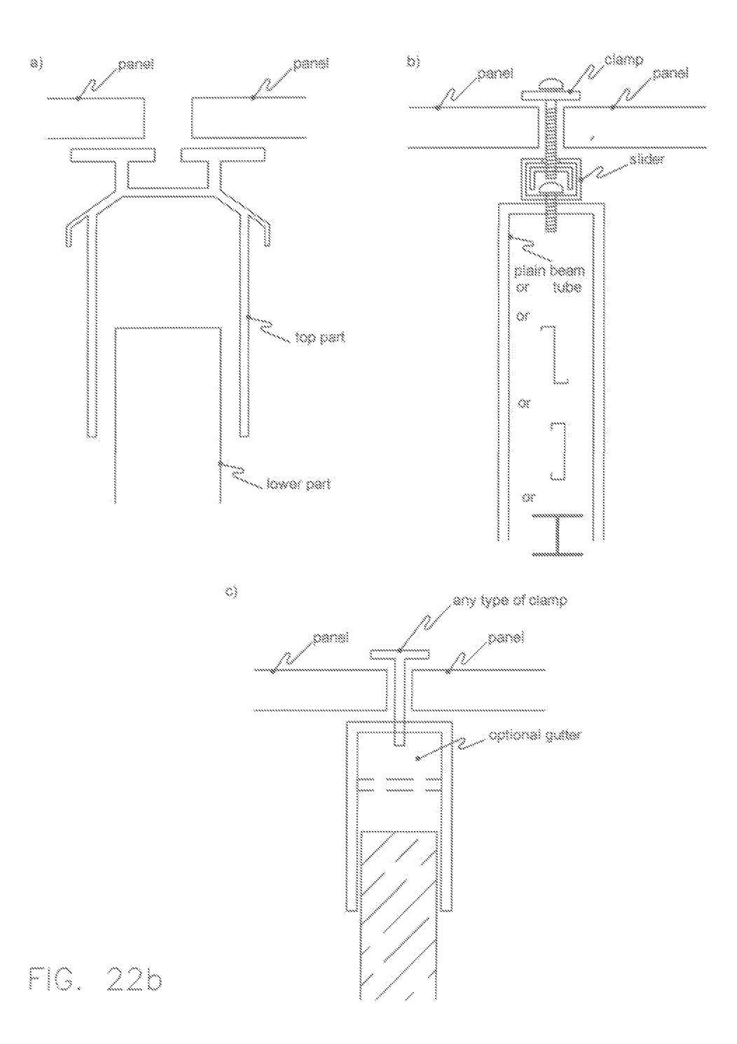

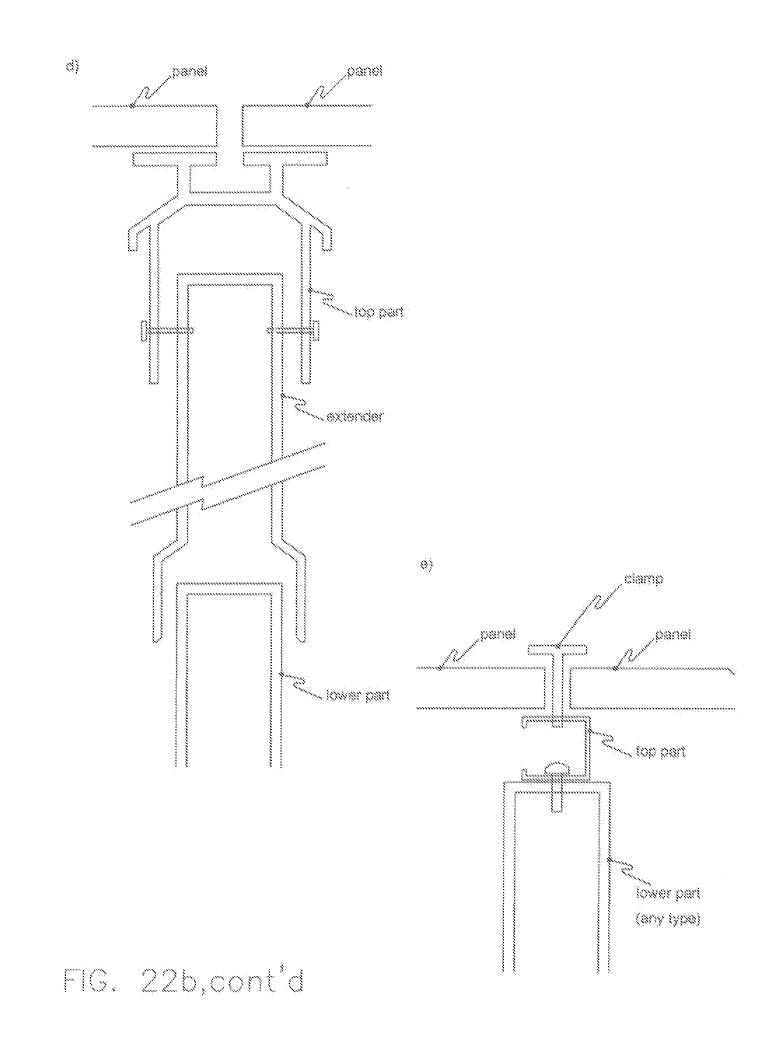

In this example, a panel is fixed to the upper part using T clamps: the T clamps are described in FIG. 22 and others. The LSC is attached to a supporting beam and loads may be suspended below. A sheathing sheet is placed between 2 LSCs, possibly using the 2 level lower rail to combine bolts and sheathing sheet. A thick insulation layer is placed above the sheathing sheet. A waterproofing sheet lays on it and goes up on the LSC's walls and slides into the specially designed gap: this way, any drop of water that might come from above cannot flow behind the waterproofing sheet (the LSC's skirt covers it like a drip), it has to flow on the upper face of the waterproofing sheet, thus guaranteeing the perfect protection of the underlying structures.

FIG. 19b: LSC, Example of Embodiment

In this example of application of the invention, a Top part similar to that of FIG. 17 is mounted on a wooden beam (lower part) to create a bi-component LSC. A thermal break, similar to those described above, may be implemented.

FIG. 19c: Examples of Embodiment

FIG. 19 shows 5 examples of LSCs, 3 of them illustrated with a perspective view on the left and a side view on the right, and 2 of them only with section in the bottom right.
a) Z beam: In this example, the LSC is made of a Z beam. The panels may be directly attached to the Z beam using various types of clamps, if necessary (it depends on the panel's frame shape). The Z beam may be fitted with various accessories enabling for example to install insulation, sheathing sheet or waterproofing. A waterproofing sheet may be placed horizontally between the LSCs and go up on the sides on the Z beam.
b) Inverted U beam: Any kind of U beam can be used. The panels are screwed directly to the beam or using clamps.
c) Lateral U beam: Any kind of U beam can be used. The panels may be directly attached to the U beam using various types of clamps, if necessary (it depends on the panel's frame shape). The U beam may be fitted with various accessories enabling for example to install insulation, sheathing sheet or waterproofing. A waterproofing sheet may be placed horizontally between the LSCs and go up on the sides on the U beam.
d) In this case, a I beam is used as a LSC.
e) In this case, a wooden beam is used as a LSC.

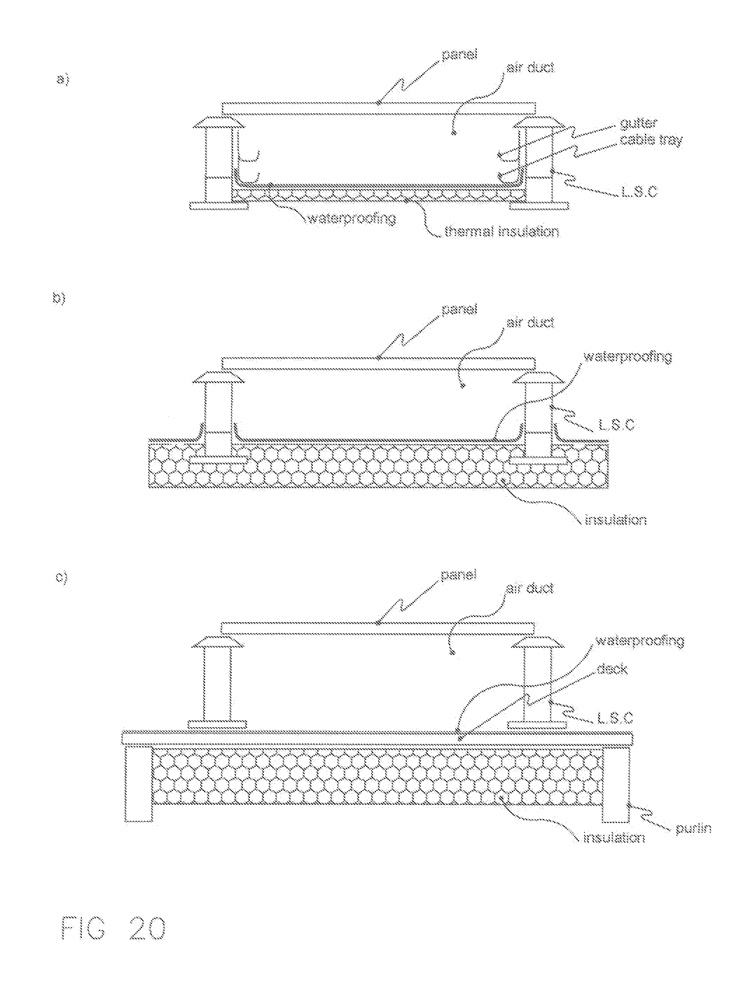

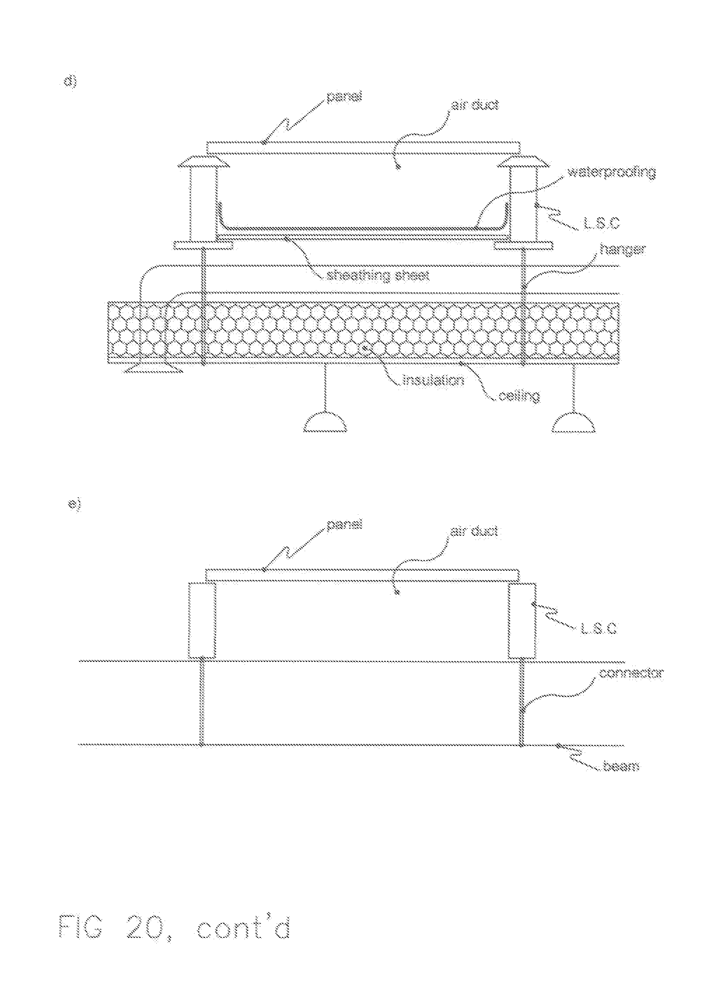

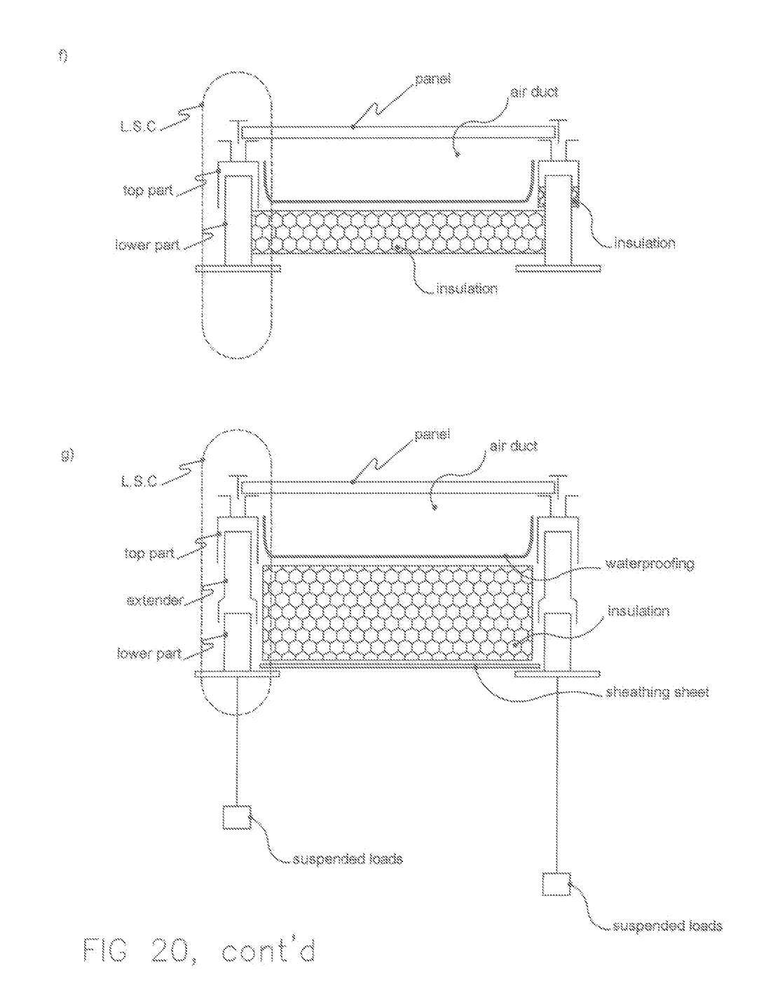

### FIG. 20: Examples of Configuration

This figure shows 7 section views, illustrating various types of outer skins. Of course, all these cases can be combined together: we only illustrate a few examples here.
a) In this example, the LSC is a mono-component part, made of a lower rail, a central portion and upper wings. It has lateral gutters/cable trays. The outer skin comprises panels, air duct, waterproofing and insulation fitted between the LSCs (and optionally a sheathing sheet).
b) In this example, the LSC is a mono-component part, made of a lower rail, a central portion and upper wings. The outer skin comprises panels, air duct, waterproofing and insulation. The thick insulation layer is between and below the LSCs, removing any condensation risk.
c) In this example, the LSC is a mono-component part, made of a lower rail, a central portion and upper wings. The system provides an air duct and sits on a classical roofing deck (instead of replacing it totally) made of purlins, wooden deck, insulation below and waterproofing above.
d) In this example, the LSC is a mono-component part, made of a lower rail, a central portion and upper wings. The outer skin comprises panels, air duct, sheathing sheet and waterproofing fitted between the LSCs. A ceiling is suspended to the LSCs. It may bear an insulation layer and/or technical equipment such as lighting, air conditioning, wiring, etc. . . . .
e) In this example, the LSC is a mono-component part, which does not include a lower rail. The LSC is attached to the underlying beam using am ad-hoc fixation system. The outer skin comprises panels, air duct, and other optional features.
f) In this example, the LSC is a bi-component element, made of a lower part and a top part, separated by a thermal break. The lower part comprises a lower rail and a central portion. The outer skin comprises panels, air duct, waterproofing and thicker insulation fitted between the LSCs (and optionally a sheathing sheet).
g) In this example, the LSC is a tri-component part, made of a lower part, a central extender and a top part, separated by a thermal break. The outer skin comprises panels, air duct, waterproofing and very thick insulation fitted between the LSCs (and optionally a sheathing sheet). Loads may be suspended to the LSCs or via a sub-system.

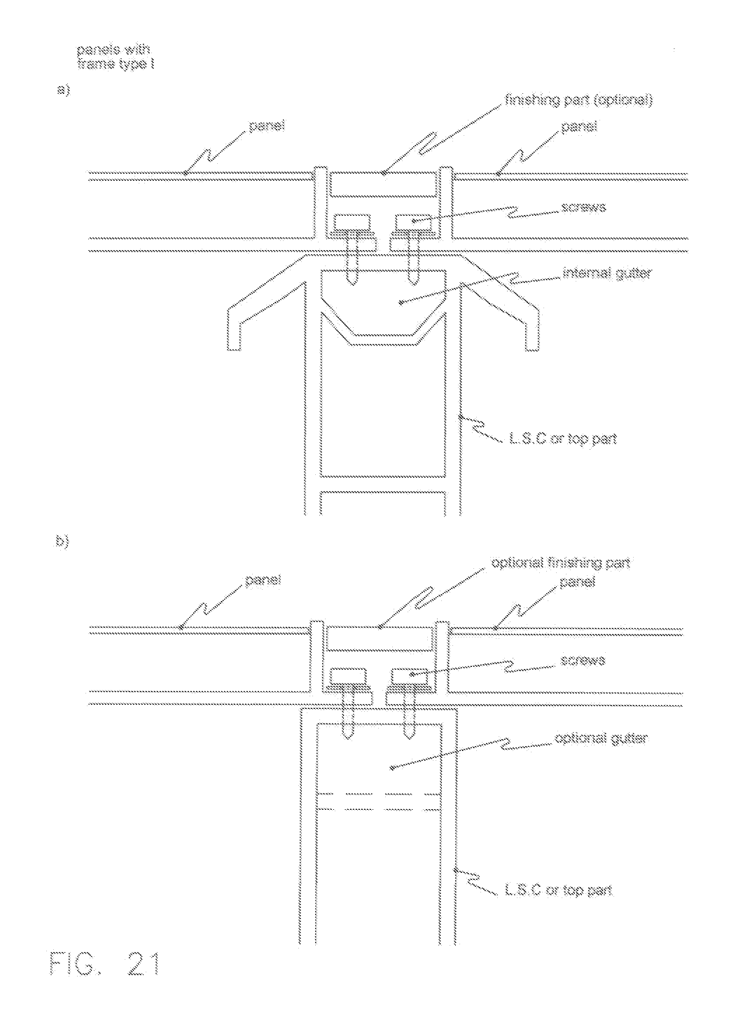

### FIG. 21: Examples for “Top and Fixation” Announced in FIG. 11

Solutions for panel attachment. This figure shows 4 section views with 4 examples of panel attachment solutions. In this series, we shall see solutions for panels whose frame allows for direct screwing (they have an outer horizontal frame). Of course, all these cases can be combined together: we only illustrate a few examples here.
a) In this case, the LSC is similar to FIG. 14. It has a flat top where the panels sit and an internal gutter below to evacuate any water flowing through the screwing holes. The panels are directly screwed to the LSC. A finishing part may be put to address the gap between the panels.
b) In this case, the LSC's top is similar to FIG. 16. It has an optional internal gutter. The panels are directly screwed to the LSC. A finishing part may be put to address the gap between the panels.
c) In this case, the LSC is a Z beam like in FIG. 19c. it could as well be a U. The panels are directly screwed to the LSC. A finishing part may be put to address the gap between the panels.
d) In this case, the LSC is an I or H beam. The panels are directly screwed to the LSC. A finishing part may be put to address the gap between the panels.

### FIG. 22: Examples for “Top and Fixation” Announced in FIG. 11

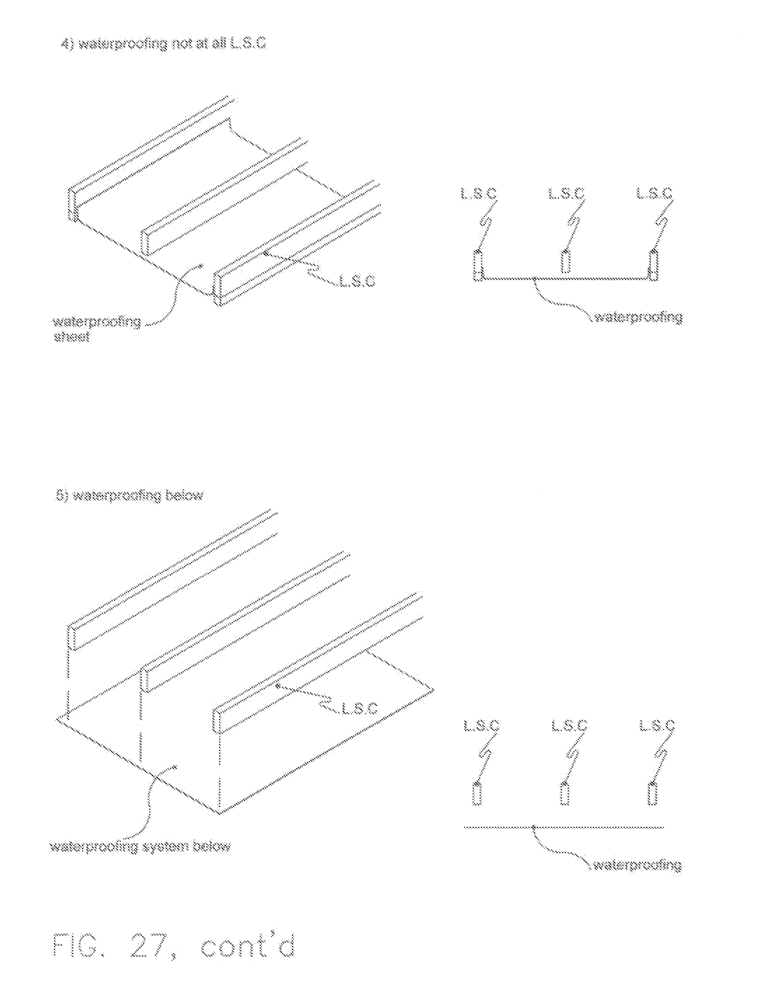

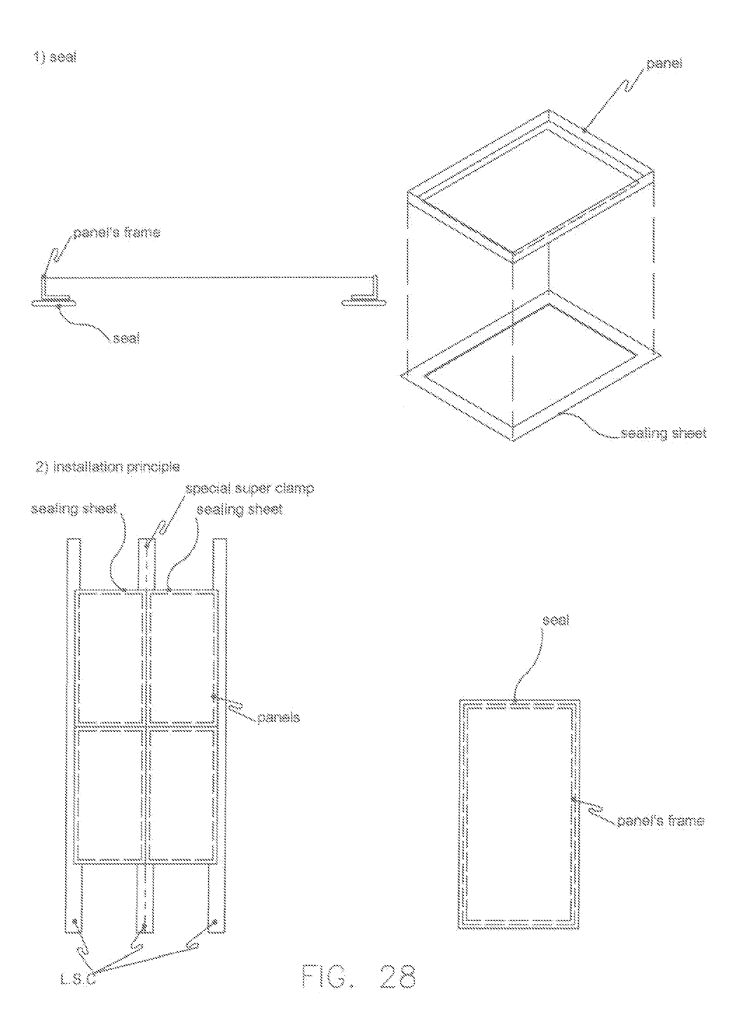

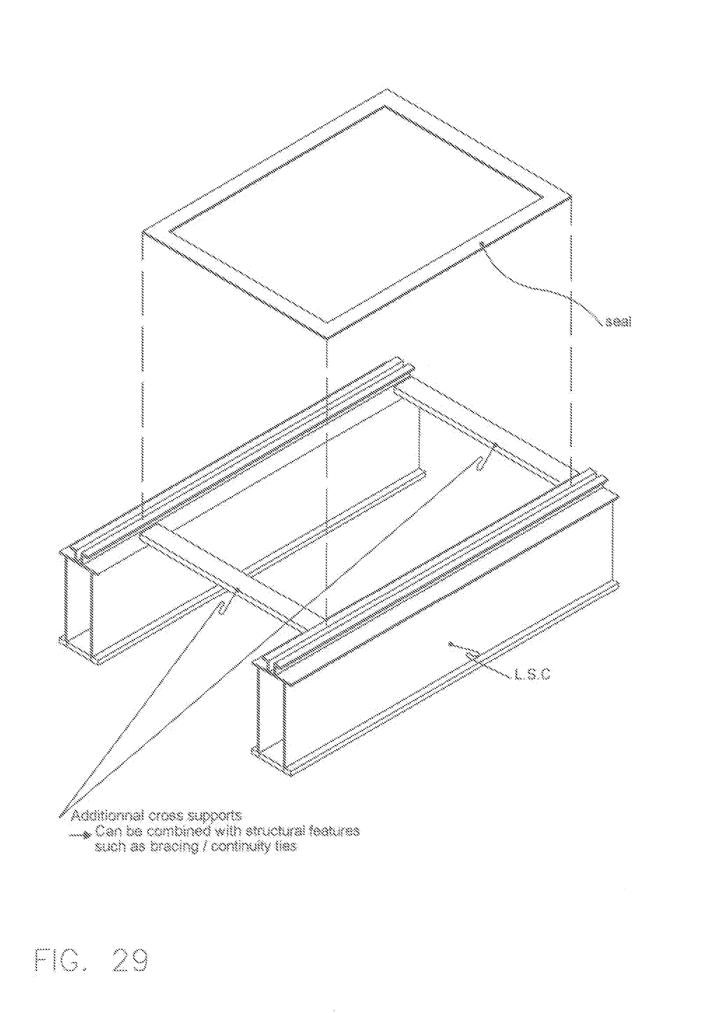

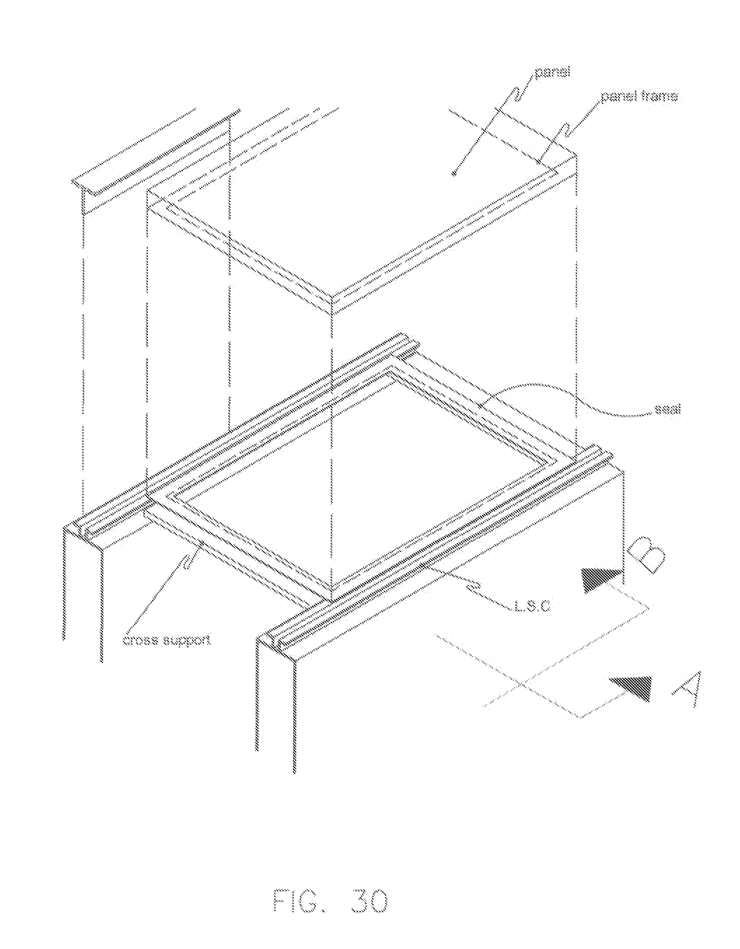

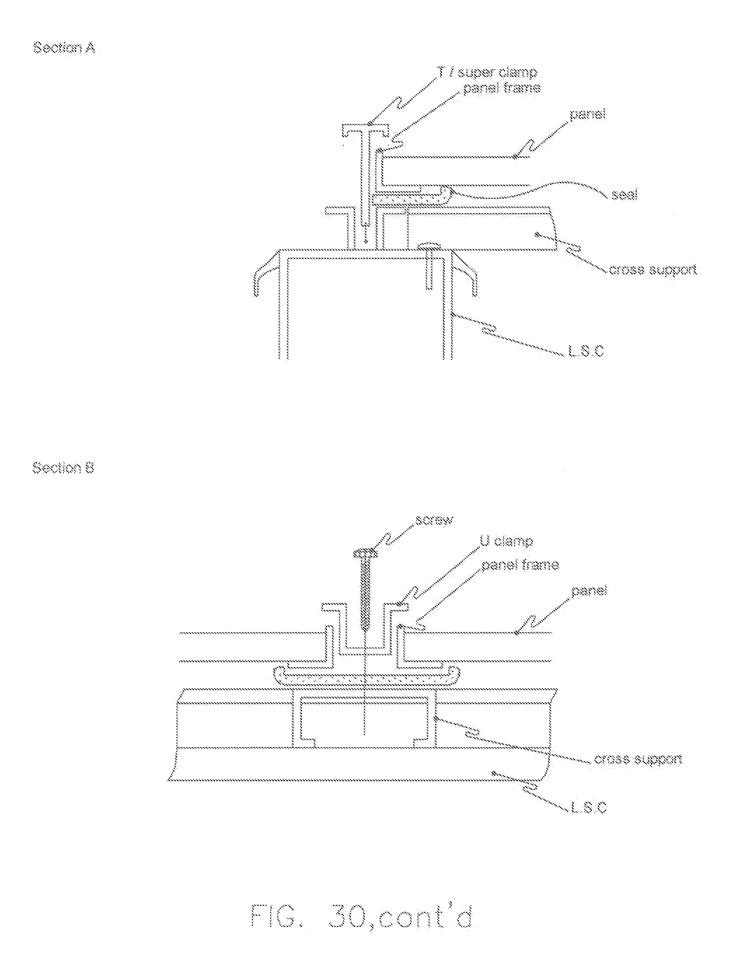

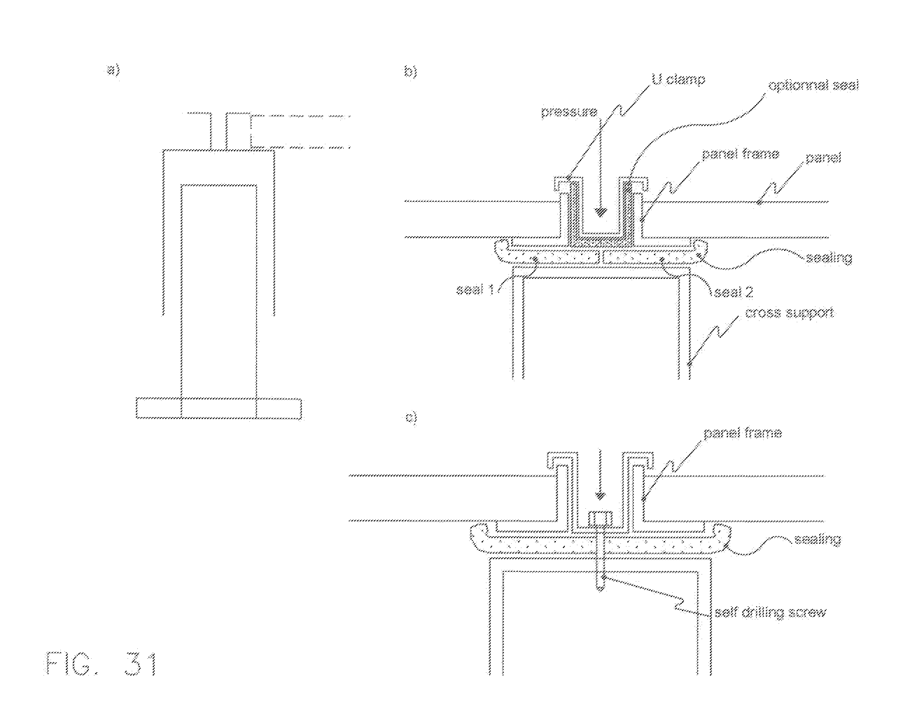

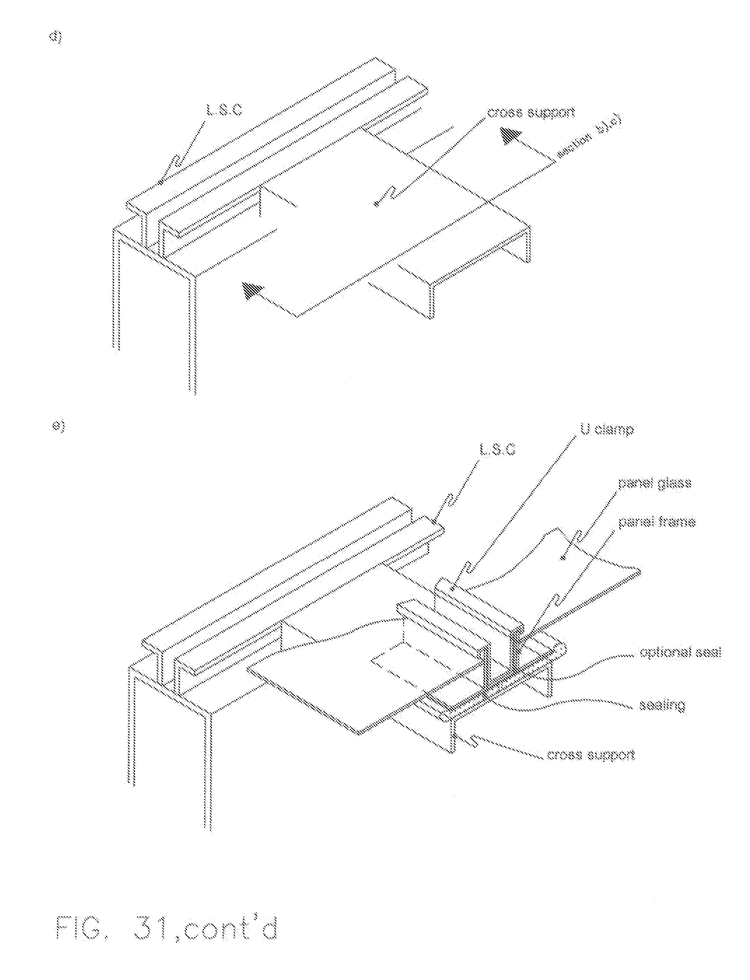

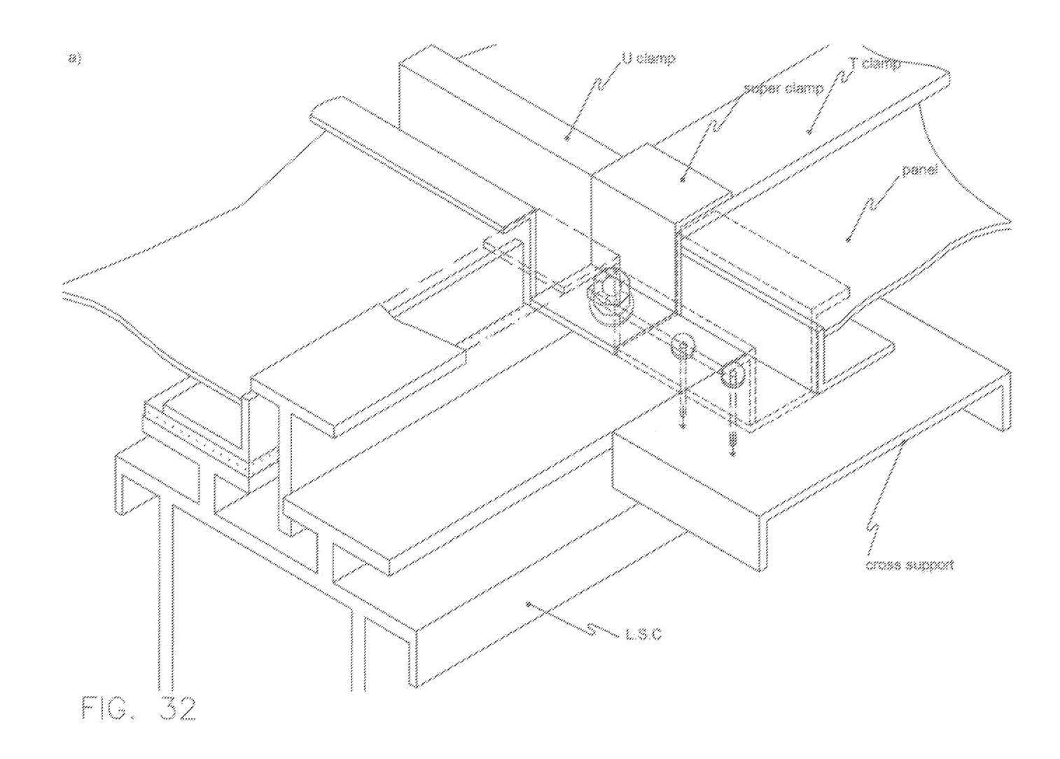

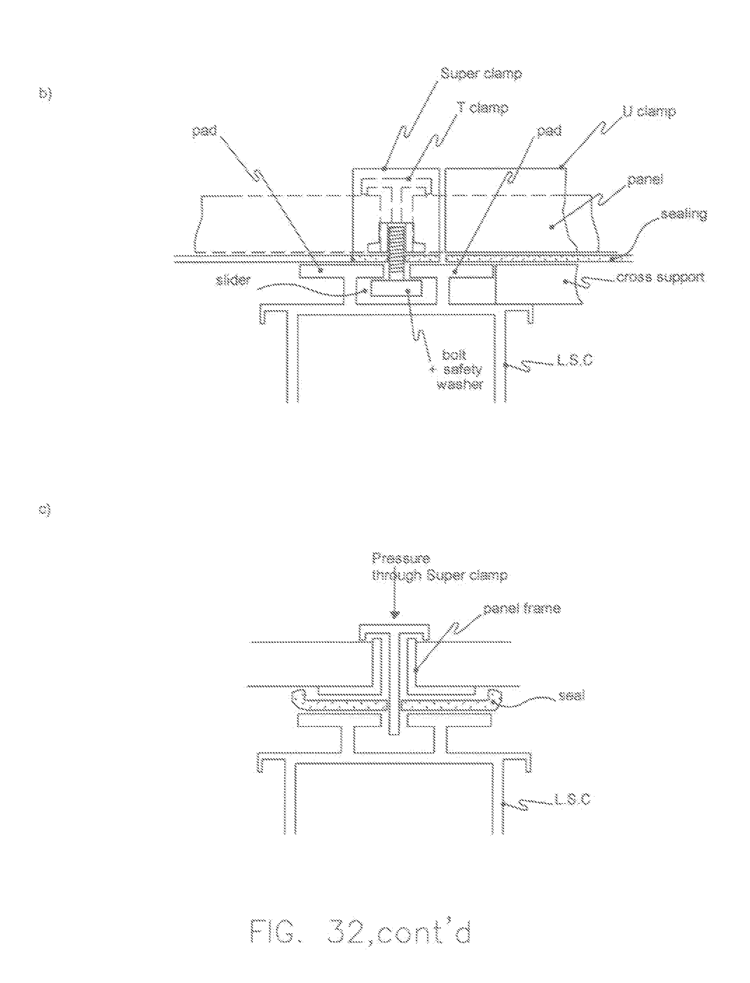

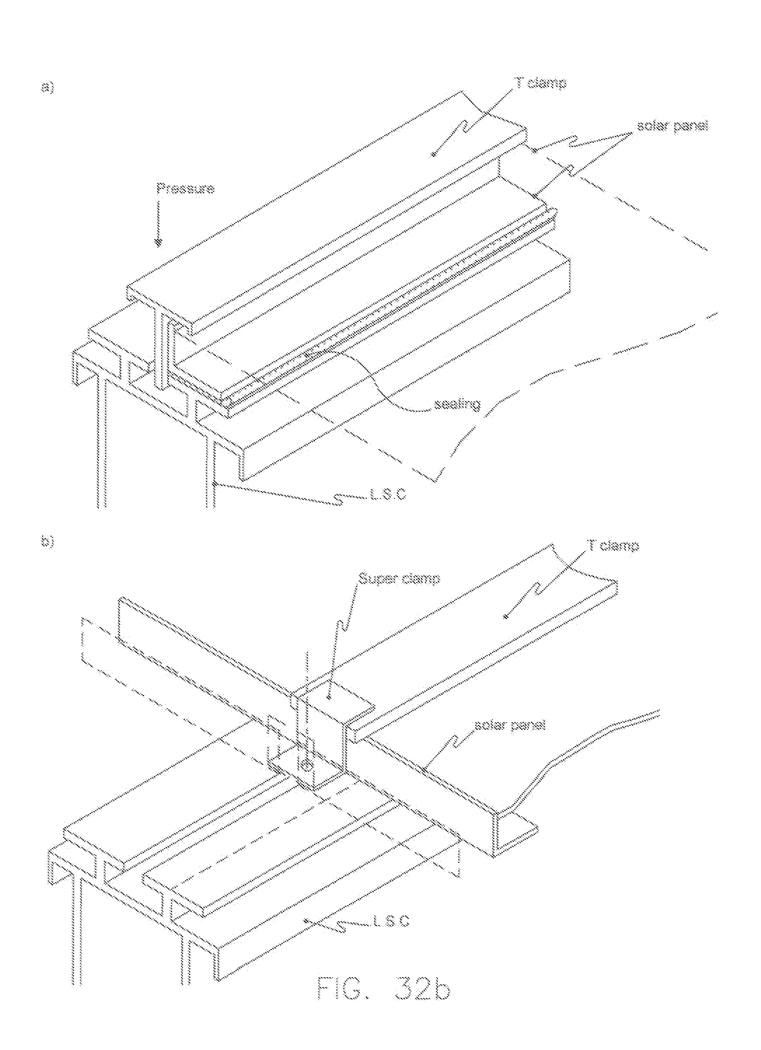

Solutions for panel attachment. This figure shows 5 sections views with 5 examples of panel attachment solutions. In this series, we shall see solutions for panels whose frame do not allow for direct screwing from the top. Of course, all these cases can be combined together: we only illustrate a few examples here.
a) In this case, the LSC is similar to FIG. 14. It has a flat top where the panels sit and an internal gutter below to evacuate any water flowing through the screwing holes. The panels are fixed using a clamp, which is directly screwed to the LSC. In this case, the clamp is a thin one, with the screw apparent above the plane of the panel, in order to reduce the gap between the panels. A finishing part may be put to address the gap between the panels.
b) In this case, the LSC's top is similar to FIG. 16. It might also be a Z or U beam. It has a flat top where the panels sit and an internal gutter below. The panels are attached using a U clamp, which is directly screwed to the LSC, the screw coming in the bottom of the U clamp. A finishing part may be put to address the gap between the panels.
c) In this case, the LSC is similar to FIG. 17, 18, 19 or 19b. It has 2 pads on the top, on which sit the panels and a gap between them where the fixation clamp can fit. In this scheme is shown a clamp similar to a), but instead of being screwed directly in the LSC, it is screwed in a slider bolt. A finishing part may be put to address the gap between the panels.
d) In this case, the LSC is similar to FIG. 17, 18, 19 or 19b H. It has 2 pads on the top, on which sit the panels and a gap between them where the fixation clamp can fit. In this scheme is shown a T clamp (better described in FIG. 32). The “T Clamp” may also be used as a finishing part addressing the gap between the panels.
e) In this case, the panels are attached to a LSC formed of a U beam, which sits on a deck.
   FIG. 22b: Examples of Attachment of the Top Part to the Core of the LSC, as Announced in FIG. 11

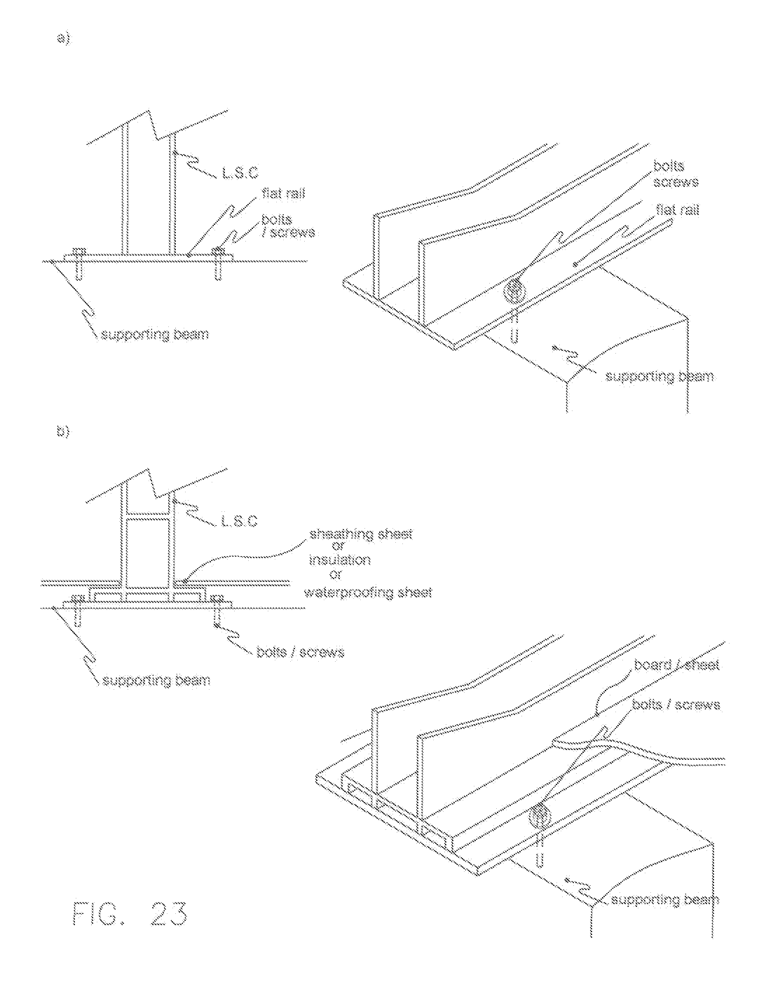

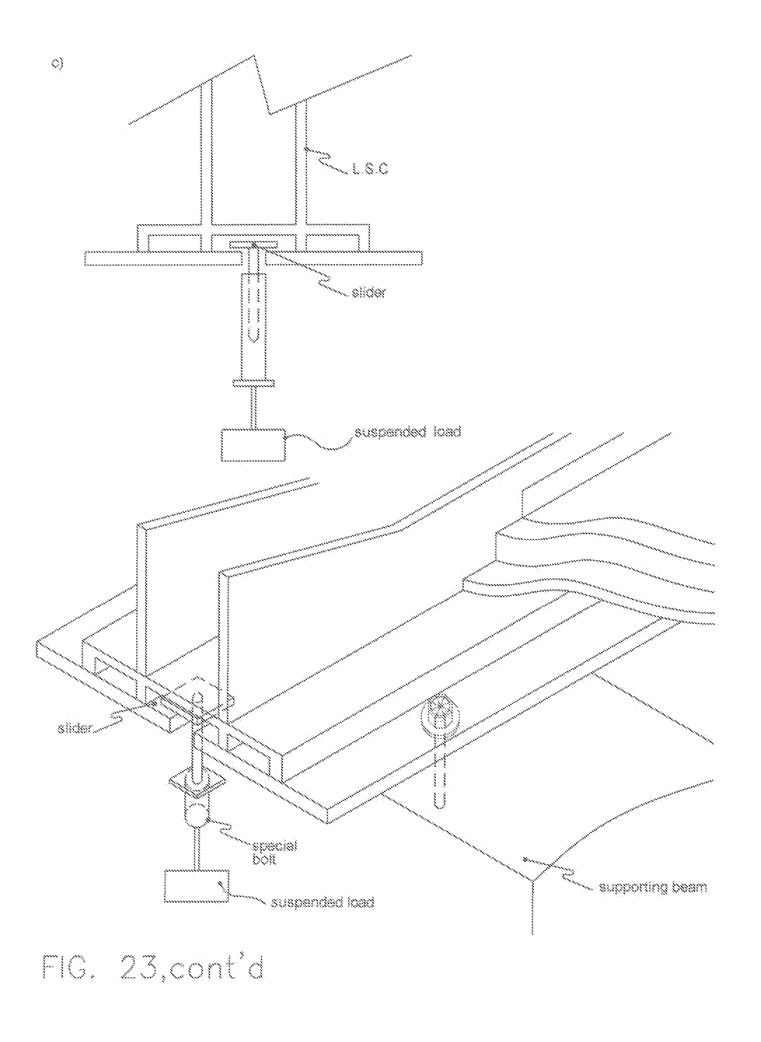

Solutions for attachment of the top part. This figure shows 5 sections views with 5 examples of attachment solutions. Of course, all these cases can be combined together: we only illustrate a few examples here.
a) In this case, like in FIG. 17, 18, 19 or 19b, the top part wraps around the upper part of the lower component, whatever it is, and is attached to it. The LSC is similar to FIG. 17. It has 2 pads on the top, on which sit the panels and a gap between them where the fixation clamp can fit.
b) In this case, the top part is a mere slider in which a screw sliding bolt system attaches a clamp. This slider is attached on top of the lower part, which may be any kind of profile or beam, including wood, tubes, Z, or U beams, etc. . . . .
c) In this case, the LSC's top is similar to FIG. 16. It has a flat top where the panels sit and an internal gutter below. It wraps around the upper part of the lower component, whatever it is, and is attached to it.
d) In this case, the LSC is similar to FIG. 19. A top part similar to FIG. 17, 18, 19 or 19b wraps around a height extender and is attached to it.
e) In this case, the top part is a U profile on which the panels are attached directly or using a clamp. This U profile is attached on top of the lower part, which may be any kind of profile or beam, including wood, tubes, Z, or U beams, etc. . . . .
   FIG. 23: Examples of Lower Parts and their Connection to the Support.

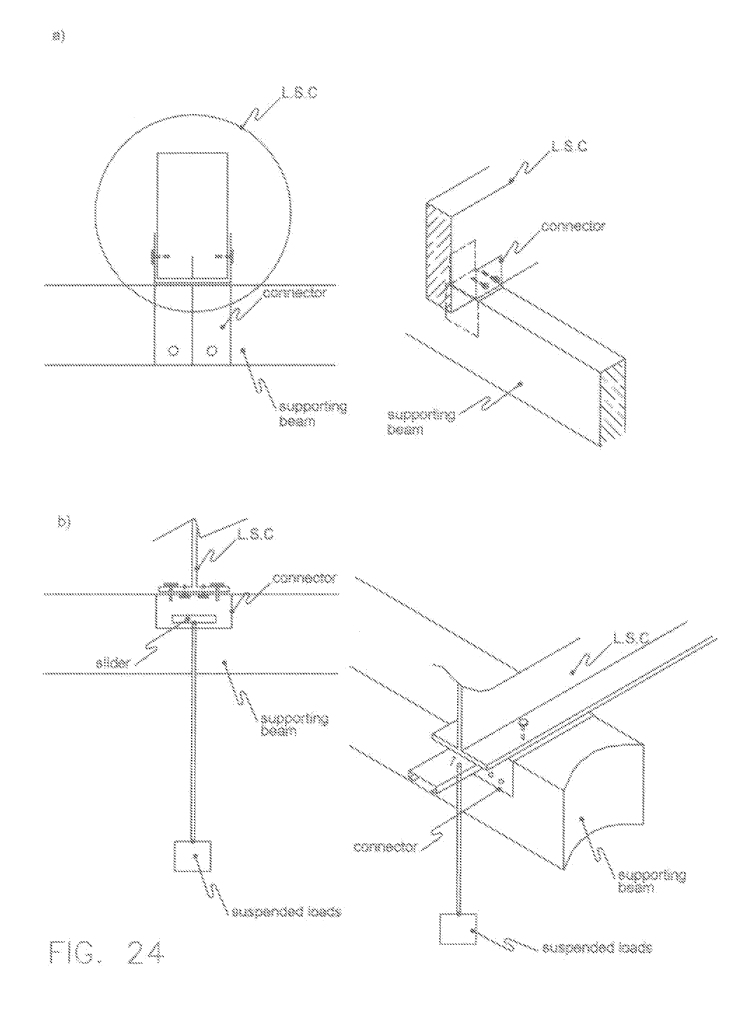

This figure shows 3 cases of lower parts, each one being illustrated with a perspective view on the right and a side view on the left.
a) The lower part of the LSC is made of a central portion and a simple flat rail. Bolts or screws attach this rail to the supporting beam.
b) Same as above, except that the rail has 2 levels: one for the bolt and one to support a board or a sheet such as sheathing sheet, insulation board or waterproofing sheet.
c) Same as above except that the lower rail includes a slider in below, allowing to suspend loads using a slider bolt or a direct fixation.
   FIG. 24: Examples of Lower Parts and their Connection to the Support.

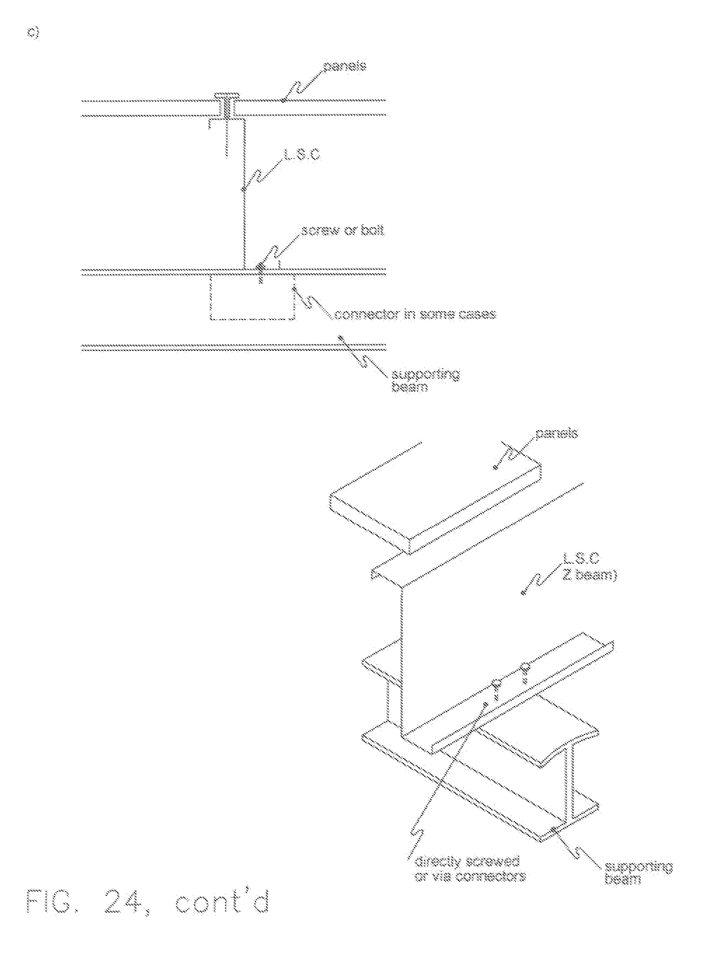

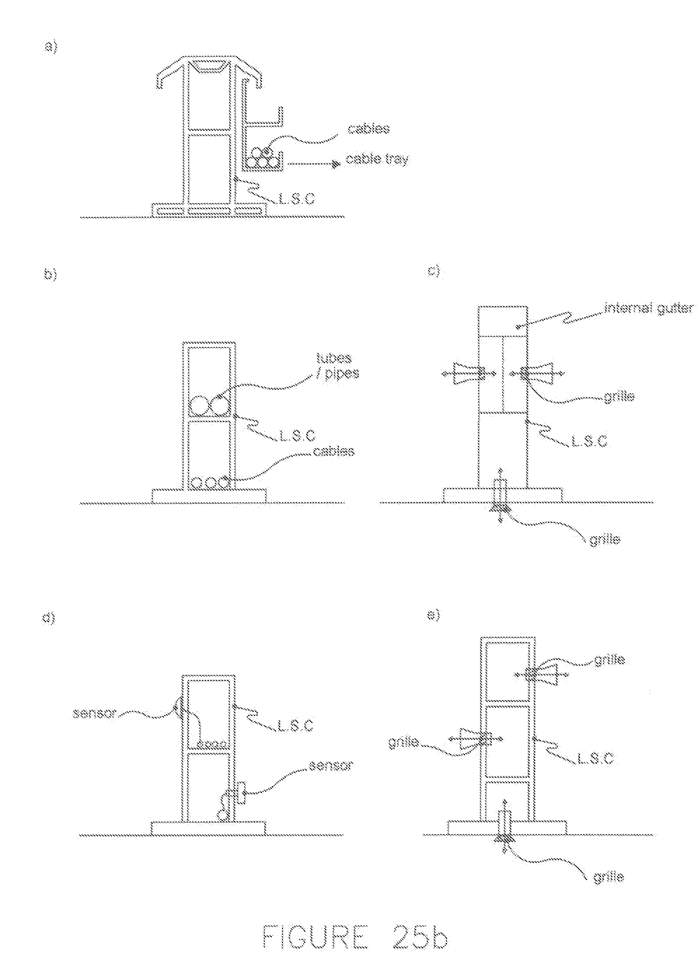

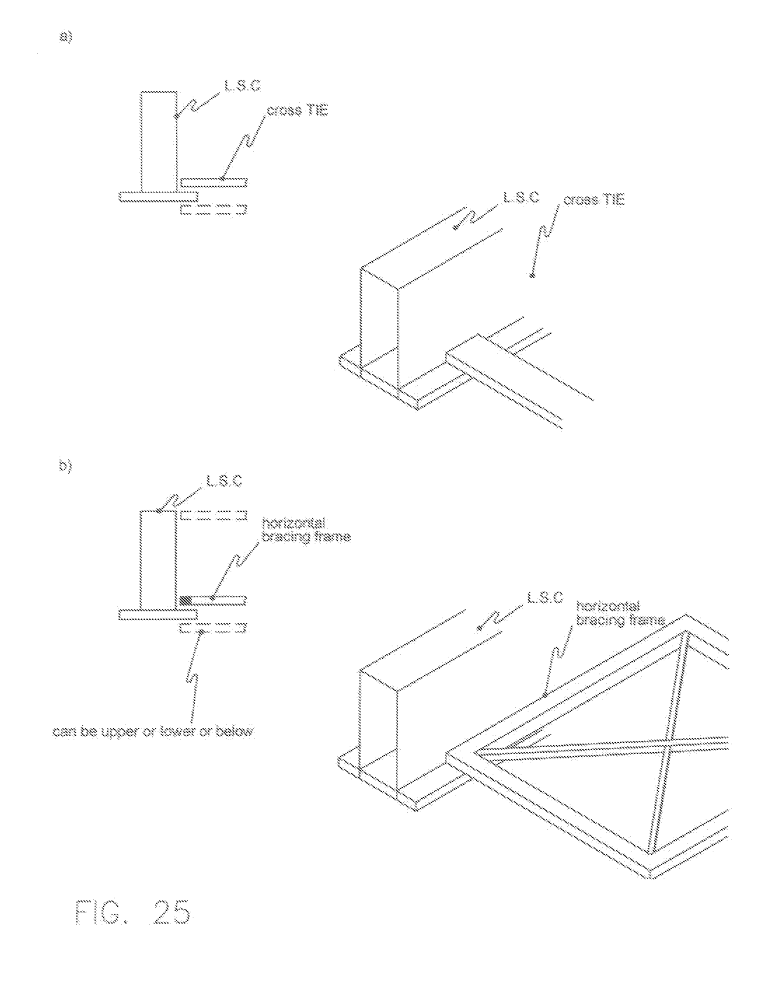

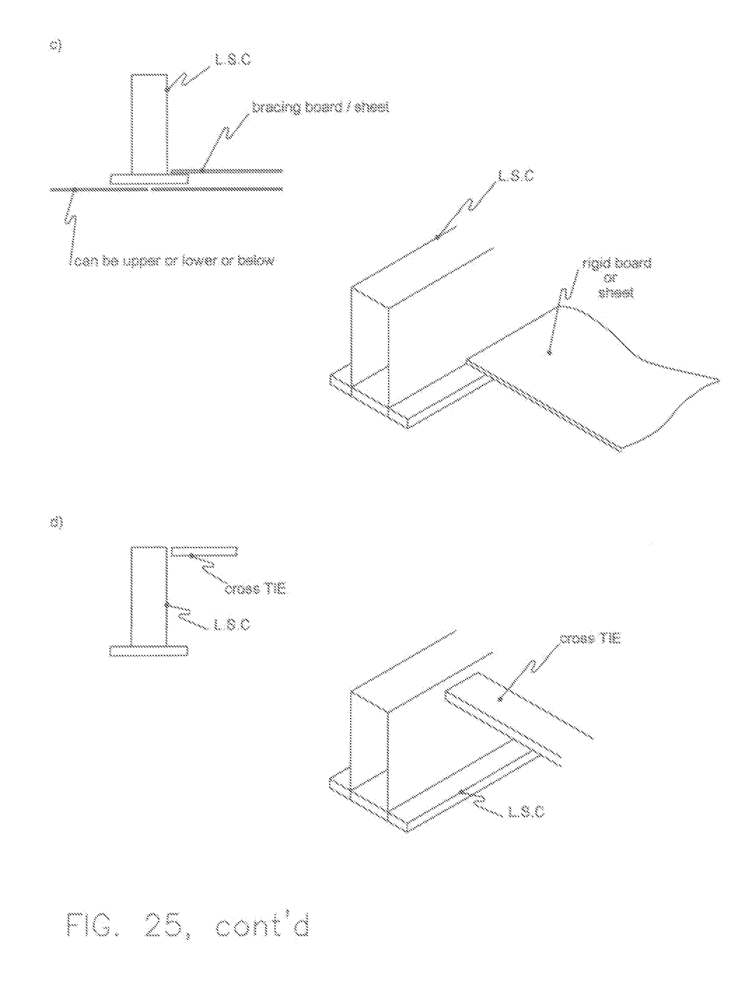

This figure shows 3 cases of lower parts, each one being illustrated with a perspective view on the right and a side view on the left.
a) In this case, we assume the LSC is supported by a wooden beam (the LSC's lower part may itself be a wooden beam). It is attached to it using a classical carpenter's connector.
b) In this case, we assume the lower part of the LSC is made of a H beam, which is attached to the supporting beam using an appropriate connector depending on the kind of supporting beam. The lower part is equipped with a slider designed to support suspended loads.
c) In this case, we assume the LSC's lower part is made of a Z beam. Depending on the type of supporting beam, it is attached either using screws or bolts or using connectors.
   FIG. 25: Examples of Application of the Invention in which the System Provides Rigidity

This figure shows 4 cases of lower parts, each one being illustrated with a perspective view on the right and a side view on the left.
a) In this case, a cross tie is created between 2 LSCs, using a component attached to the LSCs and perpendicular to them. Other geometries are possible. This may be used, for example, to create a continuity tie or a spacer.
b) In this case, a horizontal bracing is created between 2 LSCs, using a bracing frame. This frame may be put at the lower part on the LSC or upper.
c) In this case a horizontal rigidity is created using a rigid sheet (for example a plywood or a metal sheet). This sheet may be placed on the lower rail of the LSC or below the LSC.
d) Same as a), but with the cross tie placed in the upper part of the LSC.
   FIG. 25b: Examples of Application of the Invention with Accessories and Functions

This figures shows 5 examples of optional features of the LSC
a) The LSC is equipped with an external gutter, which circulates cables or pipes
b) The inner chambers of the LSC are used as cable trays or pipe trays
c) The internal chambers of the LSC are used as gutter and air ducts and they may be connected with the outside through grilles
d) Same as b), comprising the LSC being equipped with sensors and connections
e) The internal chambers of the LSC are used as air ducts and they may be connected with the outside through grilles

### FIG. 26: Waterproofing

This figure is about waterproofing in the case the waterproofing is achieved using a waterproofing sheet from LSC to LSC, with the waterproofing sheet going up on the sidewalls of the LSC.

5 cases of application are showed as examples. Cases a), b) and e) are illustrated with a schematic section and a perspective view. Cases c) and d) are illustrated with a schematic section.

The general principle, in this case, is that a waterproofing sheet lies horizontally between 2 LSCs, possibly on top of a support such as insulation or sheathing sheet. To achieve a safe waterproofing, the sheet goes up on the sidewalls of the LSC. Optionally, in order to prevent any water from flowing behind the sheet, the top of the sheet is covered, either by a wing forming a drip, by a wrapped sheet, by a specific part or by sliding into a protected gap forming a drip.
a) The LSC in this example is similar to FIG. 14. A waterproofing sheet, which may be made of various materials, lies on an optional sheathing sheet and an optional insulation layer. It goes up on the sidewall of the LSC, where it is covered by the upper lateral wings. A lateral gutter or any other part, is placed below the upper lateral wing of the LSC in such a way that no water coming from above (from the layer of panels) can flow behind it. It is pressed against the sidewall of the LSC (for example screwed, or pressed in any way). The waterproofing sheet is squeezed between the sidewall of the LSC and the pressing gutter or part. No water can access the rear face of the waterproofing sheet and therefore no leakage is possible.
b) In this example, the LSC is a modified version of FIG. 16 or FIG. 15. A waterproofing sheet slides behind an overlapping wing of the LSC (drip) or behind its sidewall. and may be fixed here. A waterproof wrap may complete or replace the system, or may be used to seal the gaps between 2 LSCs in the case several LSCs are mounted end to end.
c) In this case, the LSC is a modified version of FIG. 14. Panels are clamped on the upper face of the LSC, and a gutter collects any water that could leak in the screwing holes. The waterproofing sheet slides behind an (drip) wing (drip) and may be locked here.
d) In this case, the LSC is similar to FIG. 18. The panels sit on horizontal pads and they are attached to the LSC by clamps bolted using the slider. This way, there is no piercing and no water can fall inside the LSC. An internal gutter is provided: it may be used in the case of a junction end to end between 2 LSCs. The waterproofing sheet lies horizontally between the LSCs and goes up on the sidewalls. It slides under the wing and, optionally, it is held there by a pressure part. This pressure part may allow for the waterproofing sheet and the LSC to slide a little bit on each other, in order to enable differential thermal expansion.
e) In this case, the LSC is similar to FIG. 17. The panels sit on horizontal pads and they are attached to the LSC by clamps bolted using the slider. This way, there is no piercing and no water can fall into the LSC. An internal gutter is provided: it may be used in the case of a junction end to end between 2 LSCs. The waterproofing sheet lies horizontally between the LSCs and goes up on the sidewalls. It slides under the wing and, optionally, it is held there by a pressure part. This pressure part may allow for the waterproofing sheet and the LSC to slide a little bit on each other, in order to enable differential thermal expansion.
   FIG. 26b: Optional Waterproofing Sliding Pressure System

This figure shows an example of a solution for creating the sliding pressure system seen in FIG. 26 d) or e). This system may also help achieve air tightness.

Views a), b), c) are progressive enlargements of a schematic section.

The waterproofing sheet goes up on the sidewall of the LSC. Optionally, it slides into a protective gap (drip), created by an overlapping wing.

An optional pressure system pushes it against the wall in order to achieve sealing without fixed fixation such as gluing or screwing. This enables the waterproofing sheet to slide a little bit on the wall, for example in case of a different thermal expansion. In some cases, a seal may be put between the LSC's and the waterproofing sheet. A pressing part is pushed against the waterproofing sheet, either by a spring system or a screw system. It squeezes the sheet against the wall, thus holding it in place and achieving airtightness.

### FIG. 27: Examples of Waterproofing Options

This figure shows 5 examples of waterproofing options. Scheme 1) is a schematic section. Schemes 2) to 5) are a schematic section +a schematic perspective view.
1) In this case, the LSCs bear a top layer and there is no waterproofing at all
2) In this case, the LSCs bear a top layer and the waterproofness is achieved using a waterproof top layer
3) In this case, the waterproofness is achieved from LSC to LSC, using for example, one of the solutions described in FIG. 26.
4) Same as above except that the waterproofing sheet may include several rows of LSCs. It goes up on the sidewalls of the final LSCs, but passes below the intermediate LSCs.
5) In this case, as described in FIGS. 3b, 7, 15 and 20, the waterproofing is made below all the LSC, and may never go up on the sidewalls if no raised edge is needed. It may be created just below the LSCs or anywhere below them.

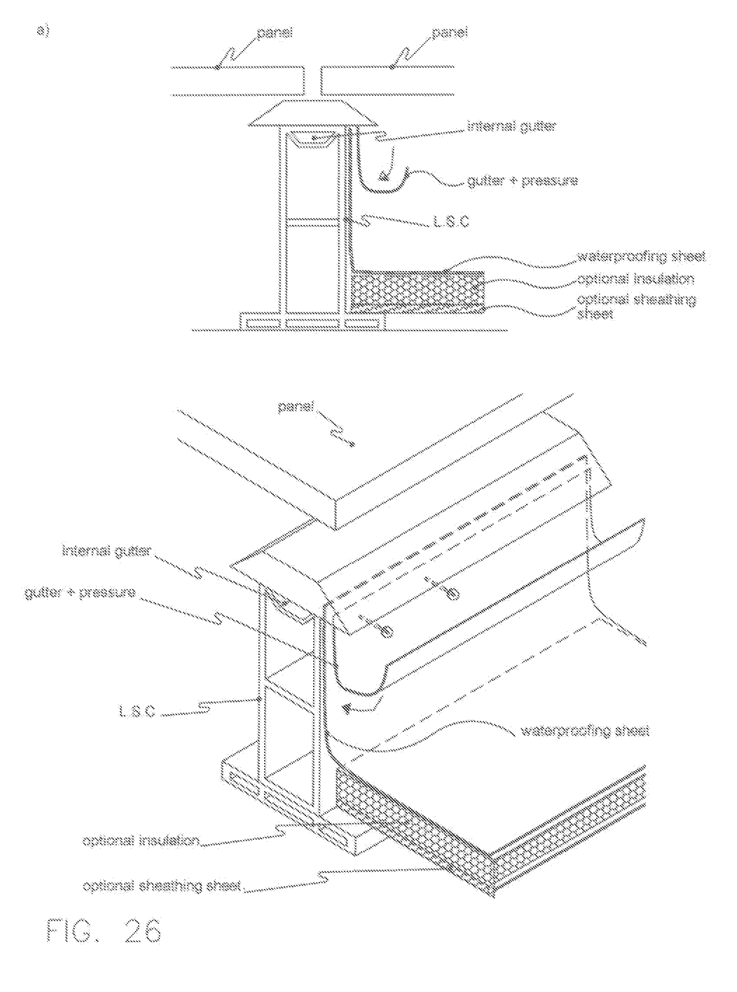

### FIG. 28: Example of Airtightning System for Non-Specific 3rd Party Solar Panels, or Other Panels.

This figure describes the principle of a system aiming at achieving airtight air ducts even with non-specific panels. The idea is to put a sealing sheet under the panel, like a frame. This “frame” covers more than the area of the panel's lower frame: it is extended a few millimeters around it.

The seal comes below the panel's frame and is pressed against a fixed part in below.

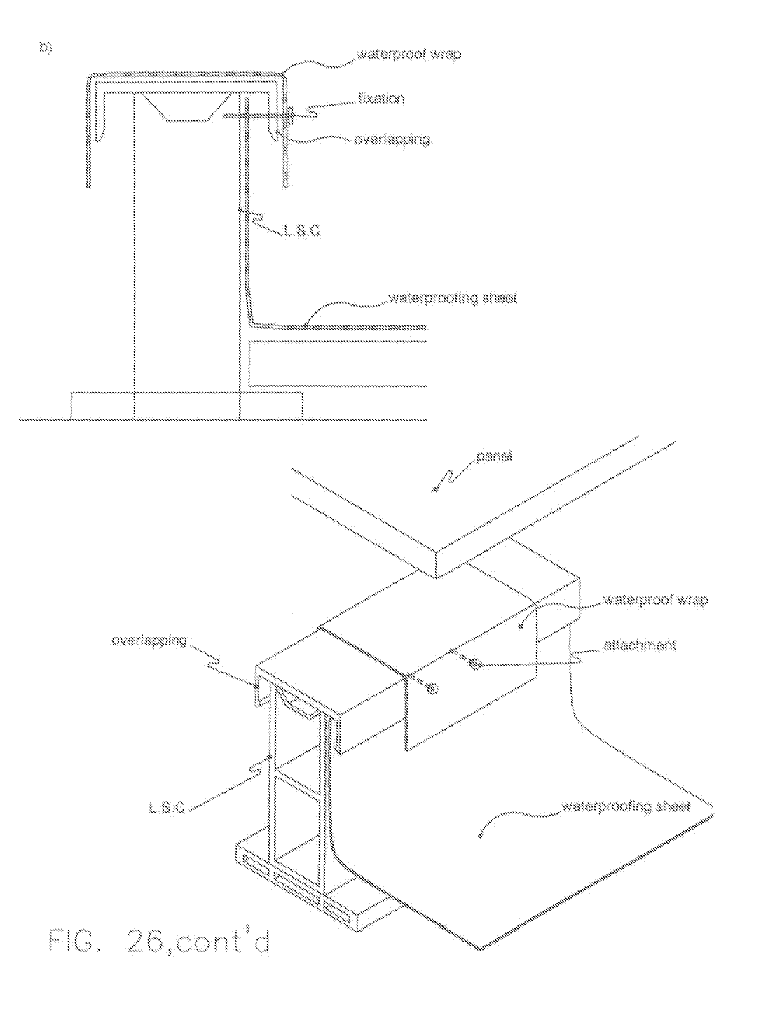

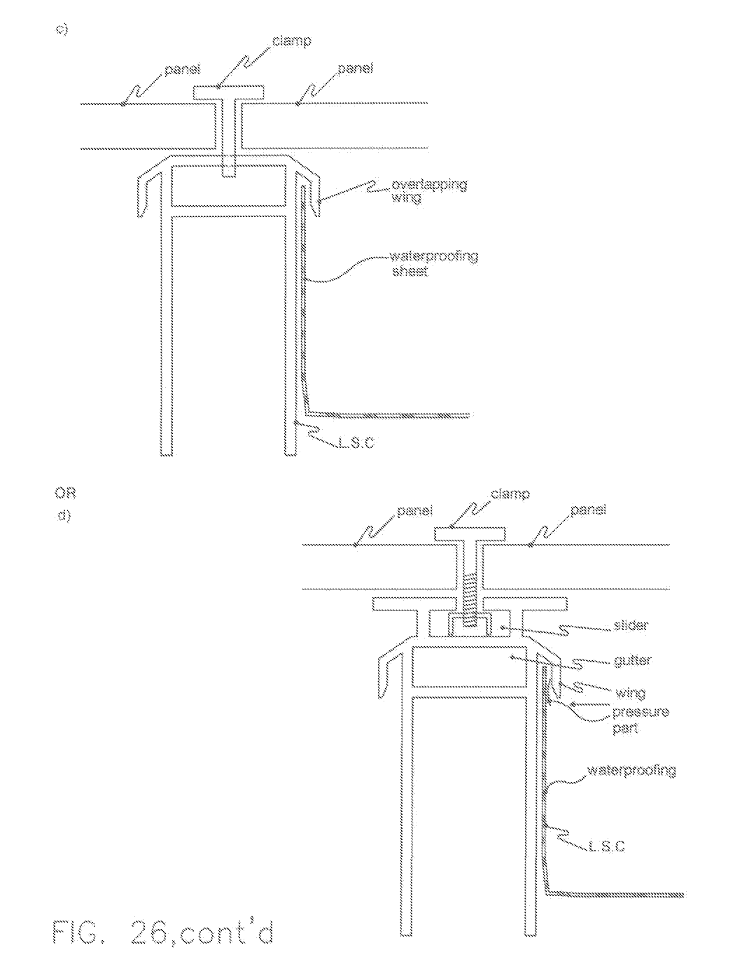

### FIG. 29: Example of Airtightning System for Non-Specific 3rd Party Solar Panels, or Other Panels.

This figure shows an exploded perspective view.

A seal, shaped as a frame matching the panel's lower frame, is applied on a supporting frame on its 4 sides: 2 sides are provided by the LSCs and 2 sides are provided by additional cross supports put transversally between the LSCs and at the same upper level.

These cross supports may be combined with structural features such as bracing or continuity ties.

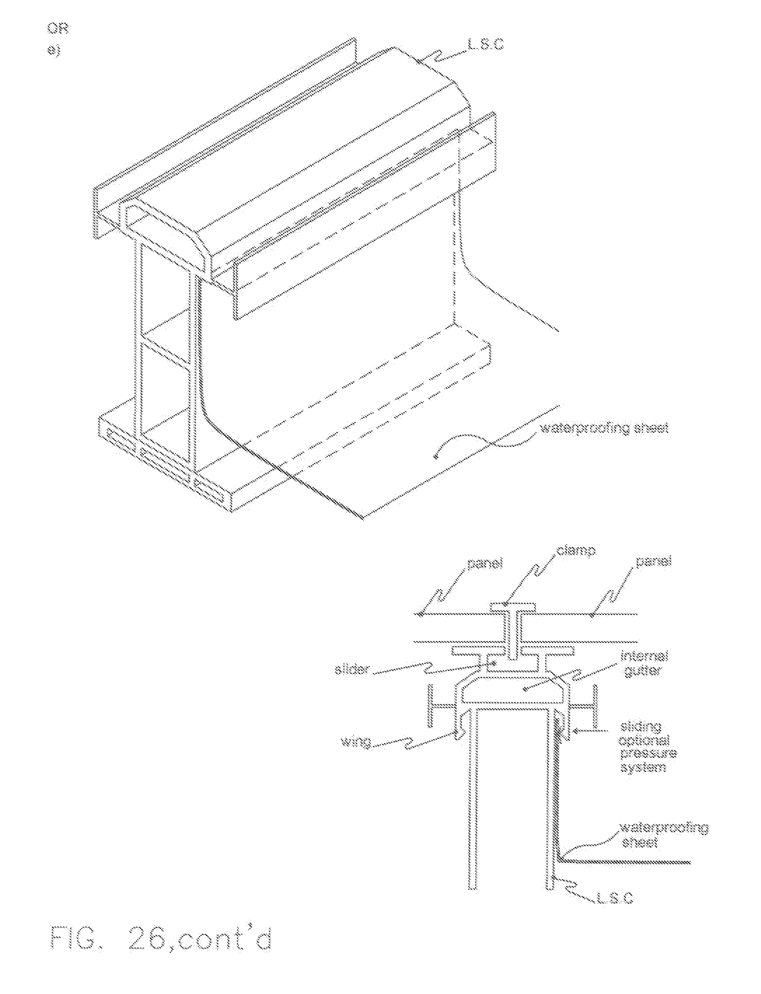

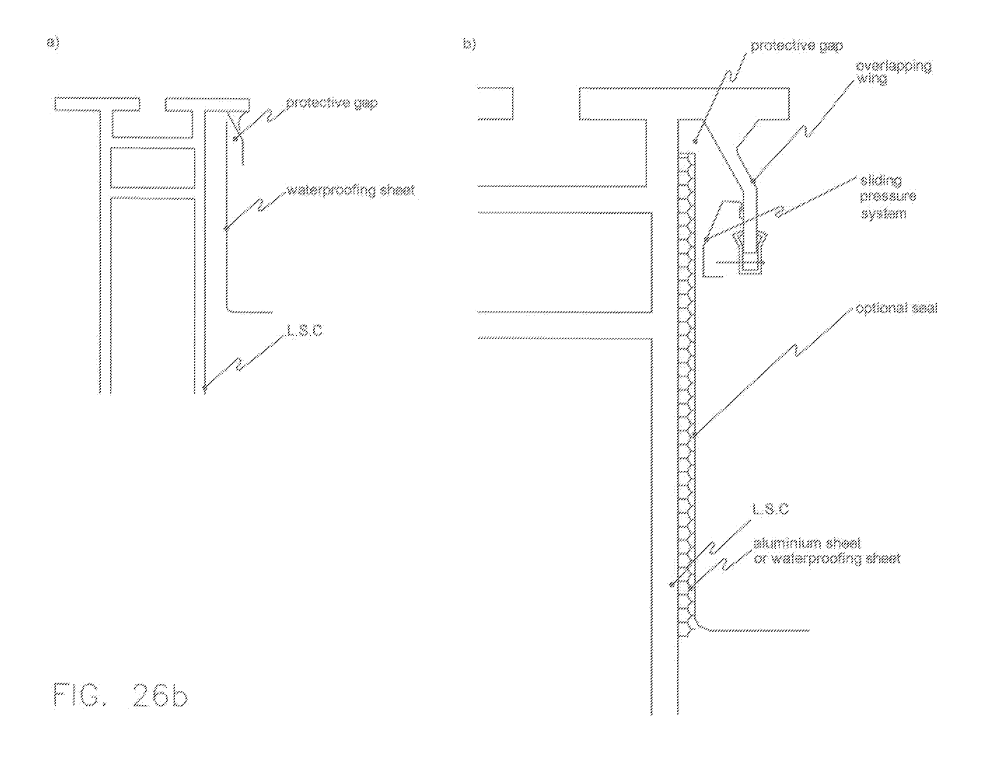

### FIG. 30: Example of Airtightning System for Non-Specific 3rd Party Solar Panels, or Other Panels.

This figure shows an exploded perspective view and 2 schematic sections A & B (the section planes are identified on the perspective view).

Step 1: the seal is placed on its supports: 2 LSCs+2 cross supports. LSCs or panels may have different shapes; we are here describing one example.

Step 2: the panel is placed on the seal

Step 3: the panel is locked and pressed vertically. Its lower frame presses the seal and airtightness is achieved. In this example, the clamp on the LSC axis is a T Clamp and on the transversal axis it is U clamp.

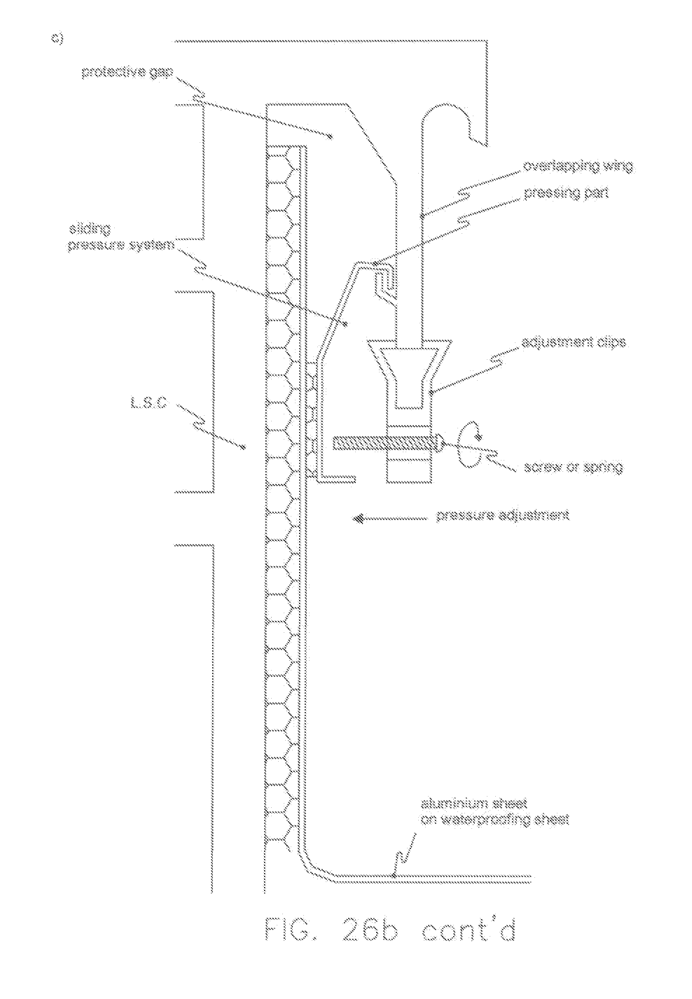

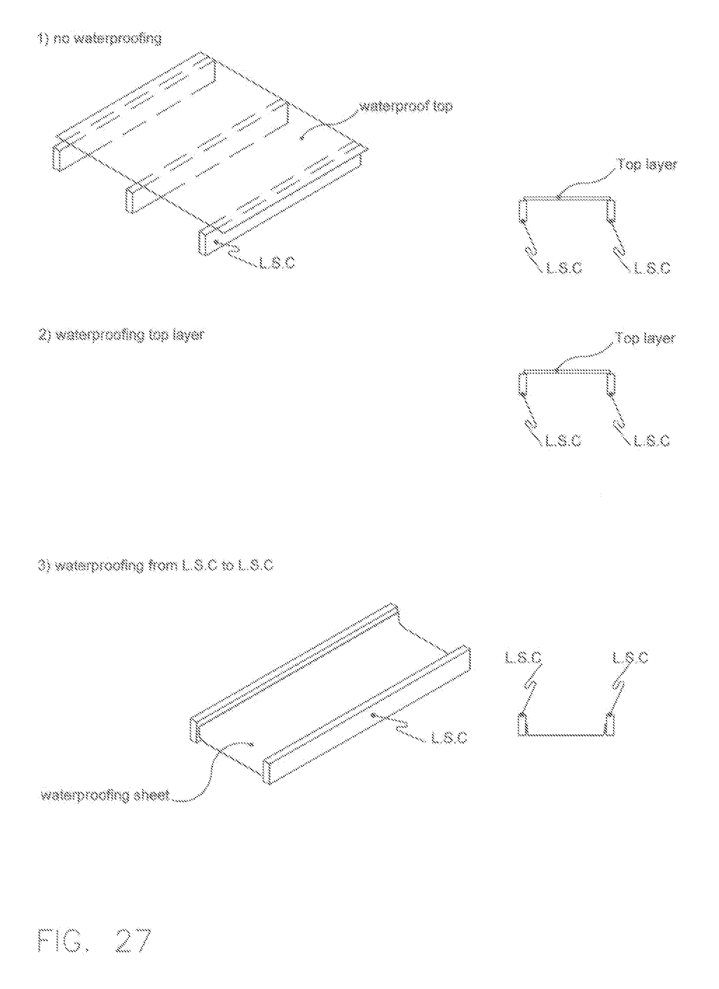

### FIG. 31: Example of Airtightning System for Non-Specific 3rd Party Solar Panels, or Other Panels: Cross Sealing

This figures shows an example of sealing on the transversal edge of the panel, between 2 LSCs.

A cross support is installed between the LSCs. Its top level matches exactly the LSC's pads' top level. This cross support supports 2 panels. The 2 seals are installed, almost touching each other. The 2 panels are placed, spaced by the size of a “U clamp”. The “U clamp” is placed and attached to the cross support, pressing the panels on the seal (the seal is squeezed between the panel's frame above it and the cross support below it), thus achieving a perfect sealing

### FIG. 32: U Clamp, T Clamp, Super Clamp

This figures describes an original way to attach the panels on the LSCs. Alternatively, panels may also be attached with a traditional Clamp.

It shows a perspective view (a), and 2 sections b) and c). Section b) cuts through the super clamp. Section c) cuts through the “T clamp”.

The perspective view shows the meeting area of 4 panels. The longitudinal LSC supports a transversal cross support.

In the longitudinal axis (LSC), the panels are attached by a “T clamp”, which is as long as the panel's edge. A “T Clamp” is a T shape component, which fulfills altogether the functions of clamp and of finishing part. It locks the panels on its whole length. Higher than the panel frame, it slides into the gap between the 2 supporting pads, in order to achieve an excellent lateral control. It provides a continuous pressure on the panel in order to ensure the airtightning seal is properly compressed, if there is one.

In the transversal axis, the panels are attached by a “U clamp” as long as the panel's edge.

The “T Clamp” is attached to the LSC using a “Super Clamp”. The “super Clamp” may hold 1 or 2 successive “T Clamps”, and optionally the 2 lateral “U Clamps”.

The “Super Clamp” is attached at each end to the LSC thanks to a strong bolt using the slider between the pads and a safety washer.

FIG. 32b: U Clamp, T Clamp, Super Clamp

This figure shows 4 perspective views of the clamps system.
a) The “T Clamp” presses the panel against its supporting LSC, squeezing the seal between the lower panel frame and the LSC.
b) The pressure to the “T Clamp” comes from the “Super Clamp”, which holds each end of the “T Clamp” and presses it towards the LSC.
c) The “Super Clamp” is attached to the LSC using a strong bolt sliding in the slider created below the panel supporting pads.
d) The sliding bolt is made of a part that is held in the slider and of a bolt or a screw, screwing it.

### FIG. 33: Examples of Air Duct and Exchanges

This figures shows 8 schematic sections of a typical air duct offered by the system and a larger section showing several rows of air ducts. All these are examples aim at illustrating the numerous possibilities enables by the invention. Many other combinations are possible.

Air Duct Size Range
a) Regular setting with LSCs holding a skin and creating small thickness air duct
b) Regular setting with LSCs holding a skin and creating mid thickness air duct
c) Higher setting with LSCs holding a skin and creating high thickness air duct

Air Flows: The LSC May be Designed as Air Pipes Too.
d) 1 air flow in the main air duct
e) 1 air flow in the main air duct +Air flow 2 in the right LSC+Air flow 3 in the left LSC
f) There may be an exchange between the main air duct and the left LSC, and/or between the environment and the right LSC
g) There may be an exchange between the main air duct and the environment, and/or between the right LSC and the opposite environment
h) There may be an exchange between the main air duct and the left LSC, and/or between the environment, an exchange between the left LSC (each LSC can comprise several air pipes) and the environment. The right LSC may comprise sensors, cables, pipes, etc. . . . .
i) If we consider a large outer skin, it may comprise several rows of air ducts and LSCs. Each element may have a specific function and run specific exchanges both inside the system and with the environment.

### FIG. 34: Examples of Flow Management on a Roof.

The ability of the outer skin to be an air duct or an air flow system gives many possibilities, including creating active thermic skins.
a) Natural air flow: fresh air enters the duct in the lower part and naturally runs upwards, pushed by a natural convection due to the panels' heat. In some cases, the flows can run the other way.
b) Faned airflow: the airflow is powered, in any direction. In this case the motor is at the bottom
c) Faned airflow: the airflow is powered, in any direction. In this case the motor is at the top
d) Multi air duct: the length of the roof is divided into several air ducts with intermediate air intakes or vents
e) Both ends of the roof's air duct are connected to an exterior duct, such as a building's air management system.
f) In this case, air enters or exits the duct freely at one end and is sucked or blown at the other end by an external system which may, for example, be the interior air flow system of a building
g) Same as above but with the roof being divided into several air circuits, and various air vents
h) In this case, the inner face of the skin provides exchanges with the inner volume. The air duct may, or may not, be open to exterior air, or be faned.

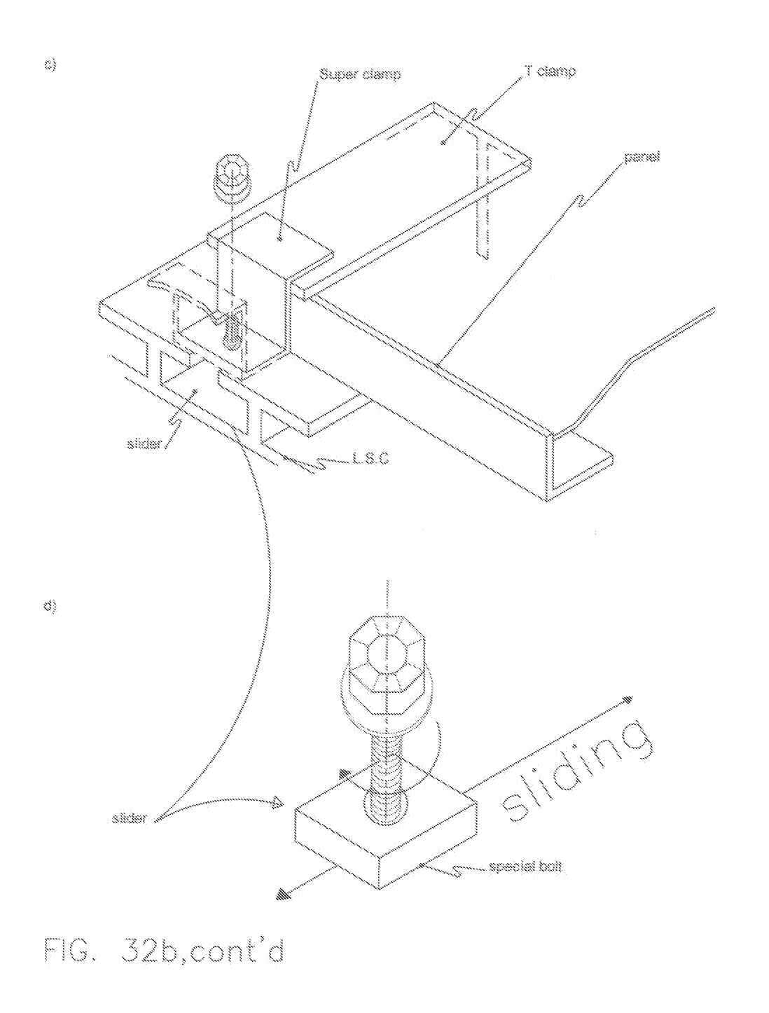

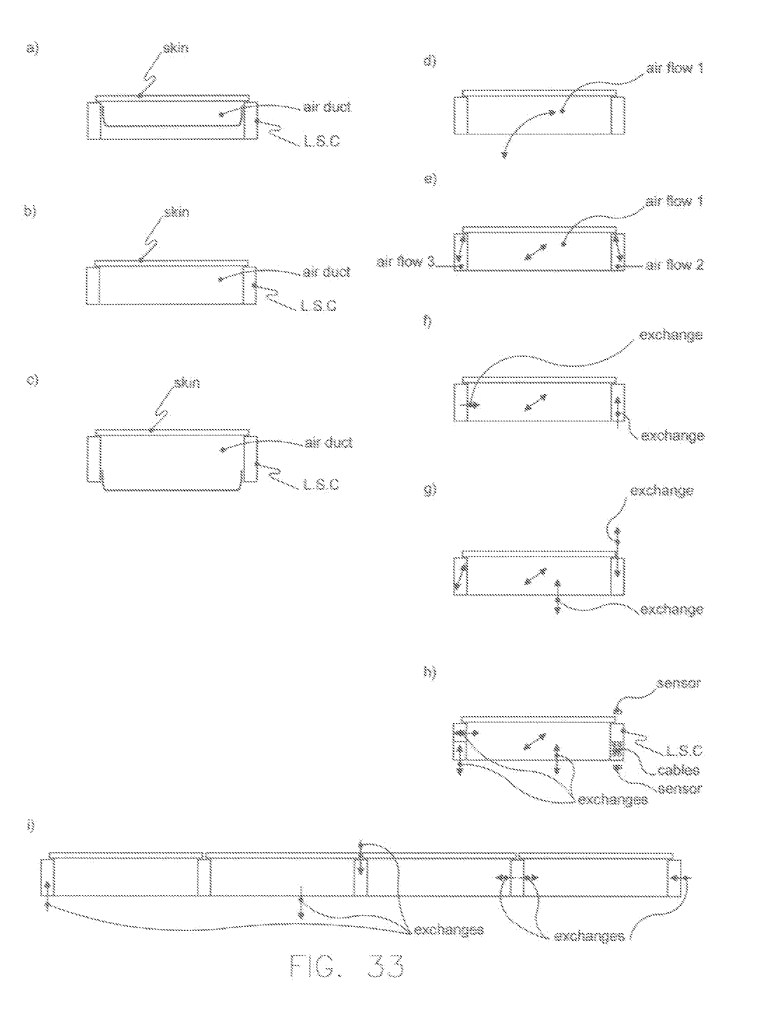

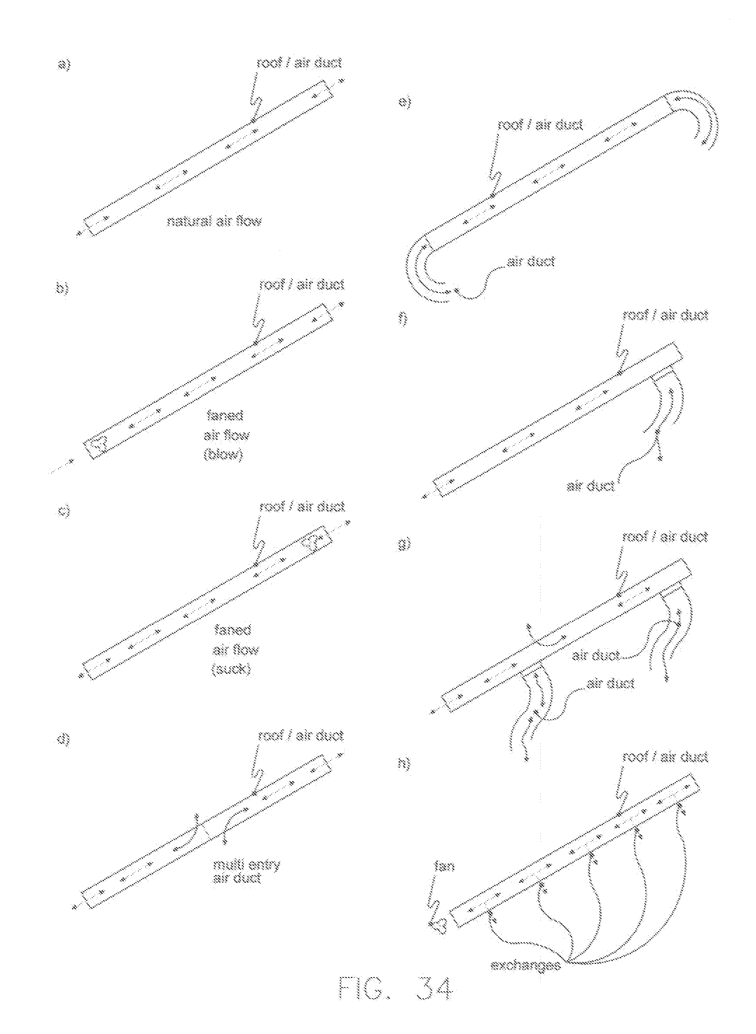

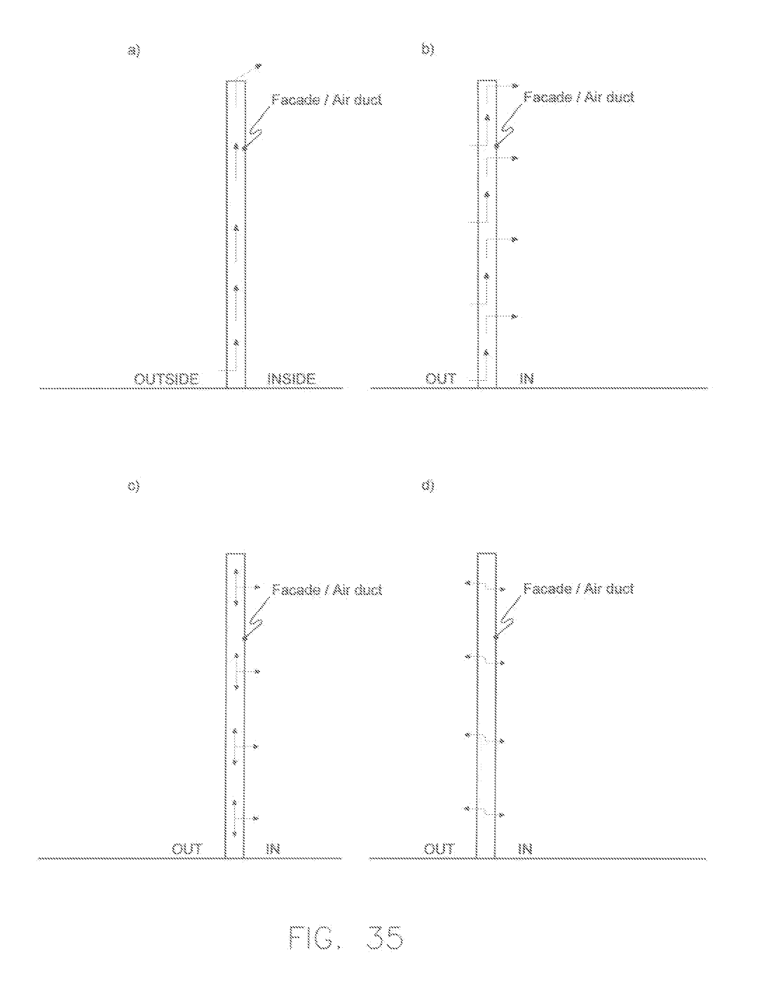

### FIG. 35: Examples of Airflows for a Façade

What has been shown in FIG. 34 may give many possibilities for creating facades, on classical buildings as well as on high-rise buildings.
a) Fresh air enters the air duct in the lower part of the façade and flows upwards, thus warming or cooling the façade or the building
b) The same is done several times: instead of a unique flow from floor to roof, the height may be divided into several circuits, for example one per storey.
c) In this case, the exchanges are not between the air duct and the outside, but between the air duct and the inside of the building
d) In this case we have complex exchanges, possibly mixing in-duct flows, connections with the inside and with the outside.

### FIG. 36

FIG. 36: examples of interconnection between the outer skin and a building or another user. We are here describing a roof, but it could also be a façade or any kind of skin.
a) In this case, there is no connection. The roof manages its own airflows without any interaction with the building or other systems.
b) In this case, the roof's air circuit is connected to the building's air management system, possibly via an air or heat processor or exchanger, which can also use outside or inside air. This way, there may be an interaction between the roof's airflow and the building's management.
c) In this case, the roof's air circuit is connected to an external air duct, possibly connected to an external management system.
d) In this case, it is not a building. It might be an independent structure, a solar carport or a ground mounted solar array or any other kind of structure. The system's airflows may be connected to an exterior system, which may extract this air or reuse it or pulse new air into the system.

### FIG. 37: Prefabrication Principles

This figure shows 2 perspective views of the same building. It is about building a solar roof, but it might be a façade or any other structure or material.

The left one, called “before”, shows the complex process of building a solar roof even using the invention. One may need to install a scaffolding and safety solutions, then to spend long and costly hours working at height to install the LSC or any other mounting system, the optional insulation, sheathing sheet, waterproofing, accessories, etc., and the panels

The picture on the right shows the prefabrication solution. The roof is prefabricated, transported or craned and simply plugged into the building. It can even arrive all completed, completely wired and ready to work, with a single plug to connect.

It may also arrive complete with all its optional finishing.

FIG. 37b: Prefabrication Principles

The same as in FIG. 37 may be applied to facades, which can arrive complete and be simply plugged into the building.

Even better, instead of prefabricating only the roof, it is a whole chunk of a building that may be prefabricated, including the solar roof, especially if it is part of the structure of the building.

### FIG. 38: Prefabrication Principles

This figure shows 3 perspective views, which correspond to 3 steps in installing a prefabricated solar system on a flat roof. This is true for many other cases, but the drawings here illustrate a solar solution similar to those of FIGS. 4, 9 and 10.

Step 1: supporting points are created on the roof of the host building.

Step 2: the prefabricated array is mounted in a distant location, either manually or with automated tools. The wiring is ready too.

Step 3: the pre-mounted chunks are carried to their final destination: in this crane, using a crane. They are put in place, attached on the previously installed supporting points, and plugged.

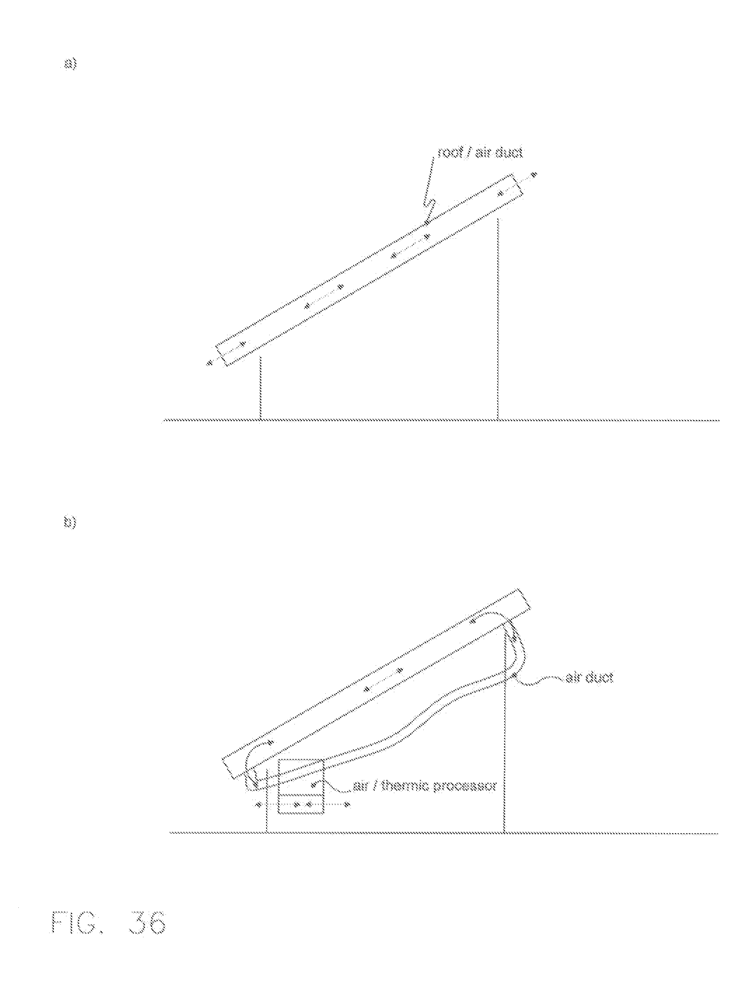

FIG. 39: Prefabrication Principles with Post-Positioning

This figure shows 2 perspective views, which correspond to 2 steps in installing a prefabricated solar system on a flat roof. This is true for many other cases, but the drawings here illustrate a solar solution similar to those of FIGS. 4, 9 and 10.

Step 1: the complete array is fully mounted horizontally on its future supporting points. Working horizontally at a convenient height is much more convenient than working at height.

Step 2: the finished array is lifted, oriented, moved or else and put in its final position. It is fixed there.

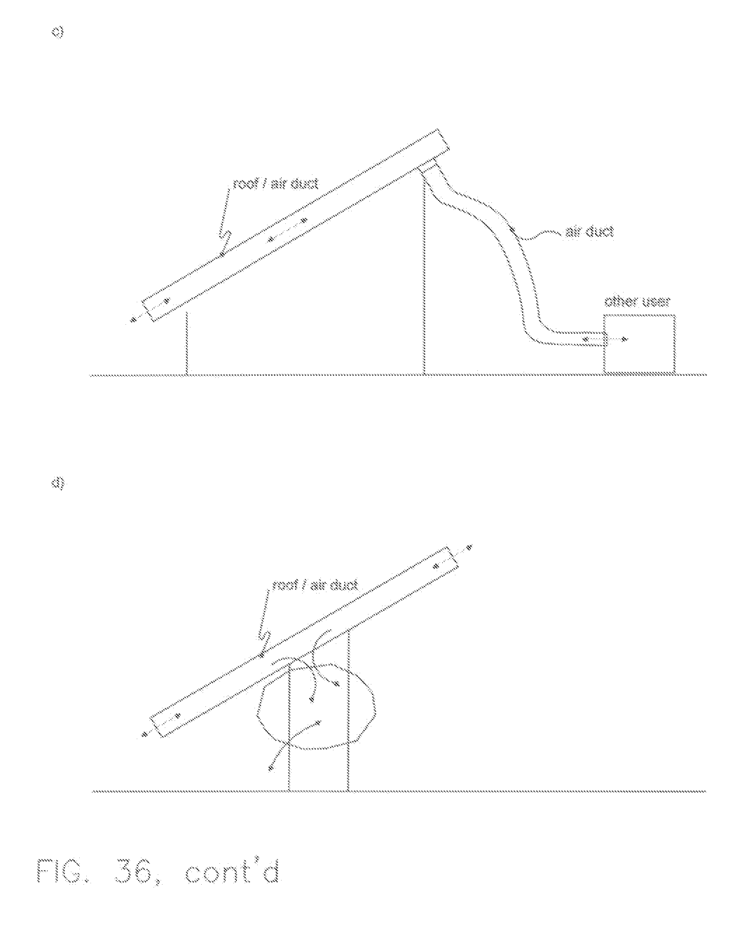

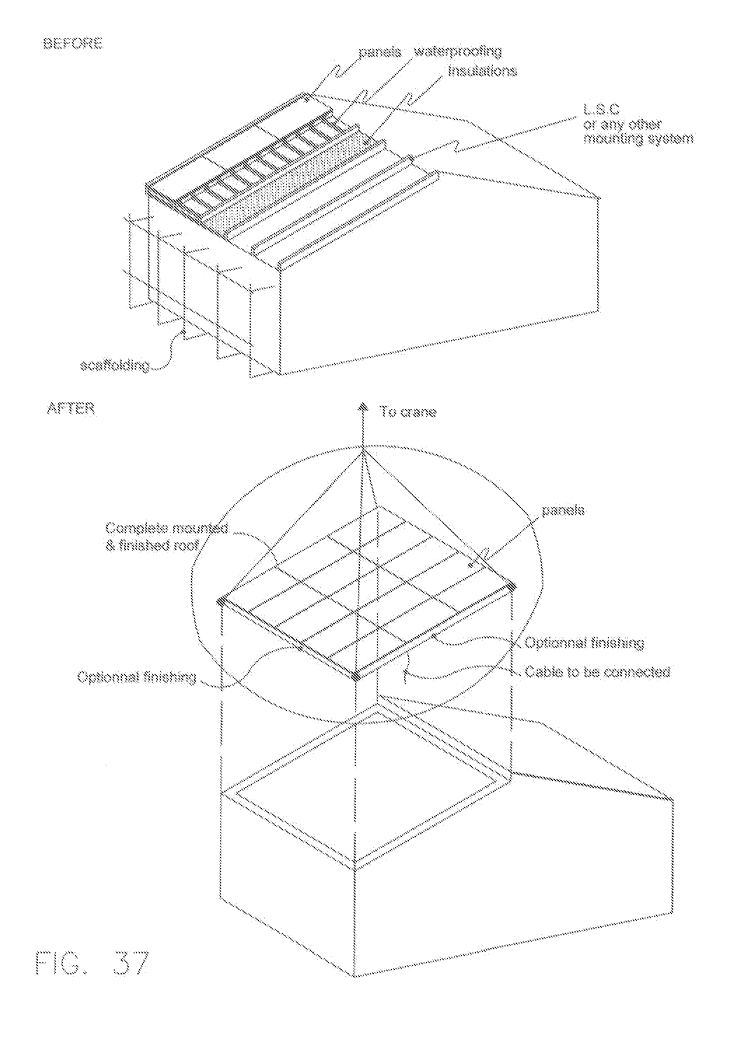

### FIG. 40: Prefabrication Option 1: The Solar Array or the Chunk of Building is Built On its Final Supporting Frame.

This figure shows 4 perspective views, which correspond to 4 steps in installing a prefabricated solar system on a flat roof. This is true for many other cases, but the drawings here illustrate a solar solution similar to those of FIGS. 4, 9 and 10.

In order to be transported from its prefabrication site to its final destination, the prefabricated array must be rigid and not deformable. Otherwise it would be damaged during the manipulations. Therefore, it has to be built on a strong frame. Two options are possible: build on its future final structure (option 1) or build on a special prefabrication frame that is removed after installation on site (option 2).

This figure is about option 1

Step 1:
This step takes place on site or remotely or in the workshop
The final supporting frame has been designed to provide sufficient support to allow for the prefabricated array, roof, façade or else to be transported and manipulated without danger. Therefore, it will probably be part of the final building's structure.
This frame is built and hooks are handling points are temporarily added to it.
Future fixation points on the host location are prepared
The system is completely built, wired, and finished.

Step 2:
The finished system is transported to its final destination. Depending on the cases, it may be moved with a crane, or hauled by road or train or else, and then lifted.

Step 3:
The finished system is attach on its final site

Step 4:
Optionally, it may be necessary to lift it in order to get the right slope or for other reason. In this case, the supporting points may include hinges.
The side to be lifted is lifted.
If necessary, additional supports are installed to provide the desired stability
   FIG. 40b: Prefabrication Option 2: The Solar Array or the Chunk of Building is Built on a Temporary Supporting Frame.

This figure shows 3 perspective views, which correspond to 3 steps in installing a prefabricated solar system on a flat roof. This is true for many other cases, but the drawings here illustrate a solar solution similar to those of FIGS. 4, 9 and 10.

In order to be transported from its prefabrication site to its final destination, the prefabricated array must be rigid and not deformable. Otherwise it would be damaged during the manipulations. Therefore, it has to be built on a strong frame. Two options are possible: build on its future final structure (option 1) or build on a special prefabrication frame that is removed after installation on site (option 2).

This figure is about option 2.

Step 1:
This step takes place on site or remotely or in the workshop
The system is completely built on a mounting frame
Future fixation points on the host location are prepared
A strong, non deformable, transport frame is attached on the outer part of the finished system

Step 2:
The finished system is transported to its final destination. Depending on the cases, it may be moved with a crane, or hauled by road or train or else, and then lifted.

Step 3:
The host building or structure has been prepared

Step 4:
The finished system is transported and attached to its final site.

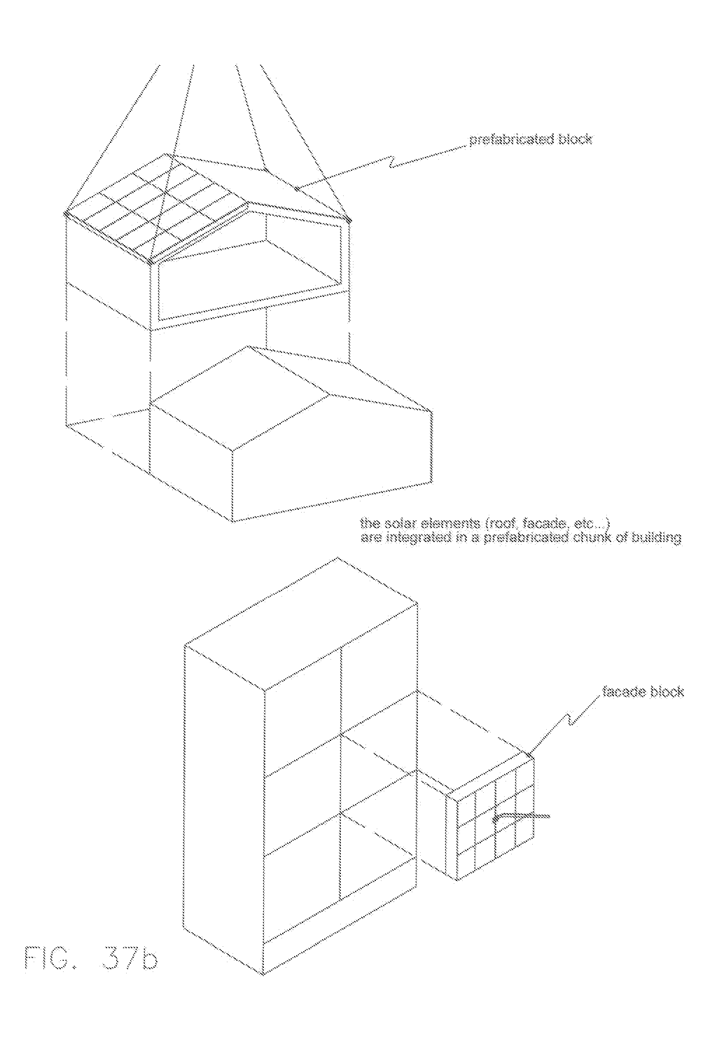

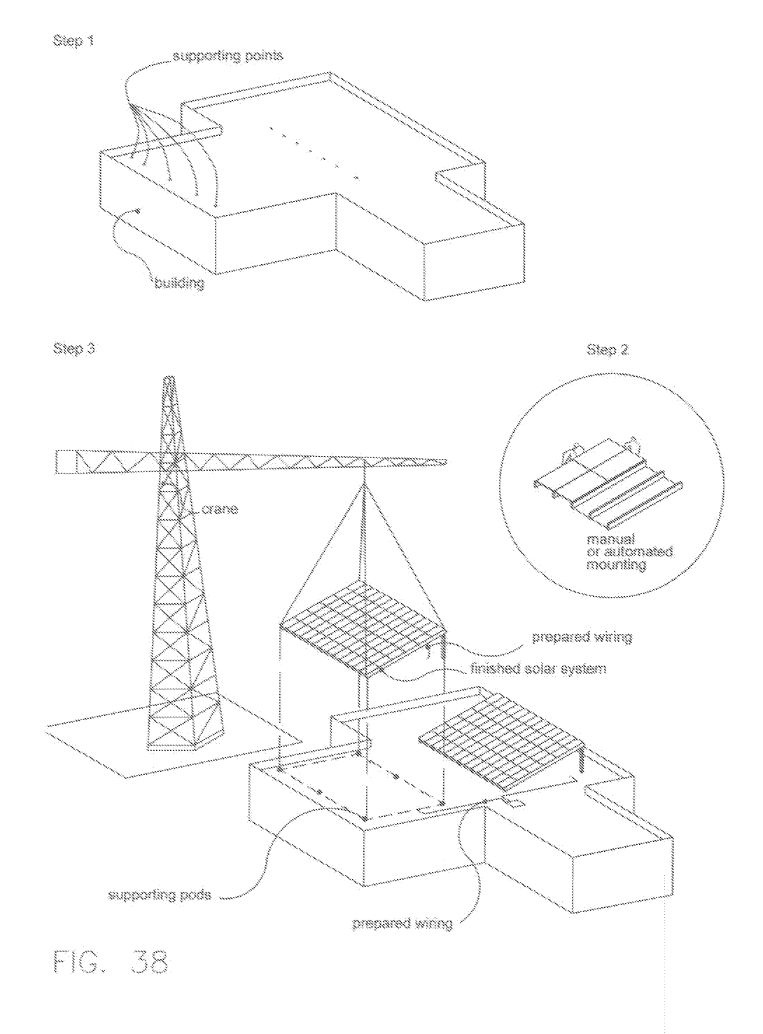

Step 5:
The transport frame is removed and may be re-used
   FIG. 41: Plug and Play. Examples of Usage.

The prefabrication includes wiring. In the case of electrical systems, including solar systems, wiring is an important part of the mounting job and it is difficult to do it on site.
a) The idea is to prefabricate complete systems or, if the project is too big, to prefabricate chunks of buildings or arrays or else and to bring them on site. They have to be wired in such a way that one only needs to plug them easily to each other or to the destination structure. Scheme a) shows a diagram of this principle.
b) Then, the pre-mounted blocks are mounted on the final construction. The final building is made of a juxtaposition of pre-mounted bocks. This is true for any kind of construction, including large ground mounted solar plants, as well as any kind of building. Scheme b) shows the example of a large building being built by chunks. If the pre-fabricated elements are roofs, or solar roofs, constructing the building is very quick and efficient. The quality may be improved too.

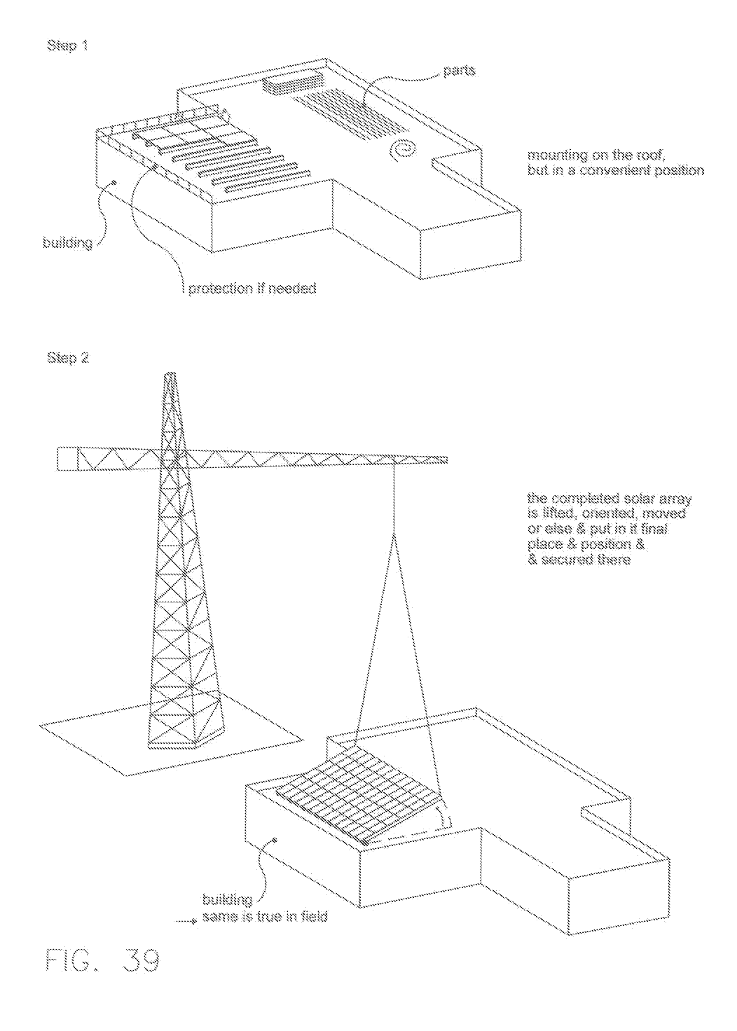

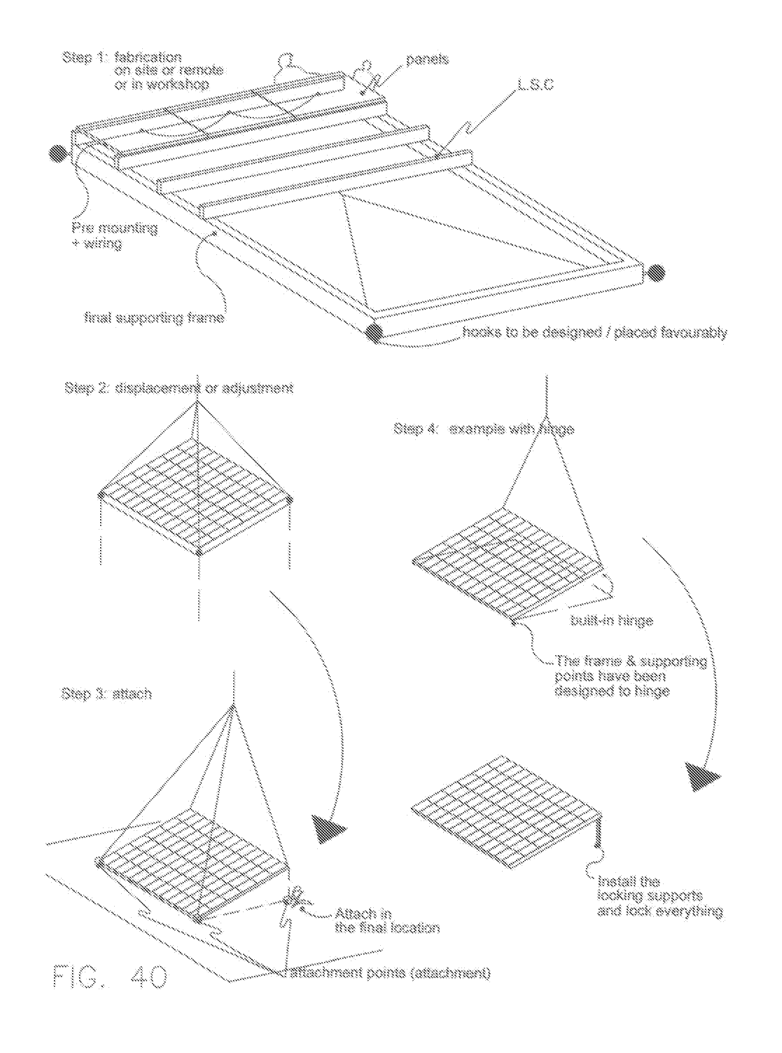

### FIG. 42: Mobile Walkway

This figure shows 2 perspective views and a schematic section of the mobile walkway that can be used either for construction or maintenance of roofs, facades or solar arrays.
a) In this example, the drawing shows a long building with a constant sloped roof. A rail is installed near the bottom edge of the plane and another one near the upper edge. A mobile walkway rolls on these rails ad slides over the building. It may be stored at one of the sides.
b) In this example, the drawing shows a long solar array with a constant slope. It might be a ground mounted solar plant. A rail is installed near the bottom edge of the plane and another one near the upper edge. A mobile walkway rolls on these rails ad slides over the array. It may be stored at one of the sides.
c) This cross view shows a solar plane or a roof, or any plane, equipped with 2 rails, one on the left, one on the right. A mobile walkway spans over the plane and rolls on these rails.
   FIG. 42b: Mobile Walkway for Several Planes

The principle of a walkway rolling over an array may be used in the case of multiple array constructions, especially if the planes are sensibly parallel.

In this case every plane has to be equipped with the left and right rails.

The mobile walkway may move from one plane to another, either carried by a crane or another transportation means or using transfer rails like on this view.

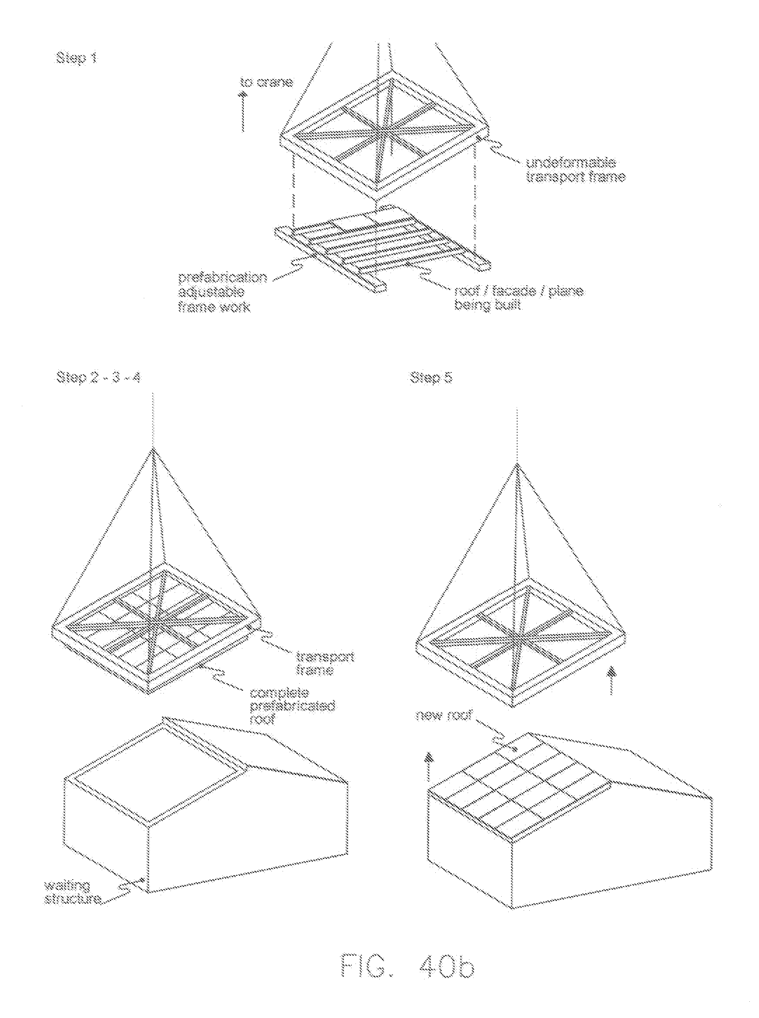

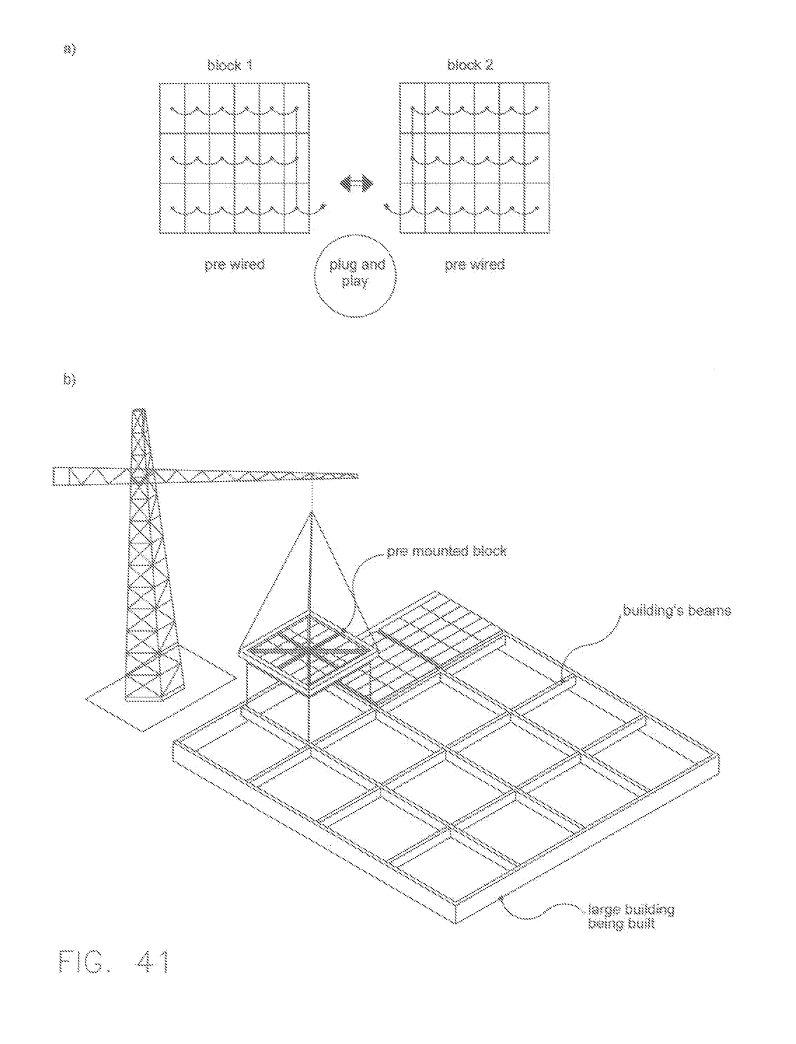

### FIG. 43: Mobile Walkway

This figure shows 2 perspective views with 2 variations of the mobile walkway.

The walkway is a tool, it will be designed on demand to meet the requirements of each specific case and many different configurations are possible.
a) This example shows an underlying roof and a mobile walkway sliding over it. This might be a walkway for human intervention with adjustable or hinged balustrades and adjustable floors, which can be open.
b) Same as above but this variation comprises a second row, designed for machine rather than humans. So, there is a pedestrian part and a tool part. The tool part is equipped with rails. One or several tool carts can run on these rails either to carry tools or to perform automated functions. Some walkways can be made entirely for automated function and not include the pedestrian part. The walkway may be a tool used for 100% automated operations.

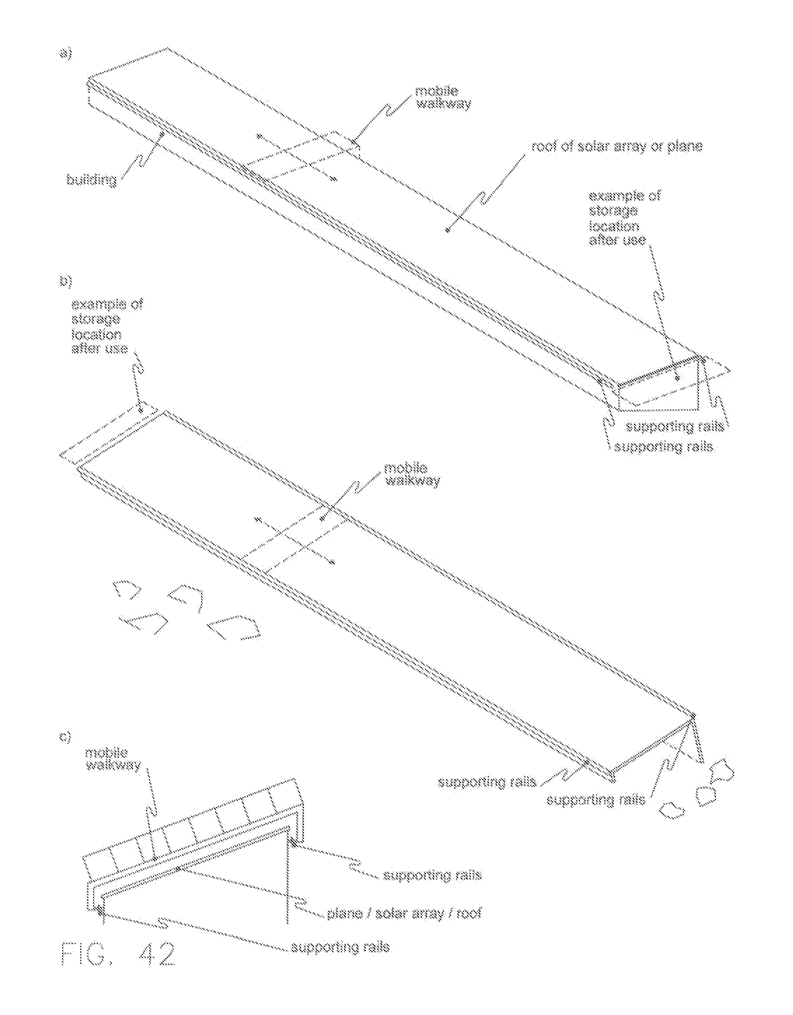

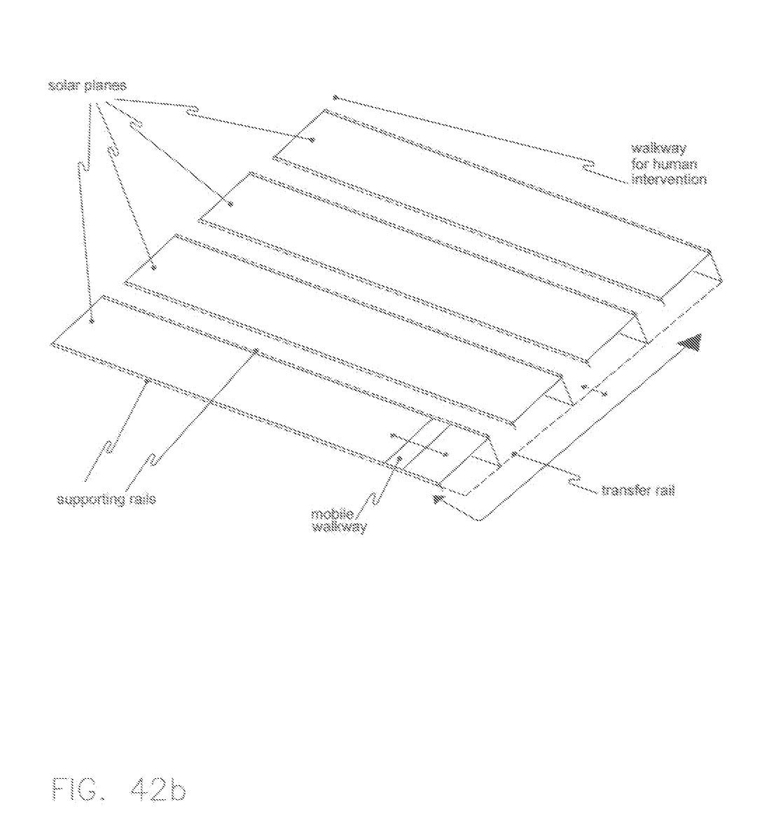

### FIG. 44: Mobile Walkway

This figure shows an example of a 100% automated unmanned device. It shows an underlying roof and the walkway as a big beam that slides laterally and carries a lot of automated equipment. It features one or several automated tools that may roll along the beam, carry various devices and perform many jobs. For example, the walkway may carry cameras, sensors and lights, as well as watering or cleaning systems. The mobile tools rolling on the walkway may include for example cleaning tools, mounting tools, test tools, inspection tools, etc. . . . . In this example, Tool 1 is a robotic arm and Tool 2 is a sweeping device.

The walkway is a tool, it will be designed on demand to meet the requirements of each specific case and many different configurations are possible.

FIG. 44b: Mobile Walkway +Automated Tools Performing an Automated Panel Mounting Operation

This figure shows a large exploded perspective view and a small top view. In this example, it shows how the mobile walkway may be used to mount a roof automatically.

A mobile walkway is sliding over a construction plan, be it on site or in the workshop. It is equipped with a pedestrian lane, here used as a storage area (although the balustrade is there, there is no human intervention involved in this example), and a second lane used for rolling tools in this case, the rolling tools comprise 2 carts (the tools may be interchangeable or be replaced). One of them (Tool 2) is carrying a robotic arm equipped with sucker, which has taken a solar panel from the pile stored aside and is about to install it on the pre-placed LSCs below him. The other tool cart is carrying a screw gun (Tool 1) and is about to attach the panel. On the right side, we can see the part of the roof the robot has already finished, and on the left, the part they have prepared: the LSC and the waterproofing are already installed. All the panels and most of the components may be numbered or identified.

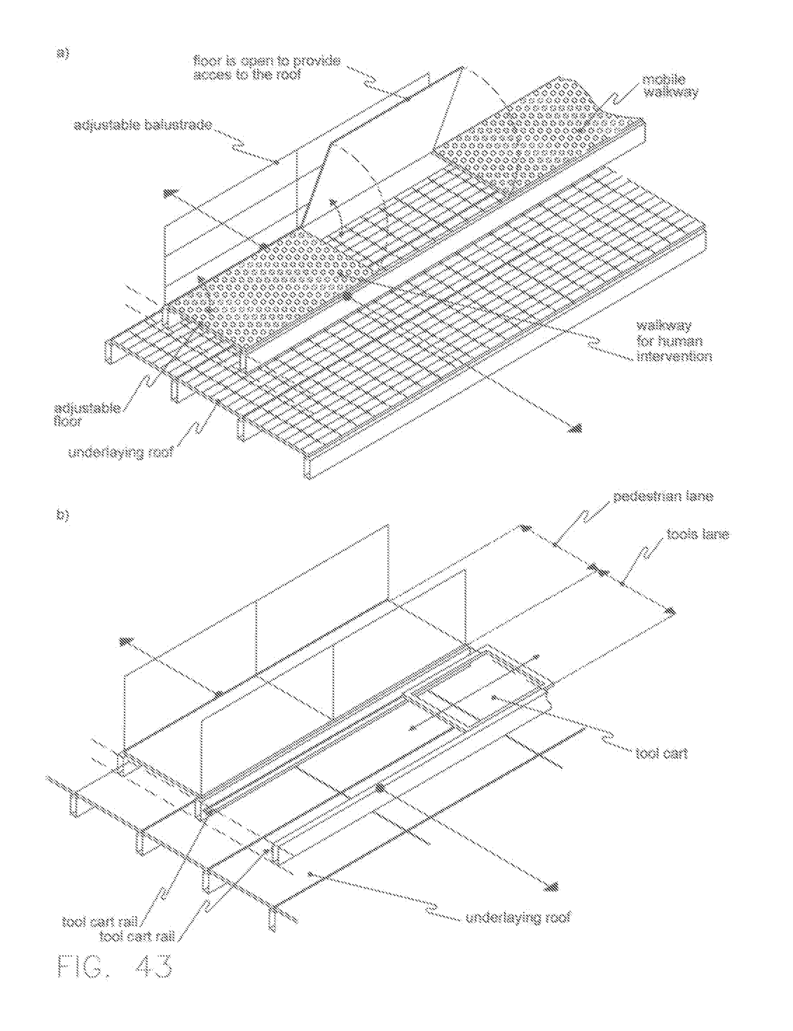

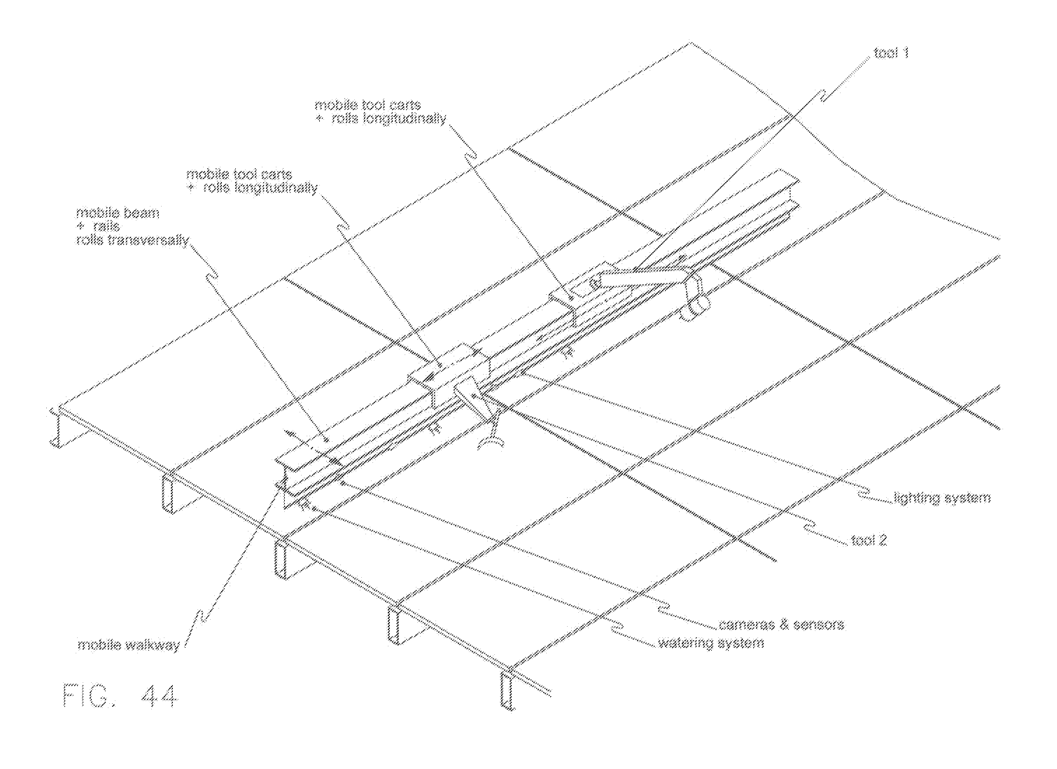

### FIG. 45: Mobile Walkway, Tools

The mobile walkway can be equipped with various interchangeable tools.

If the walkway uses rolling tool carts as described in FIG. 44, the tools can be changed on the cart, or the cart can be replaced with another one.

FIG. 45b: Mobile Walkway, Tools

This figure shows an example of a tool installed on a walkway similar to FIG. 43 or 45, but equipped with a washing tool.

There may be a pedestrian lane but it is not necessary. The tool lane may be equipped with several tools, including a washer roller and watering systems mounted on a rolling tool cart that can move transversally while the supporting walkway may move longitudinally to washed every square foot of the underlying roof.

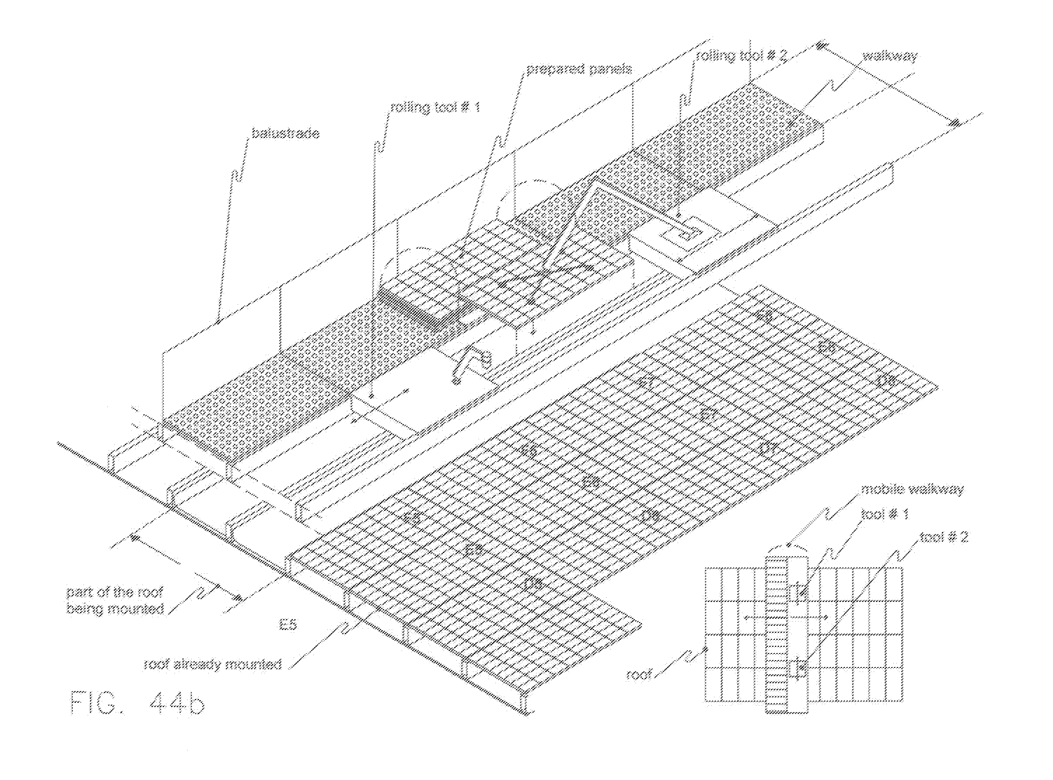

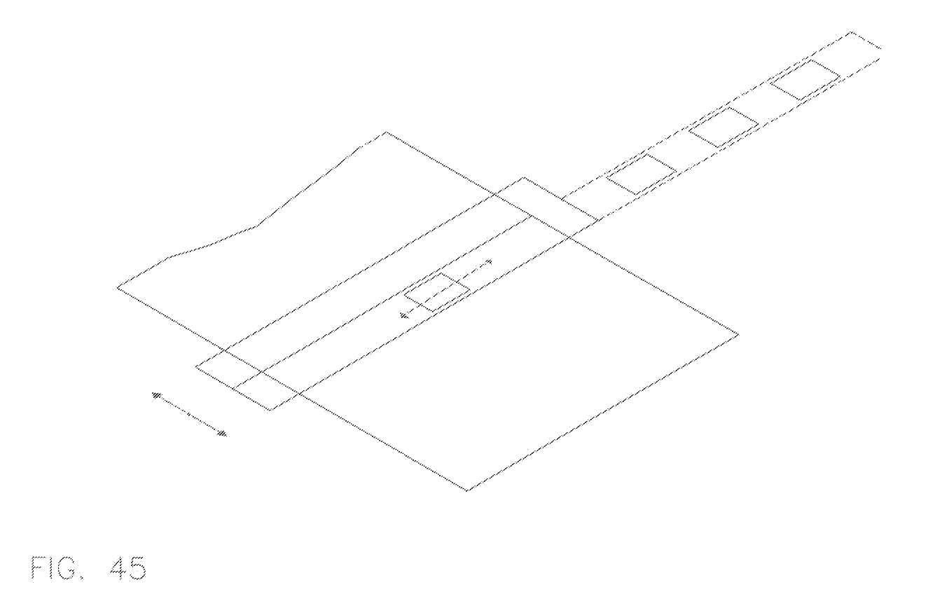

### FIG. 46: Mobile Walkway, Tools.

This figure describes a part of the construction automation system. It is based on an example of mobile walkway similar to FIG. 43 or 44b.

A metal bending machine is mounted at one of the ends of the mobile walkway's tool lane. It bears a roll of metal. The metal unrolls into the bending machine, is processed, exits with the desired shape (this shape depends on the project's configuration) and slides between the LSCs to form the waterproofing sheet and possibly the future air duct. This enables to make very long waterproofing sheets, without any junction and since without any risk of leakage. It would be very difficult to prefabricate and transport these fragile metal sheets. The best solution is to unroll them directly in place. It may be useful, in some cases, to have the end of the folded metal sheet lay on a rolling cart, which will drive it along the LSCs until it is completely deployed in the right location.

When one row is completed, the mobile walkway moves to the next one and performs the operation again.

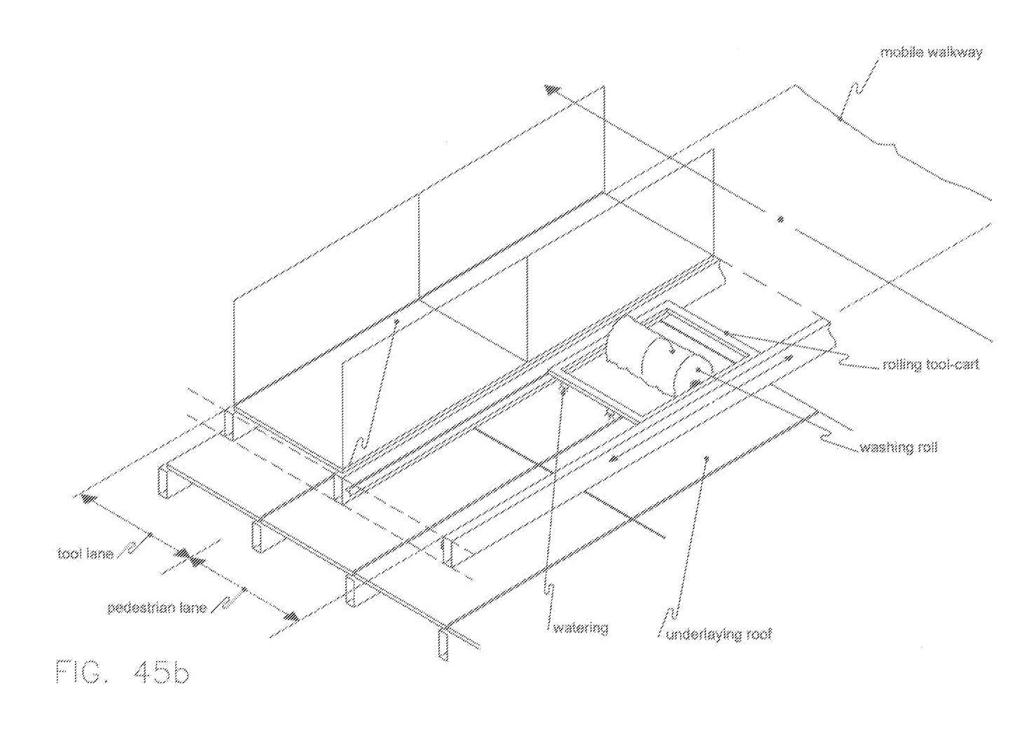

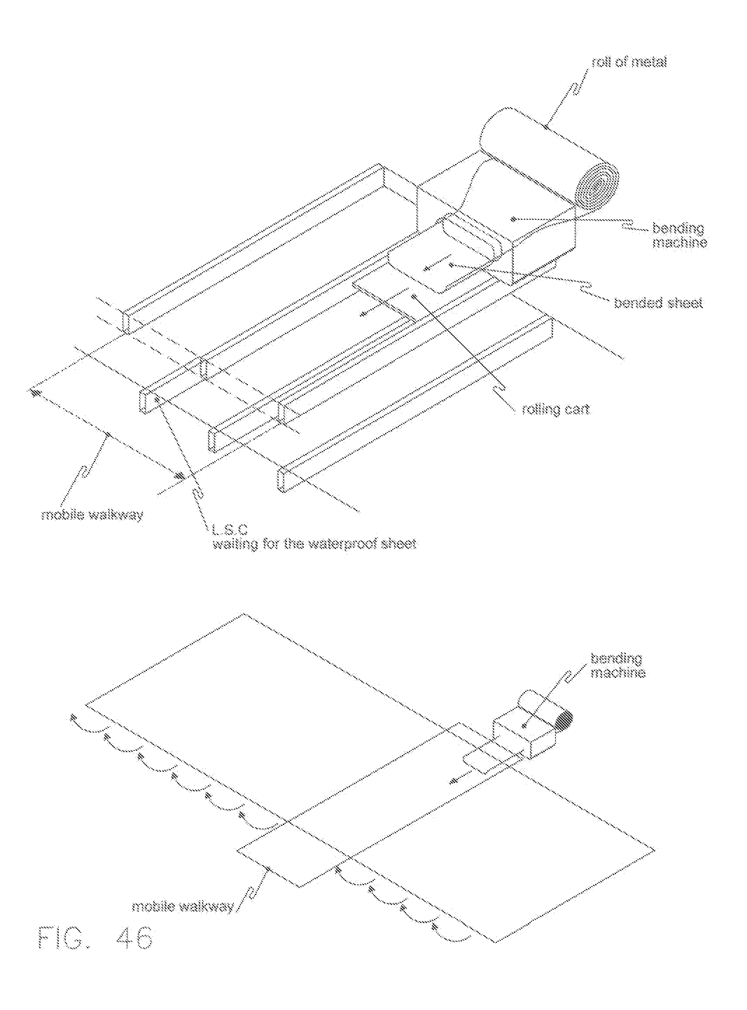

### FIG. 47: Mobile Walkway

This figure shows the mobile walkway principle being used as a prefabrication device used in a workshop or on site.

This is exactly the same process as on FIG. 44b, but is used as prefabrication tool in a workshop or in a on-site prefabrication workshop (it can be outdoor, in a mobile tent, or else). In this case, the walkway rolls on rails that do not belong to the building.

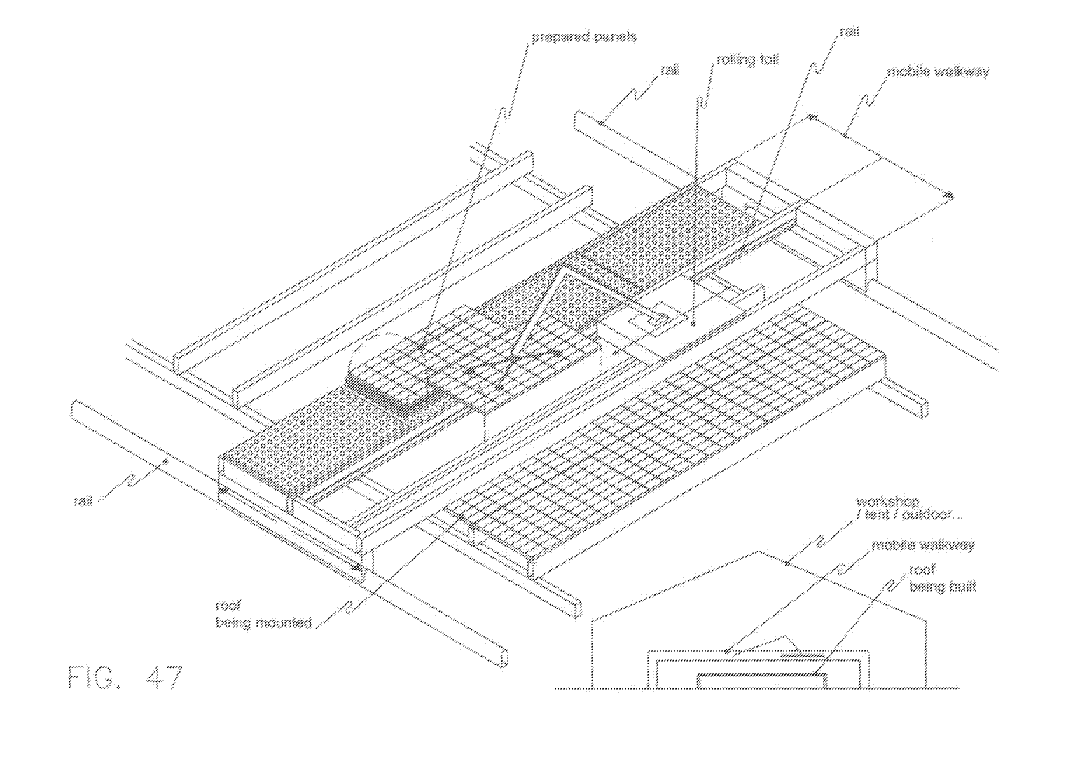

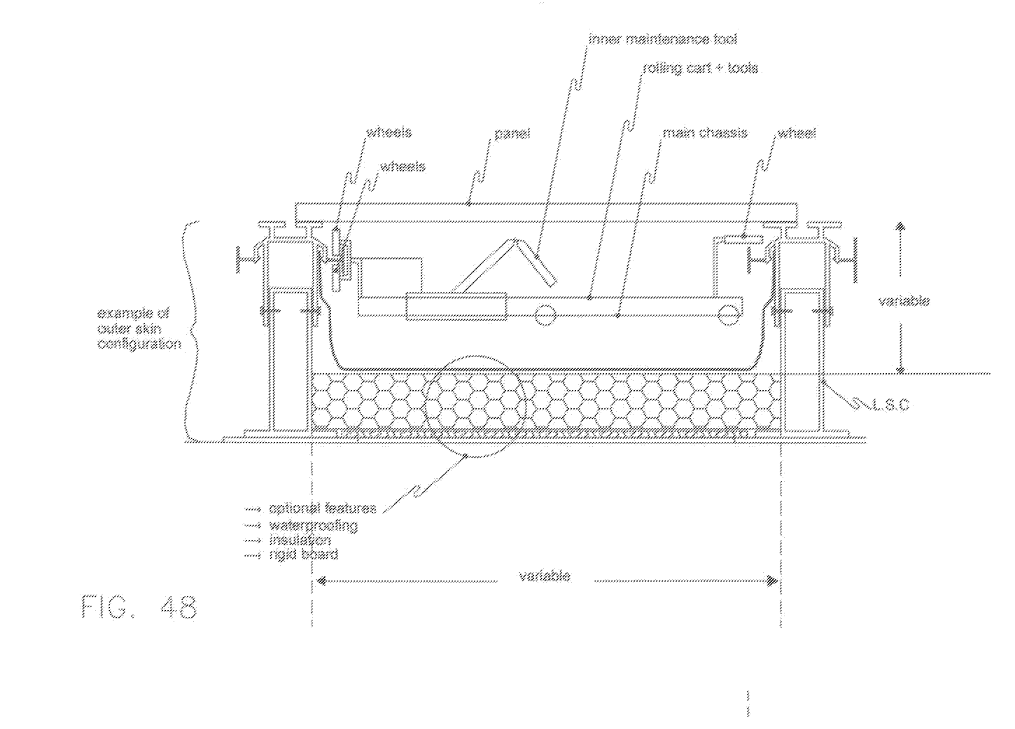

FIG. 48: Robot for Inside the Duct. Principles.

This figure shows a schematic section and a schematic top view of an example of the robot, in situ.

In this example, the robot rolls inside the air duct, below or behind the panels, above or ahead the optional waterproofing, insulation or rigid board. It has wheels that roll on a specific “rail” that is part of the LSC's design on each side: the “robot way”. Its width and height are variable or adjustable to fit the variable width or height of the duct. It is basically a cart using a chassis, which may carry a number of various tools or devices, including fixed tools, and mobile tools that are mounted on transversally rolling carts, which roll on transversal rails. Some of the wheels may have a suspension, and/or caterpillar tracks.

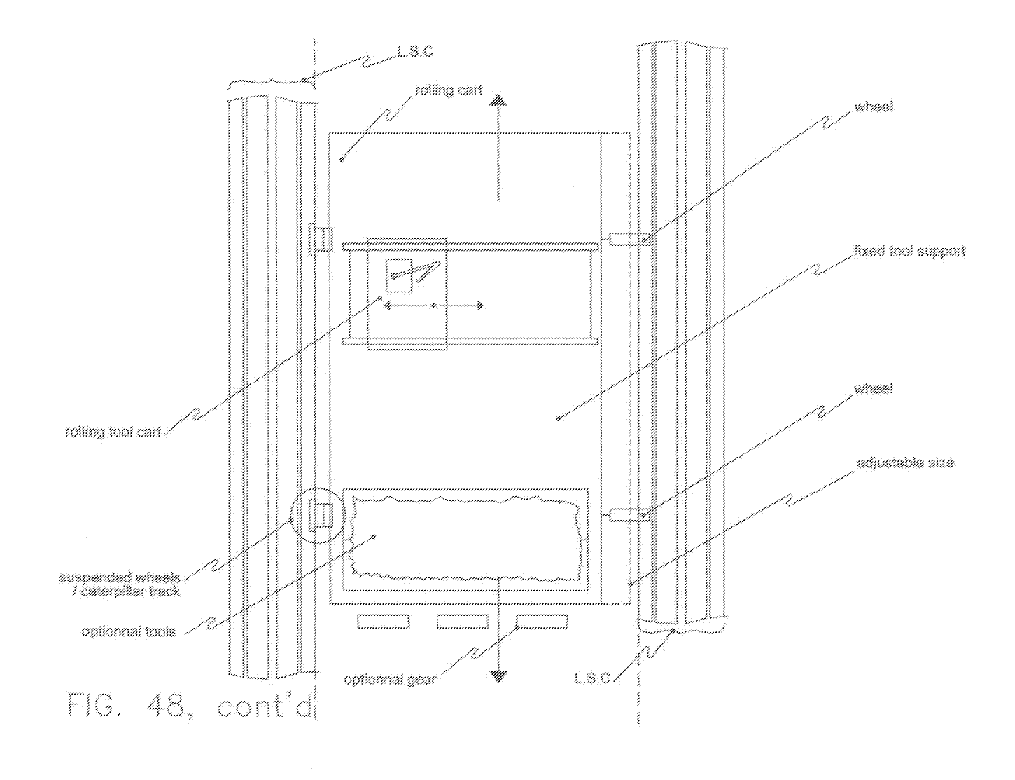

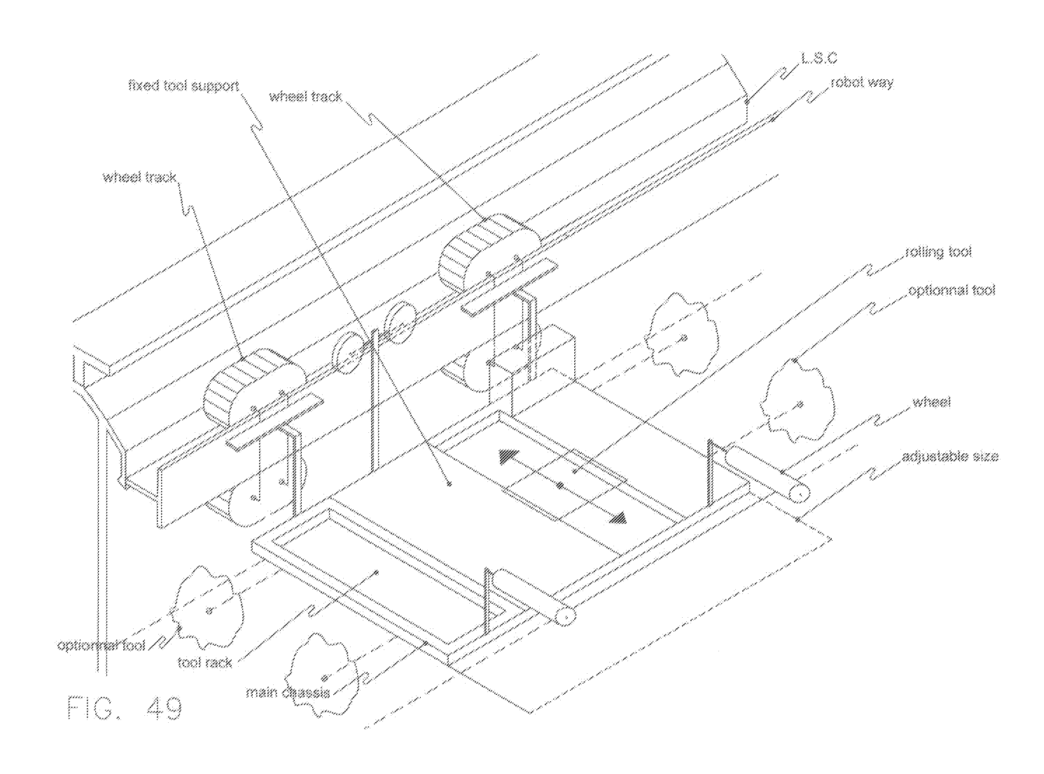

FIG. 49: Robot for Inside the Duct. Principles.

This figure shows an exploded perspective view of an example of the robot.

It rolls on a special rail part of the LSC, that we may call the “robot way”. It may have different wheels on each side. There may be at least one driving side with powered wheels or caterpillar. There may be double wheel systems, with wheels above and below the rail in order to control the robot perfectly, and the wheel may be articulated or suspended. There may also be simple supporting wheels.

There may be optional tools almost everywhere, either fixed on the cart's chassis, in the special tool rack, or mounted on transversally rolling tool carts.

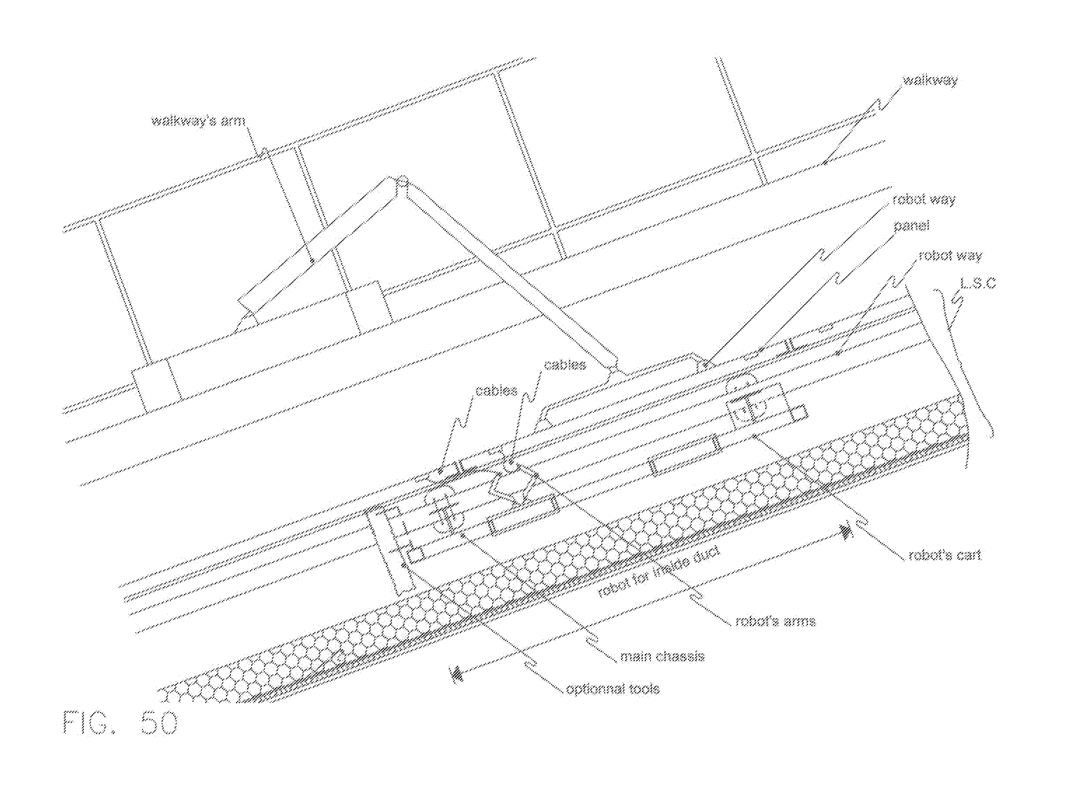

### FIG. 50: Example of Robotized Mounting Operation

On this side view, the inside robot, using its 2 robotic arms (which are mounted either on the robot's chassis or on transversally rolling carts), is connecting the solar panel's cables, while the mobile walkway's tools are installing the panels. The robot is rolling on the LSC's “robot way”. The mobile walkway's robotic arm holds the panel with its suckers. The inside robot has front tools that can, for example, sweep the air duct.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A building system for a building comprising:
an outer skin complex comprising:
solar panels; and
a plurality of substantially parallel longitudinal supporting components to support the solar panels wherein the plurality of substantially parallel longitudinal supporting components are spaced apart to accommodate the dimension of the solar panels;
a supporting beam to support the plurality of substantially parallel longitudinal supporting components; and
a ventilation duct complex.

2. The building system of claim 1, further comprising one or more of the following: an impervious layer in the ventilation duct complex to provide water proofing, and a thermal insulation layer in the ventilation duct complex.

3. The building system of claim 1, wherein the ventilation duct complex has one or more of the following characteristics: closed on all sides, open on at least one side, natural ventilation, forced ventilation, connected to external ventilation systems, connected to a heat exchanger system, connected to liquid or air circulation systems.

4. The building system of claim 1, wherein the ventilation duct complex includes as least part of the space formed between adjacent parallel longitudinal supporting components and the solar panels.

5. The building system of claim 1, further including one or more robots to perform one or more of the following: inspection of the outer skin complex, cleaning one or more components of the outer skin complex, repairing one or more components of the outer skin complex, or mounting one or more components of the outer skin complex.

6. The building system of claim 1, the ventilation duct complex is designed to allow a robot for performing one or more of the following: inspection of the ventilation duct complex, cleaning one or more components of the ventilation duct complex, repairing one or more components of the outer skin complex, or mounting one or more components of the ventilation duct complex.

7. The building system of claim 5, wherein the one or more robots has one or more of the following characteristics: autonomous, remotely controlled, or semi-autonomous, programmed to perform expert functions.

8. The building system of claim 5, wherein the one or more robots is equipped with one or more of the following tools: robotic arms, cameras, thermal sensors, humidity sensors, electrical sensors, contact sensors, weather sensors, wind sensors, motion or presence sensors, GPS systems, alarm systems, light transmitters, radar equipment, ultrasonic equipment, infrared lighting, and radiation equipment, construction tools, watering system, spraying system, lighting system, cleaning systems, testing equipment, systems for holding and setting panels.

9. The building system of claim 1, wherein the ventilation duct complex is cleaned by one or more of the following: local vacuuming system, centralized vacuum system, robotic vacuums, water sprays, chemical sprays, air blowers, mechanical scrapers, cleaning tools, mechanized brushes.

10. The building system of claim 1, wherein the outer skin complex is cleaned by one or more of the following: local vacuuming system, centralized vacuum system, robotic vacuums, water sprays, chemical sprays, air blowers, mechanical scrapers, cleaning tools, and mechanized brushes.

11. The building system of claim 5, wherein the one or more robots has one or more of the following characteristics: ability to hold panels, ability to plug panels, ability to lift panels, ability to set panels, ability to screw or unscrew, ability to clean the ventilation duct complex, ability to clean the solar panels, ability to make repairs to the ventilation duct complex, ability to make repairs to the outer skin complex, ability to transmit information to a remote location, ability to test electrical systems, ability to test waterproofing systems, ability to test insulation systems, ability to perform construction functions, ability to test structural systems.

12. The building system of claim 1, wherein the supporting beam is any one of the following: a transversal frame girder of a roof, transversal frame girder of a façade, a joist, a frame, a grid, a lattice, a shell, a cable, a membrane, a wall or a façade, a wall plate, a wooden deck, a metal deck, a diaphragm, a covering, a slab, a post, or existing components of the building or of the supporting structure.

13. The building system of claim 1, wherein the ventilation duct complex is used for one or more of the following: to ventilate the outer skin complex, to ventilate the solar panels, to extract energy from the outer skin complex, to extract energy from the solar panels, to improve efficiency of the outer skin complex, to improve the efficiency of the solar panels, to improve the efficiency of the building, and to convert the extracted energy for re-use.
